(19) United States
(12) Patent Application Publication
(10) Pub. No.: US 2013/0083003 A1
(43) Pub. Date: Apr. 4, 2013

(54) PERSONAL AUDIO/VISUAL SYSTEM

(71) Applicants: Kathryn Stone Perez, Kirkland, WA (US); Stephen G. Latta, Seattle, WA (US); Ben J. Sugden, Gilford (GB); Benjamin I. Vaught, Seattle, WA (US); Kevin A. Geisner, Mercer Island, WA (US); Alex Aben-Athar Kipman, Redmond, WA (US); Jennifer A. Karr, Edmonds, WA (US)

(72) Inventors: Kathryn Stone Perez, Kirkland, WA (US); Stephen G. Latta, Seattle, WA (US); Ben J. Sugden, Gilford (GB); Benjamin I. Vaught, Seattle, WA (US); Kevin A. Geisner, Mercer Island, WA (US); Alex Aben-Athar Kipman, Redmond, WA (US); Jennifer A. Karr, Edmonds, WA (US)

(21) Appl. No.: 13/250,878

(22) Filed: Sep. 30, 2011

(51) Int. Cl. G09G 5/00; G06T 15/00

(52) U.S. Cl. 345/419; 345/633

(57) ABSTRACT

The technology described herein incudes a see-through, near-eye, mixed reality display device for providing customized experiences for a user. The system can be used in various entertainment, sports, shopping and theme-park situations to provide a mixed reality experience.

### BACKGROUND

Augmented reality is a technology that allows virtual imagery to be mixed with a real world physical environment. For example, an augmented reality system can be used to insert an image of a dinosaur into a user's view of a room so that the user sees a dinosaur walking in the room.

In many cases, augmented reality is accomplished using an apparatus that can be viewed by one person or a small number of people. Therefore, the augmented reality system can provide a personalized experience.

### SUMMARY

Technology is described herein provides various embodiments for implementing an augmented reality system that can provide a personalized experience for the user of the system. In one embodiment, the augmented reality system comprises a see-through, near-eye, augmented reality display that is worn by a user. The system can be used in various entertainment, sports, shopping and theme-park situations to provide a mixed reality experience.

One embodiment include automatically determining a three dimensional location of the personal A/V apparatus, the personal A/V apparatus includes one or more sensors and a see-through display; automatically determining an orientation of the personal A/V apparatus; automatically determining a gaze of a user looking through the see-through display of the personal A/V apparatus; automatically determining a three dimensional location of a movable object in the field of view of the user through the see-through display, the determining of the three dimensional location of the movable object is performed using the one or more sensors; transmitting the three dimensional location of the personal A/V apparatus, the orientation, the gaze and the three dimensional location of the movable object to a server system; accessing weather data at the server system and automatically determining the effects of weather on the movement of the movable object; accessing course data at the server system; accessing the user's profile at the server system, the user's profile including information about the user's skill and past performance; automatically determining a recommend action on the movable object base on the three dimensional location of the movable object, the weather data and the course data; automatically adjusting the recommendation based on the user's skill and past performance; transmitting the adjusted recommendation to the personal A/V apparatus; and displaying the adjusted recommendation in the see-through display of the personal A/V apparatus.

One embodiment includes a personal A/V apparatus that includes a see-through, near-eye, augmented reality display that is worn by a user; and one or more servers in wireless communication with the personal A/V apparatus. The one or more servers automatically determine that the user is within an attraction. The one or more servers access a user profile for the user and identify one or more enhancement packages for the attraction that match parameters of the user profile. The one or more servers filter out enhancement packages that have already been experienced by the user and choose one of the remaining enhancement packages. The chosen enhancement package is implemented by the personal A/V apparatus sensing data about its location and orientation, the personal A/V apparatus sensing data about gaze of the user, the one or more servers determining a graphic to add to the see-through, near-eye, augmented reality display, and the personal A/V apparatus rendering the determined graphic in the see-through, near-eye, augmented reality display. The one or more servers automatically determine that the user has completed the attraction and terminate the chosen enhancement package in response to determining that the user has completed the attraction.

One embodiment includes accessing a data structure indicating storage locations and items to be stored at each of the locations, automatically determining a current location of a personal A/V apparatus, automatically determining that the current location is a storage location based on the data structure, identifying items to be stored at the current location based on the data structure, automatically sensing presence of a plurality of items, automatically identifying items from the data structure that are missing from the current location based on the automatically sensing presence of the plurality of items and the data structure, creating a list, adding the items that are missing from the current location to a list, and storing the list, displaying the list in the personal A/V apparatus, and ordering the items that are missing from the current location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram depicting example components of one embodiment of a see-through, mixed reality display device with adjustable IPD in a system environment in which the device may operate.

FIG. 1B is a block diagram depicting example components of another embodiment of a see-through, mixed reality display device with adjustable IPD.

FIG. 2A is a top view illustrating examples of gaze vectors extending to a point of gaze at a distance and a direction for aligning a far IPD.

FIG. 2B is a top view illustrating examples of gaze vectors extending to a point of gaze at a distance and a direction for aligning a near IPD.

FIG. 3A is a flowchart of a method embodiment for aligning a see-through, near-eye, mixed reality display with an IPD.

FIG. 3B is a flowchart of an implementation example of a method for adjusting a display device for bringing the device into alignment with a user IPD.

FIG. 3C is a flowchart illustrating different example options of mechanical or automatic adjustment of at least one display adjustment mechanism.

FIG. 4A illustrates an exemplary arrangement of a see through, near-eye, mixed reality display device embodied as eyeglasses with movable display optical systems including gaze detection elements.

FIG. 4B illustrates another exemplary arrangement of a see through, near-eye, mixed reality display device embodied as eyeglasses with movable display optical systems including gaze detection elements.

FIG. 4C illustrates yet another exemplary arrangement of a see through, near-eye, mixed reality display device embodied as eyeglasses with movable display optical systems including gaze detection elements.

FIGS. 4D, 4E and 4F illustrate different views of an example of a mechanical display adjustment mechanism using a sliding mechanism which a user may actuate for moving a display optical system.

FIG. 4G illustrates an example of a mechanical display adjustment mechanism using a turn wheel mechanism which a user may actuate for moving a display optical system.

FIGS. 4H and 4I illustrate different views of an example of a mechanical display adjustment mechanism using a ratcheting mechanism which a user may actuate for moving a display optical system.

FIG. 4J illustrates a side view of a ratchet such as may be used in the mechanisms of FIGS. 4H and 4I.

FIG. 5A is a side view of an eyeglass temple in an eyeglasses embodiment of a mixed reality display device providing support for hardware and software components.

FIG. 5B is a side view of an eyeglass temple in an embodiment of a mixed reality display device providing support for hardware and software components and three dimensional adjustment of a microdisplay assembly.

FIG. 6A is a top view of an embodiment of a movable display optical system of a see-through, near-eye, mixed reality device including an arrangement of gaze detection elements.

FIG. 6B is a top view of another embodiment of a movable display optical system of a see-through, near-eye, mixed reality device including an arrangement of gaze detection elements.

FIG. 6C is a top view of a third embodiment of a movable display optical system of a see-through, near-eye, mixed reality device including an arrangement of gaze detection elements.

FIG. 6D is a top view of a fourth embodiment of a movable display optical system of a see-through, near-eye, mixed reality device including an arrangement of gaze detection elements.

FIG. 7A is a block diagram of one embodiment of hardware and software components of a see-through, near-eye, mixed reality display unit as may be used with one or more embodiments.

FIG. 7B is a block diagram of one embodiment of the hardware and software components of a processing unit associated with a see-through, near-eye, mixed reality display unit.

FIG. 8A is a block diagram of a system embodiment for determining positions of objects within a user field of view of a see-through, near-eye, mixed reality display device.

FIG. 8B is a flowchart of a method embodiment for determining a three-dimensional user field of view of a see-through, near-eye, mixed reality display device.

FIG. 9A is a flowchart of a method embodiment for aligning a see-through, near-eye, mixed reality display with an IPD.

FIG. 9B is a flowchart of a method embodiment for aligning a see-through, near-eye, mixed reality display with an IPD based on image data of a pupil in an image format.

FIG. 9C is a flowchart of a method embodiment for determining at least one adjustment value for a display adjustment mechanism based on a mapping criteria of at least one sensor for each display optical system not satisfying an alignment criteria.

FIG. 9D is a flowchart of a method embodiment for aligning a see-through, near-eye, mixed reality display with an IPD based on gaze data.

FIG. 9E is a flowchart of another version of the method embodiment of FIG. 9D.

FIG. 9F is a flowchart of a method embodiment for aligning a see-through, near-eye, mixed reality display with an IPD based on gaze data with respect to an image of a virtual object.

FIG. 10A is a flowchart illustrating a method embodiment for re-aligning a see-through, near-eye, mixed reality display device with an inter-pupillary distance (IPD).

FIG. 10B is a flowchart illustrating a method embodiment for selecting an IPD from a near IPD or a far IPD.

FIG. 11 is a flowchart illustrating a method embodiment for determining whether a change has been detected indicating the alignment with the selected IPD no longer satisfies an alignment criteria.

FIG. 12 is a flowchart of a method embodiment for determining gaze in a see-through, near-eye mixed reality display system.

FIG. 13 is a flowchart of a method embodiment for identifying glints in image data.

FIG. 14 is a flowchart of a method embodiment which may be used to determine boundaries for a gaze detection coordinate system.

FIG. 15 is a flowchart illustrating a method embodiment for determining a position of a center of a cornea in the coordinate system with optical gaze detection elements of the see-through, near-eye, mixed reality display.

FIG. 16 provides an illustrative example of defining a plane using the geometry provided by an arrangement of optical elements to form the gaze detection coordinate system which may be used by the embodiment of FIG. 15 to find the cornea center.

FIG. 17 is a flowchart illustrating a method embodiment for determining a pupil center from image data generated by a sensor.

FIG. 18 is a flowchart illustrating a method embodiment for determining a gaze vector based on the determined centers for the pupil, the cornea and a center of rotation of an eyeball.

FIG. 19 is a flowchart illustrating a method embodiment for determining gaze based on glint data.

FIG. 20 is a block diagram of an exemplary mobile device which may operate in embodiments of the technology.

FIG. 21 is a block diagram of one embodiment of a computing system that can be used to implement a hub computing system.

FIG. 22 is a block diagram of one embodiment of a system used to provide a customized experience.

FIG. 23 is a block diagram of one embodiment of a system used to provide a customized experience.

FIG. 24 is a block diagram of one embodiment of a system used to provide a customized experience.

FIG. 25 is a flow chart describing one embodiment of a method for providing a customized experience.

FIG. 26 is a block diagram of one embodiment of a system used to provide a customized experience during a sporting event for a user remote from the event.

FIG. 27 is a flow chart describing one embodiment of a method for providing a customized experience during a sporting event for a user remote from the event.

FIG. 28 is a block diagram of one embodiment of a system used to provide a customized experience during a sporting event for a user at the event.

FIGS. 29A-C are flow charts describing one embodiment of a method for providing a customized experience during a sporting event for a user at the event.

FIG. 30 is a flow chart describing one embodiment of a method for providing a customized experience while a user plays a sporting event.

FIG. 31 is a flow chart describing one embodiment of a method for providing a customized experience while a user plays a sporting event or exercises.

FIG. 32 is a flow chart describing one embodiment of a method for providing a customized experience while a user exercises.

FIG. 33 is a flow chart describing one embodiment of a method for sharing a game using a personal A/V system.

FIG. 34 depicts one embodiment of a system for viewing a remote sporting event at a different stadium.

FIGS. 35A and 35B are flow charts describing one embodiment of a method for viewing a remote sporting event at a different stadium.

FIGS. 36A and 36B are flow charts describing one embodiment of a method for providing a customized shopping experience using a personal A/V apparatus.

FIG. 37 is a flow chart describing one embodiment of a method for providing a customized shopping experience using a personal A/V apparatus.

FIG. 38 is a flow chart describing one embodiment of a method for automatically providing a customized list using a personal A/V apparatus.

FIGS. 39A and 39B are flow charts describing embodiments of methods for maintaining inventories.

FIG. 39C is a flow chart describing one embodiment of a method for automatically identifying recipes using a personal A/V apparatus.

FIG. 39D is a flow chart describing one embodiment of a method for automatically identifying menus using a personal A/V apparatus.

FIGS. 40A-D and 41 are flow charts describing embodiments for implementing dietary restrictions.

FIGS. 42A and 42B are flow charts describing various embodiments of methods for aggregating group demand to improve transactions.

FIG. 43 is a flow chart describing one embodiment of a method for provisioning services through a personal A/V apparatus.

FIG. 44 is a block diagram describing one embodiment of an information system for use at a public place of interest.

FIG. 45 is a flow chart describing one embodiment of a method for updating metrics.

FIG. 46 is a flow chart describing one embodiment of a method for using a personal A/V apparatus in conjunction with an information system to navigate and use a public place of interest.

FIG. 47 is a flow chart describing one embodiment of a process for providing personal content to a user of a personal A/V apparatus while the user is waiting.

FIG. 48A is a flow chart describing one embodiment of a process for providing a personalized enhancement of a ride or attraction.

FIG. 48B is a flow chart describing one embodiment of a process for implementing an enhancement package while user is in/on attraction.

FIG. 49 is a flow chart describing one embodiment of a process for providing a personalized experience to a user of a personal A/V apparatus viewing a historical perspective of a modern location.

FIG. 50 is a flow chart describing one embodiment of a process for using a personal A/V apparatus as a virtual guide.

FIG. 51 is a flow chart describing one embodiment of a process for providing a virtual environment.

FIG. 52 is a flow chart describing one embodiment of a process for using a personal A/V apparatus within a limited location.

### DETAILED DESCRIPTION

The technology described herein incudes a see-through, near-eye, mixed reality display device for providing customized experiences for a user. The system can be used in various entertainment, sports, shopping and theme-park situations to provide a mixed reality experience.

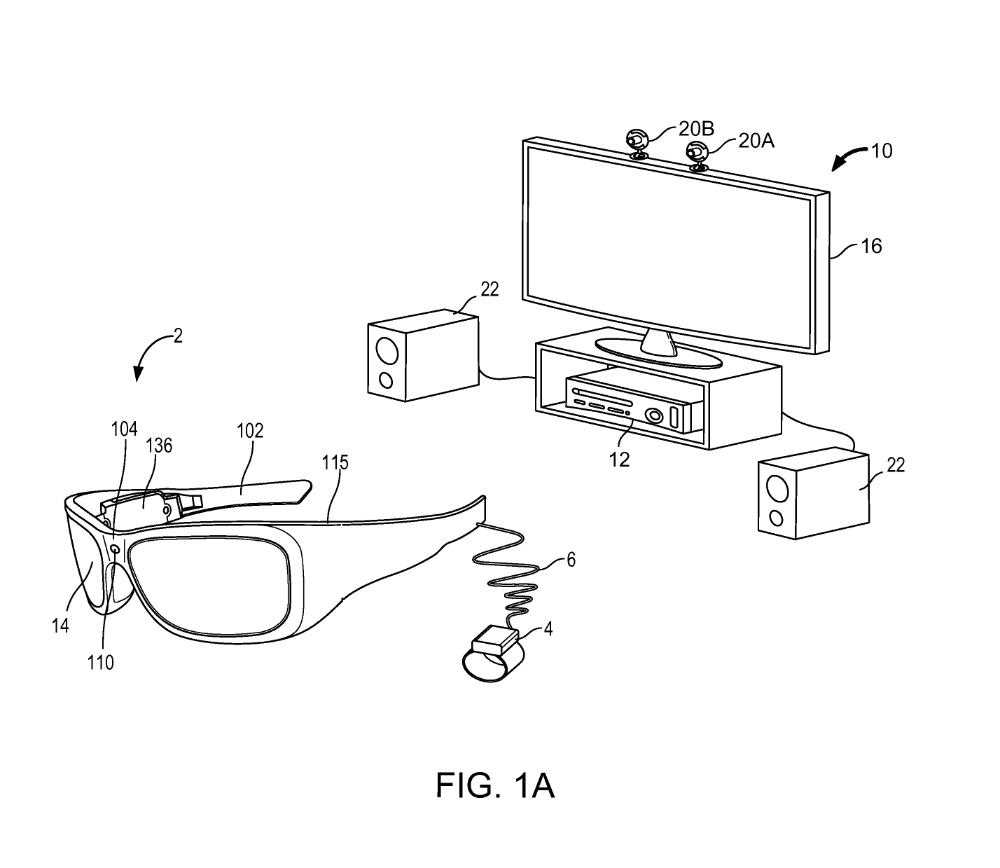

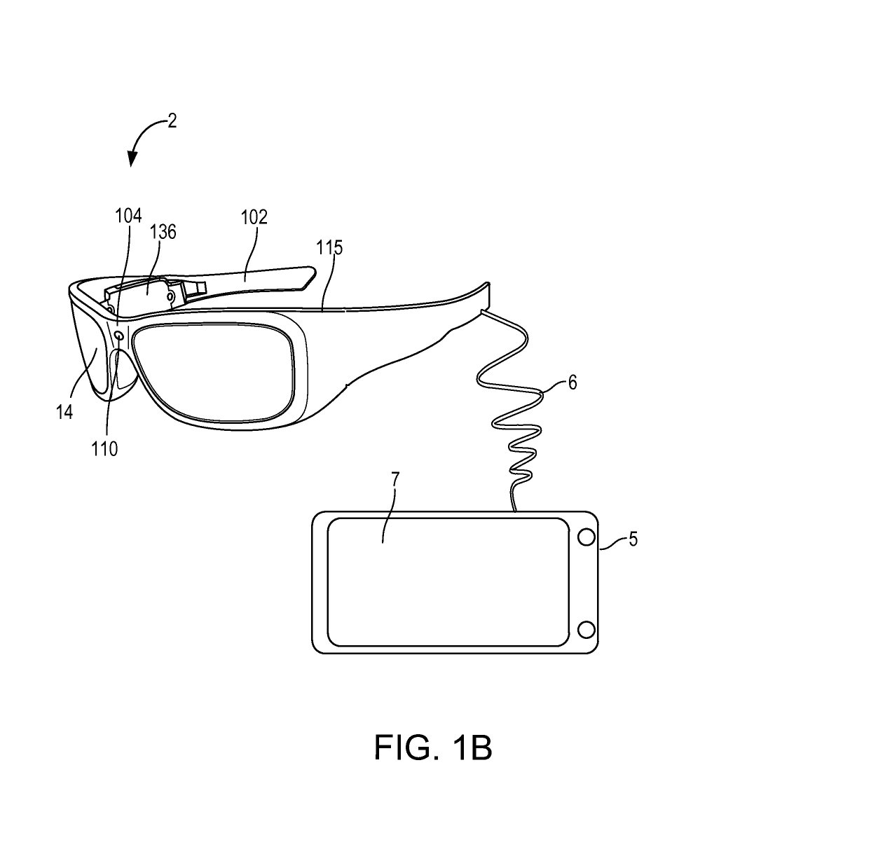

FIG. 1A is a block diagram depicting example components of one embodiment of a see-through, mixed reality display device in a system environment in which the device may operate. System 10 includes a see-through display device as a near-eye, head mounted display device 2 in communication with processing unit 4 via wire 6. In other embodiments, head mounted display device 2 communicates with processing unit 4 via wireless communication. Processing unit 4 may take various embodiments. In some embodiments, processing unit 4 is a separate unit which may be worn on the user's body, e.g. the wrist in the illustrated example or in a pocket, and includes much of the computing power used to operate near-eye display device 2. Processing unit 4 may communicate wirelessly (e.g., WiFi, Bluetooth, infra-red, or other wireless communication means) to one or more hub computing systems 12, hot spots, cellular data networks, etc. In other embodiments, the functionality of the processing unit 4 may be integrated in software and hardware components of the display device 2.

Head mounted display device 2, which in one embodiment is in the shape of eyeglasses in a frame 115, is worn on the head of a user so that the user can see through a display, embodied in this example as a display optical system 14 for each eye, and thereby have an actual direct view of the space in front of the user. The use of the term “actual direct view” refers to the ability to see real world objects directly with the human eye, rather than seeing created image representations of the objects. For example, looking through glass at a room allows a user to have an actual direct view of the room, while viewing a video of a room on a television is not an actual direct view of the room. Based on the context of executing software, for example, a gaming application, the system can project images of virtual objects, sometimes referred to as virtual images, on the display that are viewable by the person wearing the see-through display device while that person is also viewing real world objects through the display.

Frame 115 provides a support for holding elements of the system in place as well as a conduit for electrical connections. In this embodiment, frame 115 provides a convenient eyeglass frame as support for the elements of the system discussed further below. In other embodiments, other support structures can be used. An example of such a structure is a visor. hat, helmet or goggles. The frame 115 includes a temple or side arm for resting on each of a user's ears. Temple 102 is representative of an embodiment of the right temple and includes control circuitry 136 for the display device 2. Nose bridge 104 of the frame includes a microphone 110 for recording sounds and transmitting audio data to processing unit 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. An application may be executing on hub computing system 12, the display device 2, as discussed below on a mobile device 5 or a combination of these.

Hub computing system 12 further includes one or more capture devices, such as capture devices 20A and 20B. In other embodiments, more or less than two capture devices can be used to capture the room or other physical environment of the user.

Capture devices 20A and 20B may be, for example, cameras that visually monitor one or more users and the surrounding space such that gestures and/or movements performed by the one or more users, as well as the structure of the surrounding space, may be captured, analyzed, and tracked to perform one or more controls or actions within an application and/or animate an avatar or on-screen character.

Hub computing system 12 may be connected to an audiovisual device 16 such as a television, a monitor, a high-definition television (HDTV), or the like that may provide game or application visuals. In some instances, the audiovisual device 16 may be a three-dimensional display device. In one example, audiovisual device 16 includes internal speakers. In other embodiments, audiovisual device 16, a separate stereo or hub computing system 12 is connected to external speakers 22.

Note that display device 2 and processing unit 4 can be used without Hub computing system 12, in which case processing unit 4 will communicate with a WiFi network, a cellular network or other communication means.

FIG. 1B is a block diagram depicting example components of another embodiment of a see-through, mixed reality display device. In this embodiment, the near-eye display device 2 communicates with a mobile computing device 5 as an example embodiment of the processing unit 4. In the illustrated example, the mobile device 5 communicates via wire 6, but communication may also be wireless in other examples.

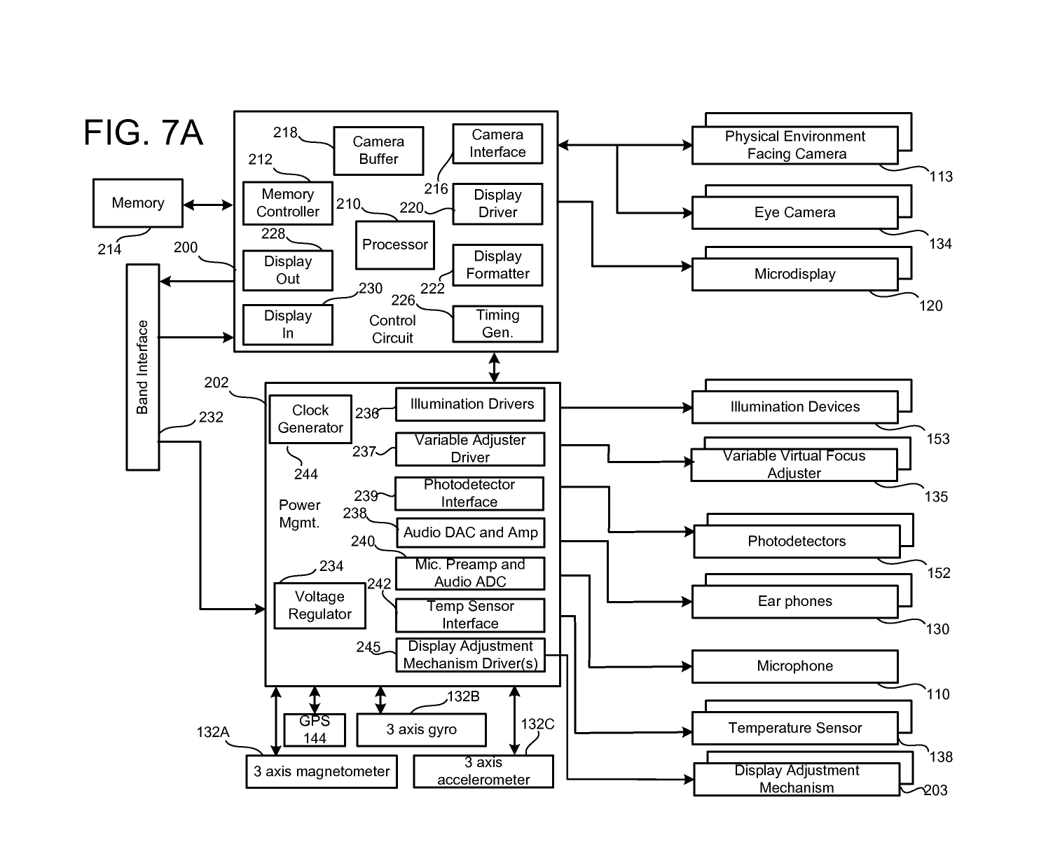

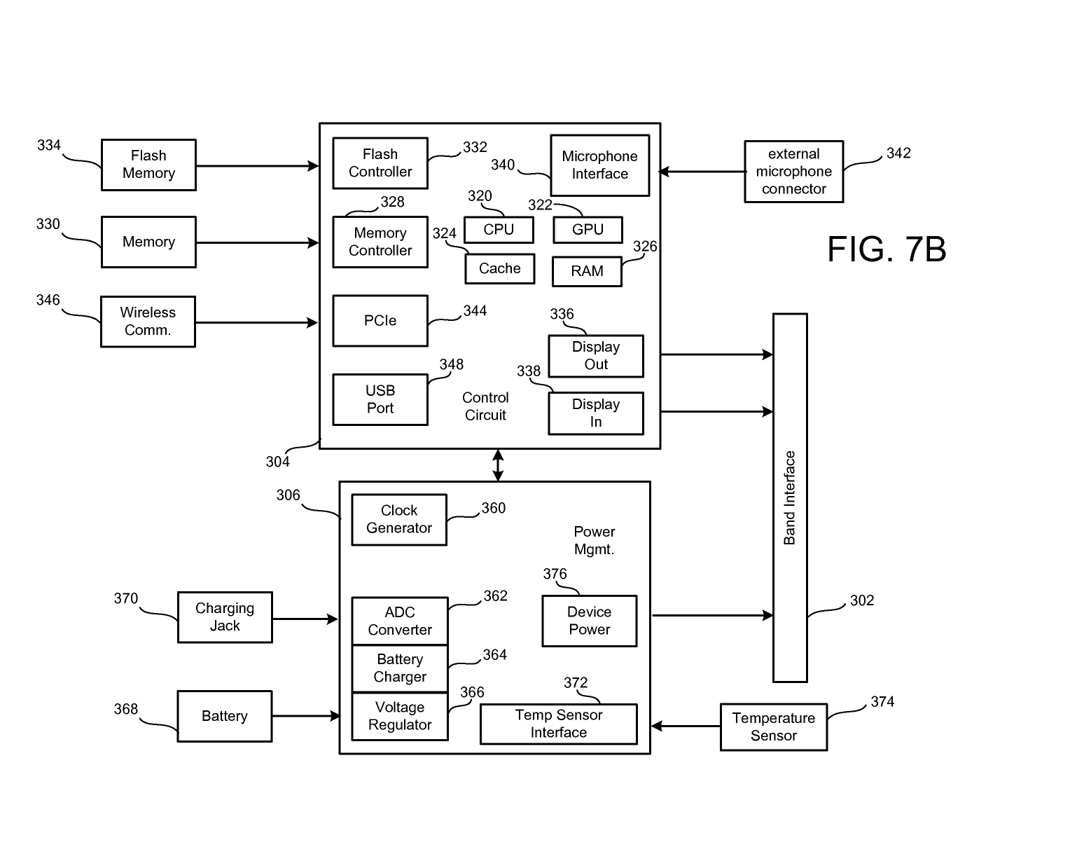

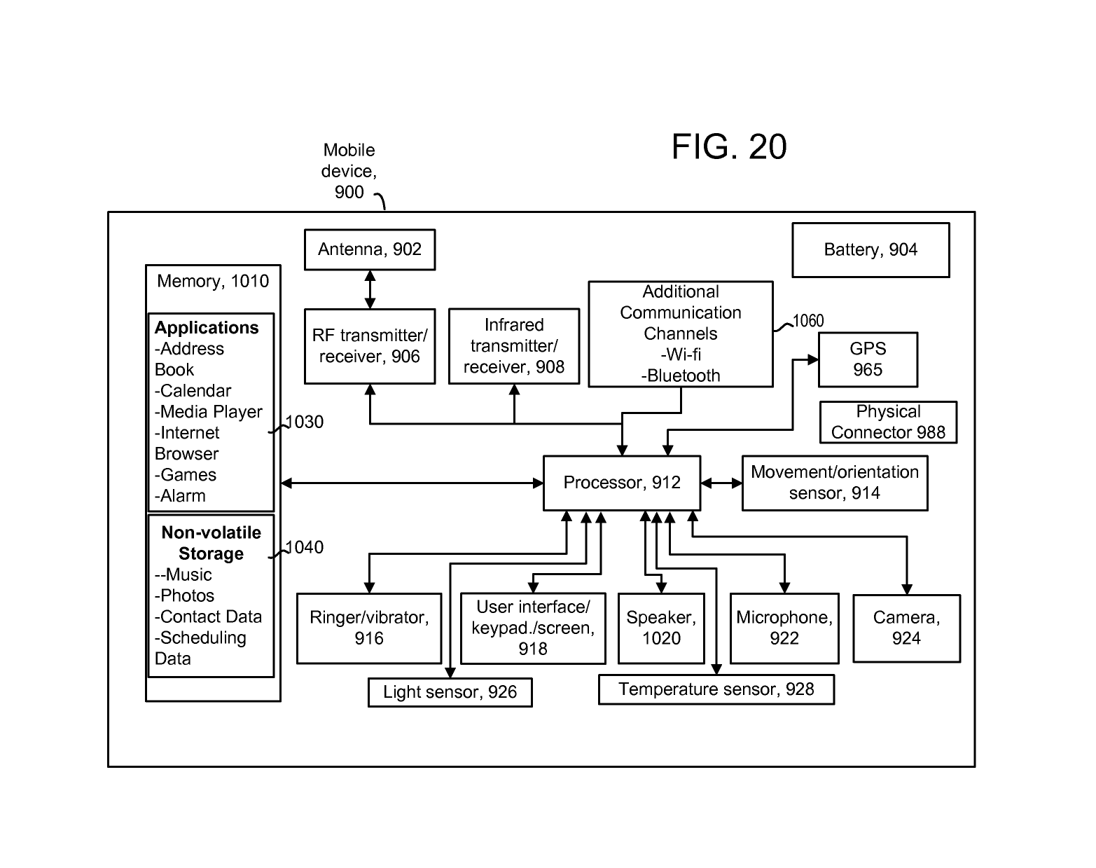

Furthermore, as in the hub computing system 12, gaming and non-gaming applications may execute on a processor of the mobile device 5 which user actions control or which user actions animate an avatar as may be displayed on a display 7 of the device 5. The mobile device 5 also provides a network interface for communicating with other computing devices like hub computing system 12 over the Internet or via another communication network via a wired or wireless communication medium using a wired or wireless communication protocol. A remote network accessible computer system like hub computing system 12 may be leveraged for processing power and remote data access by a processing unit 4 like mobile device 5. Examples of hardware and software components of a mobile device 5 such as may be embodied in a smartphone or tablet computing device are described in FIG. 20, and these components can embody the hardware and software components of a processing unit 4 such as those discussed in the embodiment of FIG. 7A. Some other examples of mobile devices 5 are a laptop or notebook computer and a netbook computer.

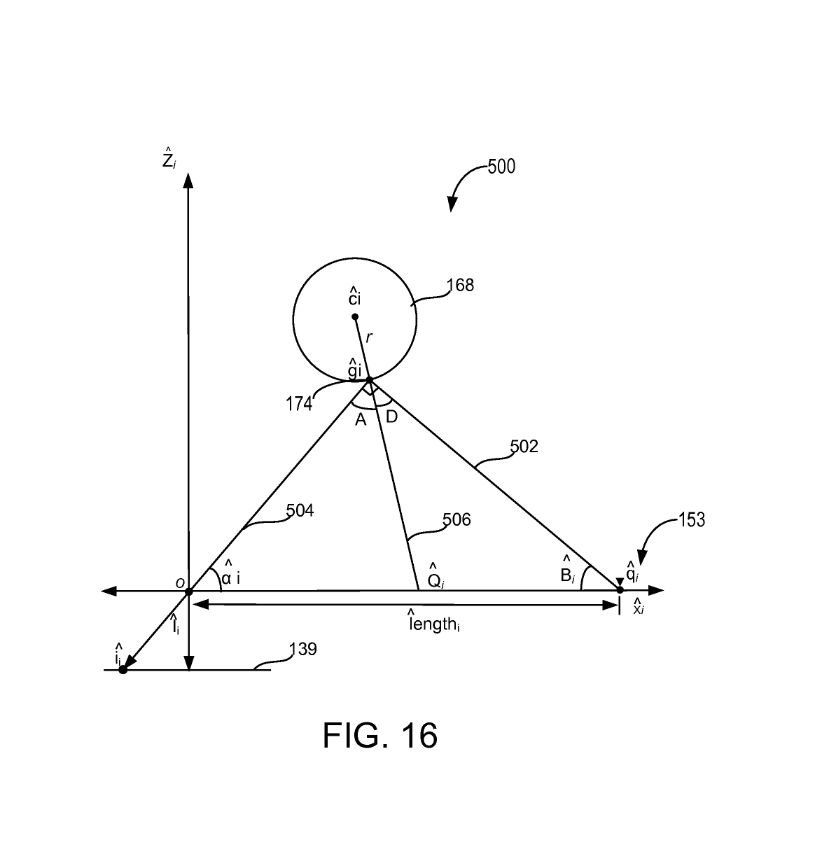

In some embodiments, gaze detection of each of a user's eyes is based on a three dimensional coordinate system of gaze detection elements on a near-eye, mixed reality display device like the eyeglasses 2 in relation to one or more human eye elements such as a cornea center, a center of eyeball rotation and a pupil center. Examples of gaze detection elements which may be part of the coordinate system including glint generating illuminators and at least one sensor for capturing data representing the generated glints. As discussed below (see FIG. 16 discussion), a center of the cornea can be determined based on two glints using planar geometry. The center of the cornea links the pupil center and the center of rotation of the eyeball, which may be treated as a fixed location for determining an optical axis of the user's eye at a certain gaze or viewing angle.

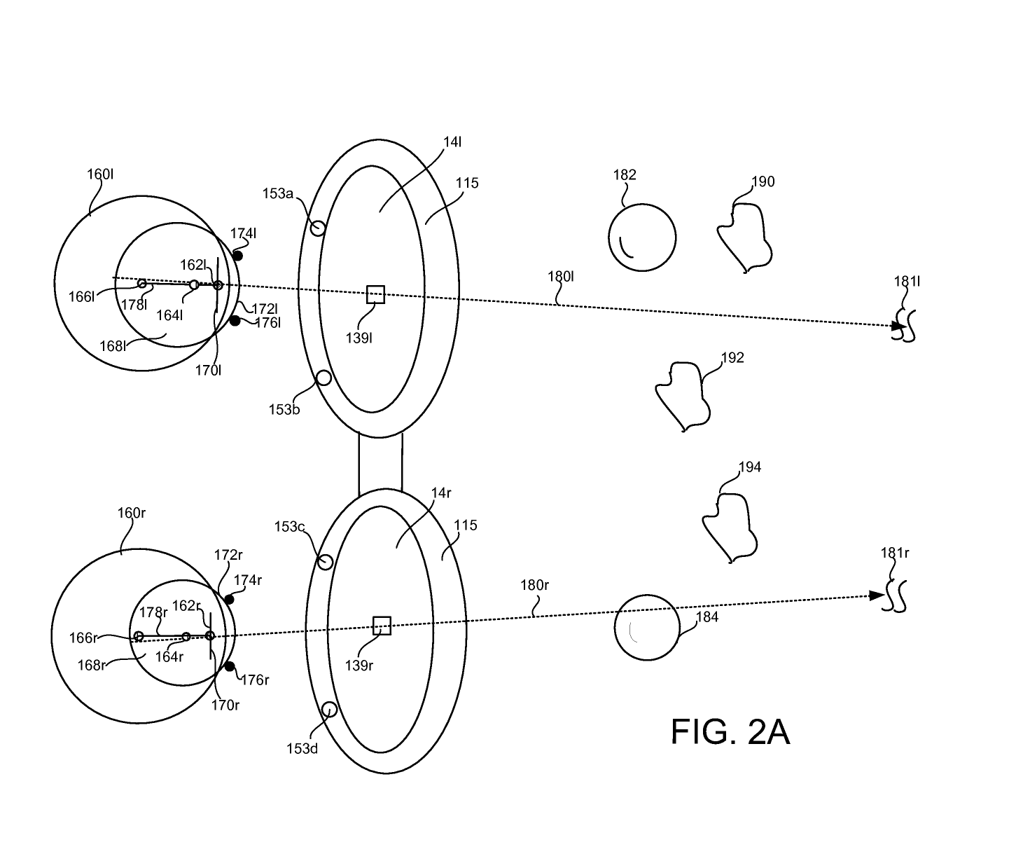

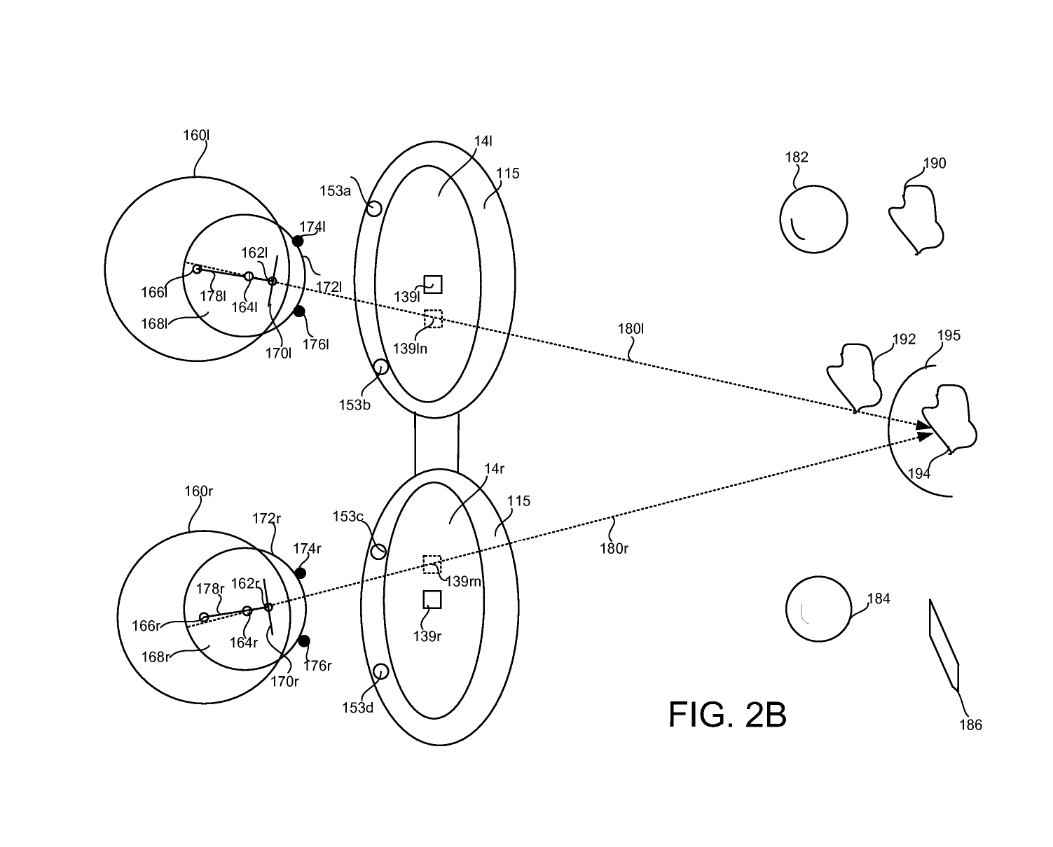

FIG. 2A is a top view illustrating examples of gaze vectors extending to a point of gaze at a distance and direction for aligning a far inter-pupillary distance (IPD). FIG. 2A illustrates examples of gaze vectors intersecting at a point of gaze where a user's eyes are focused effectively at infinity, for example beyond five (5) feet, or, in other words, examples of gaze vectors when the user is looking straight ahead. A model of the eyeball 1601, 160r is illustrated for each eye based on the Gullstrand schematic eye model. For each eye, an eyeball 160 is modeled as a sphere with a center of rotation 166 and includes a cornea 168 modeled as a sphere too and having a center 164. The cornea rotates with the eyeball, and the center 166 of rotation of the eyeball may be treated as a fixed point. The cornea covers an iris 170 with a pupil 162 at its center. In this example, on the surface 172 of the respective cornea are glints 174 and 176.

In the illustrated embodiment of FIG. 2A, a sensor detection area 139 (139l and 139r) is aligned with the optical axis of each display optical system 14 within an eyeglass frame 115. The sensor associated with the detection area is a camera in this example capable of capturing image data representing glints 1741 and 1761 generated respectively by illuminators 153a and 153b on the left side of the frame 115 and data representing glints 174r and 176r generated respectively by illuminators 153c and 153d. Through the display optical systems, 14l and 14r in the eyeglass frame 115, the user's field of view includes both real objects 190, 192 and 194 and virtual objects 182, 184, and 186.

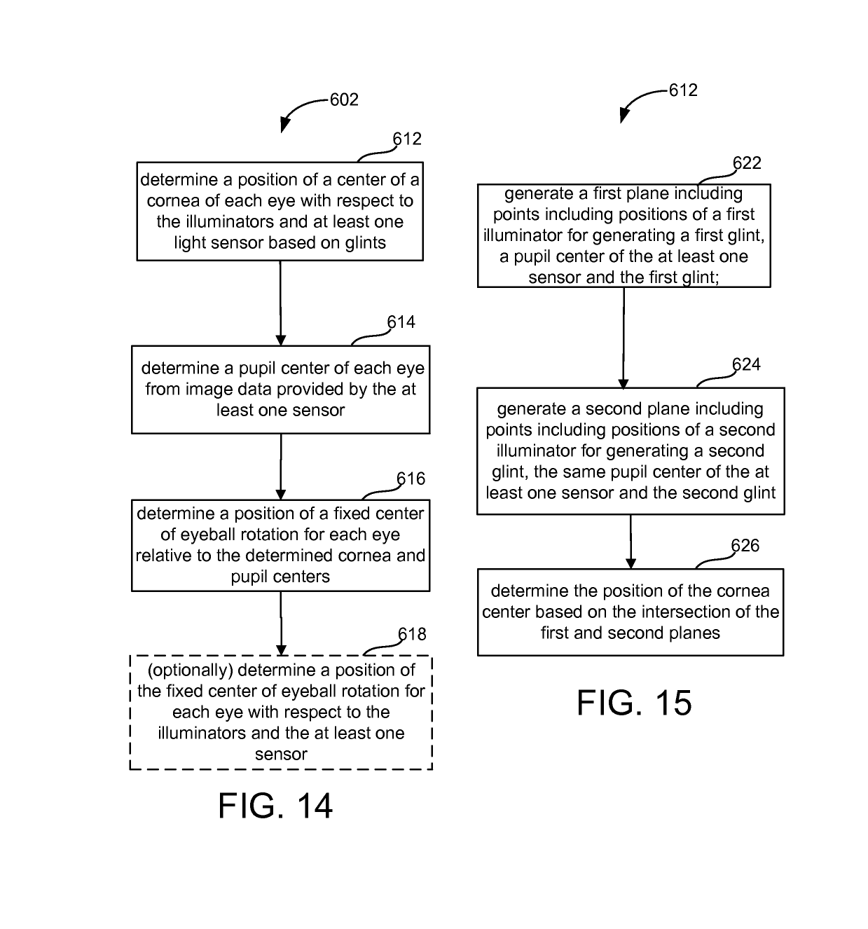

The axis 178 formed from the center of rotation 166 through the cornea center 164 to the pupil 162 is the optical axis of the eye. A gaze vector 180 is sometimes referred to as the line of sight or visual axis which extends from the fovea through the center of the pupil 162. The fovea is a small area of about 1.2 degrees located in the retina. The angular offset between the optical axis computed in the embodiment of FIG. 14 and the visual axis has horizontal and vertical components. The horizontal component is up to 5 degrees from the optical axis, and the vertical component is between 2 and 3 degrees. In many embodiments, the optical axis is determined and a small correction is determined through user calibration to obtain the visual axis which is selected as the gaze vector. For each user, a virtual object may be displayed by the display device at each of a number of predetermined positions at different horizontal and vertical positions. An optical axis may be computed for each eye during display of the object at each position, and a ray modeled as extending from the position into the user eye. A gaze offset angle with horizontal and vertical components may be determined based on how the optical axis must be moved to align with the modeled ray. From the different positions, an average gaze offset angle with horizontal or vertical components can be selected as the small correction to be applied to each computed optical axis. In some embodiments, only a horizontal component is used for the gaze offset angle correction.

The visual axes 180l and 180r illustrate that the gaze vectors are not perfectly parallel as the vectors become closer together as they extend from the eyeball into the field of view at a point of gaze which is effectively at infinity as indicated by the symbols 181l and 181r. At each display optical system 14, the gaze vector 180 appears to intersect the optical axis upon which the sensor detection area 139 is centered. In this configuration, the optical axes are aligned with the inter-pupillary distance (IPD). When a user is looking straight ahead, the IPD measured is also referred to as the far IPD.

When identifying an object for a user to focus on for aligning IPD at a distance, the object may be aligned in a direction along each optical axis of each display optical system. Initially, the alignment between the optical axis and user's pupil is not known. For a far IPD, the direction may be straight ahead through the optical axis. When aligning near IPD, the identified object may be in a direction through the optical axis, however due to vergence of the eyes necessary for close distances, the direction is not straight ahead although it may be centered between the optical axes of the display optical systems.

FIG. 2B is a top view illustrating examples of gaze vectors extending to a point of gaze at a distance and a direction for aligning a near IPD. In this example, the cornea 168l of the left eye is rotated to the right or towards the user's nose, and the cornea 168r of the right eye is rotated to the left or towards the user's nose. Both pupils are gazing at a real object 194 at a much closer distance, for example two (2) feet in front of the user. Gaze vectors 180l and 180r from each eye enter the Panum's fusional region 195 in which real object 194 is located. The Panum's fusional region is the area of single vision in a binocular viewing system like that of human vision. The intersection of the gaze vectors 180l and 180r indicates that the user is looking at real object 194. At such a distance, as the eyeballs rotate inward, the distance between their pupils decreases to a near IPD. The near IPD is typically about 4 mm less than the far IPD. A near IPD distance criteria, e.g. a point of gaze at less than four feet for example, may be used to switch or adjust the IPD alignment of the display optical systems 14 to that of the near IPD. For the near IPD, each display optical system 14 may be moved toward the user's nose so the optical axis, and detection area 139, moves toward the nose a few millimeters as represented by detection areas 139ln and 139rn.

Users do not typically know their IPD data. The discussion below illustrates some embodiments of methods and systems for determining the IPD for the user, and adjusting the display optical systems accordingly.

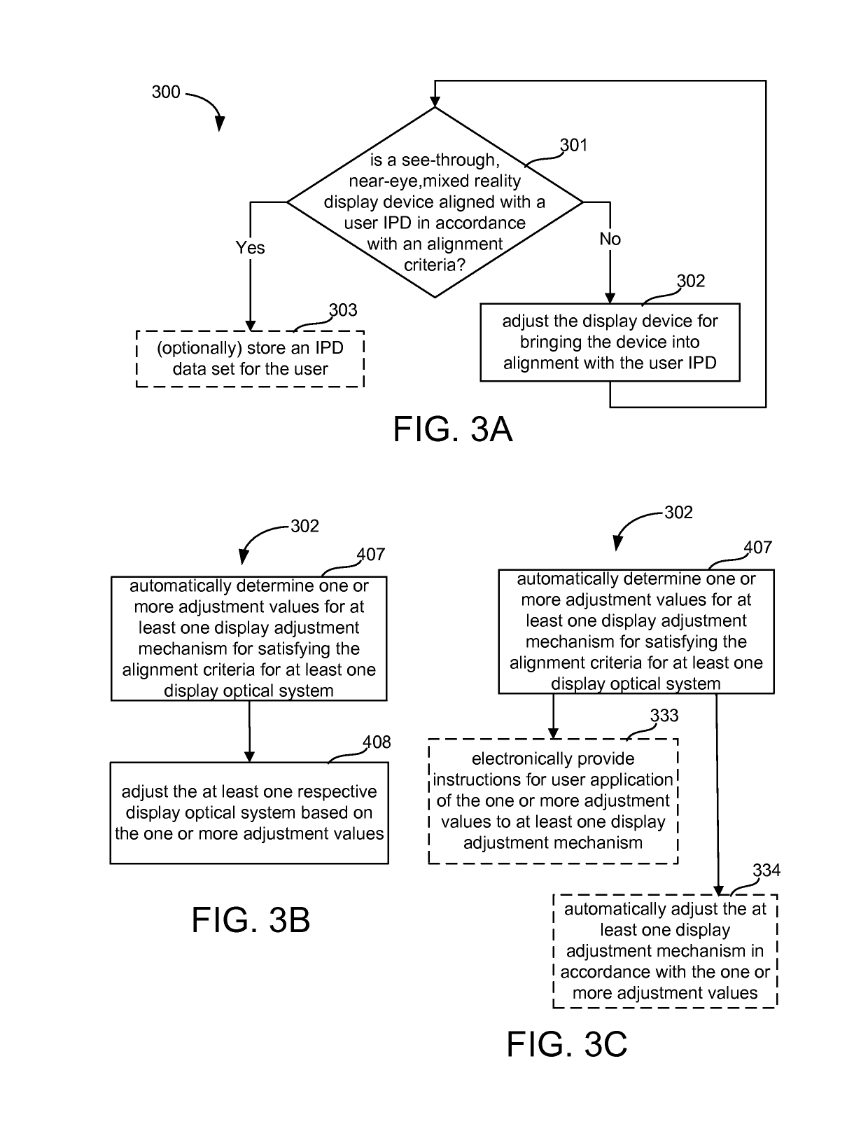

FIG. 3A is a flowchart of a method embodiment 300 for aligning a see-through, near-eye, mixed reality display with an IPD. In step 301, one or more processors of the control circuitry 136, e.g. processor 210 in FIG. 7A below, the processing unit 4, 5, the hub computing system 12 or a combination of these automatically determines whether a see-through, near-eye, mixed reality display device is aligned with an IPD of a user in accordance with an alignment criteria. If not, in step 302, the one or more processors cause adjustment of the display device by at least one display adjustment mechanism for bringing the device into alignment with the user IPD. If it is determined the see-through, near-eye, mixed reality display device is in alignment with a user IPD, optionally, in step 303 an IPD data set is stored for the user. In some embodiments, a display device 2 may automatically determine whether there is IPD alignment every time anyone puts on the display device 2. However, as IPD data is generally fixed for adults, due to the confines of the human skull, an IPD data set may be determined typically once and stored for each user. The stored IPD data set may at least be used as an initial setting for a display device with which to begin an IPD alignment check.

A display device 2 has a display optical system for each eye, and in some embodiments, the one or more processors store the IPD as the distance between the optical axes of the display optical systems at positions which satisfy the alignment criteria. In some embodiments, the one or more processors store the position of each optical axis in the IPD data set. The IPD for a user may be asymmetrical, for example with respect to the user's nose. For instance, the left eye is a little closer to the nose than the right eye is. In one example, adjustment values of a display adjustment mechanism for each display optical system from an initial position may be saved in the IPD data set. The initial position of the display adjustment mechanism may have a fixed position with respect to a stationary frame portion, for example a point on the bridge 104. Based on this fixed position with respect to the stationary frame portion, and the adjustment values for one or more directions of movement, a position of each optical axis with respect to the stationary frame portion may be stored as a pupil alignment position for each display optical system. Additionally, in the case of the stationary frame portion being a point on the bridge, a position vector of the respective pupil to the user's nose may be estimated for each eye based on the fixed position to the point on the bridge and the adjustment values. The two position vectors for each eye provide at least horizontal distance components, and can include vertical distance components as well. An inter-pupillary distance IPD in one or more directions may be derived from these distance components.

FIG. 3B is a flowchart of an implementation example of a method for adjusting a display device for bringing the device into alignment with a user IPD. In this method, at least one display adjustment mechanism adjusts the position of a at least one display optical system 14 which is misaligned. In step 407, one or more adjustment are automatically determined for the at least one display adjustment mechanism for satisfying the alignment criteria for at least one display optical system. In step 408, that at least one display optical system is adjusted based on the one or more adjustment values. The adjustment may be performed automatically under the control of a processor or mechanically as discussed further below.

FIG. 3C is a flowchart illustrating different example options of mechanical or automatic adjustment by the at least one display adjustment mechanism as may be used to implement step 408. Depending on the configuration of the display adjustment mechanism in the display device 2, from step 407 in which the one or more adjustment values were already determined, the display adjustment mechanism may either automatically, meaning under the control of a processor, adjust the at least one display adjustment mechanism in accordance with the one or more adjustment values in step 334. Alternatively, one or more processors associated with the system, e.g. a processor in processing unit 4, 5, processor 210 in the control circuitry 136, or even a processor of hub computing system 12 may electronically provide instructions as per step 333 for user application of the one or more adjustment values to the at least one display adjustment mechanism. There may be instances of a combination of automatic and mechanical adjustment under instructions.

Some examples of electronically provided instructions are instructions displayed by the microdisplay 120, the mobile device 5 or on a display 16 by the hub computing system 12 or audio instructions through speakers 130 of the display device 2. There may be device configurations with an automatic adjustment and a mechanical mechanism depending on user preference or for allowing a user some additional control.

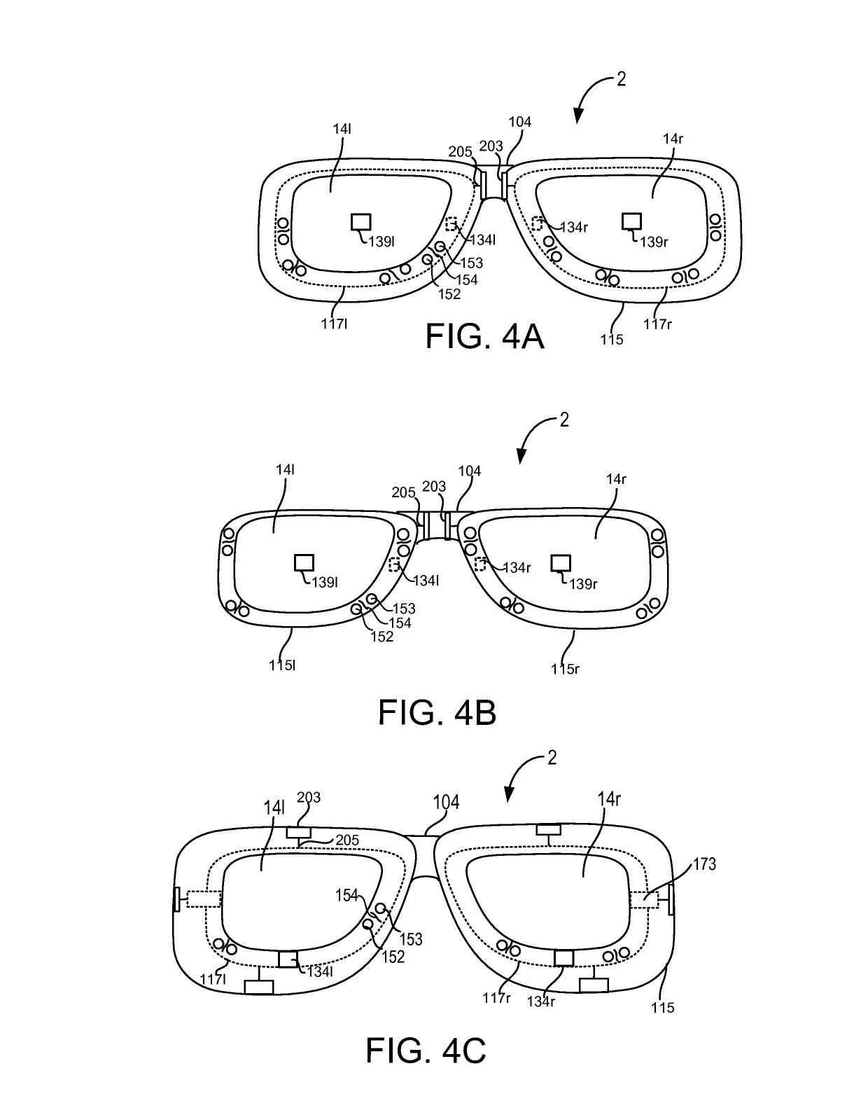

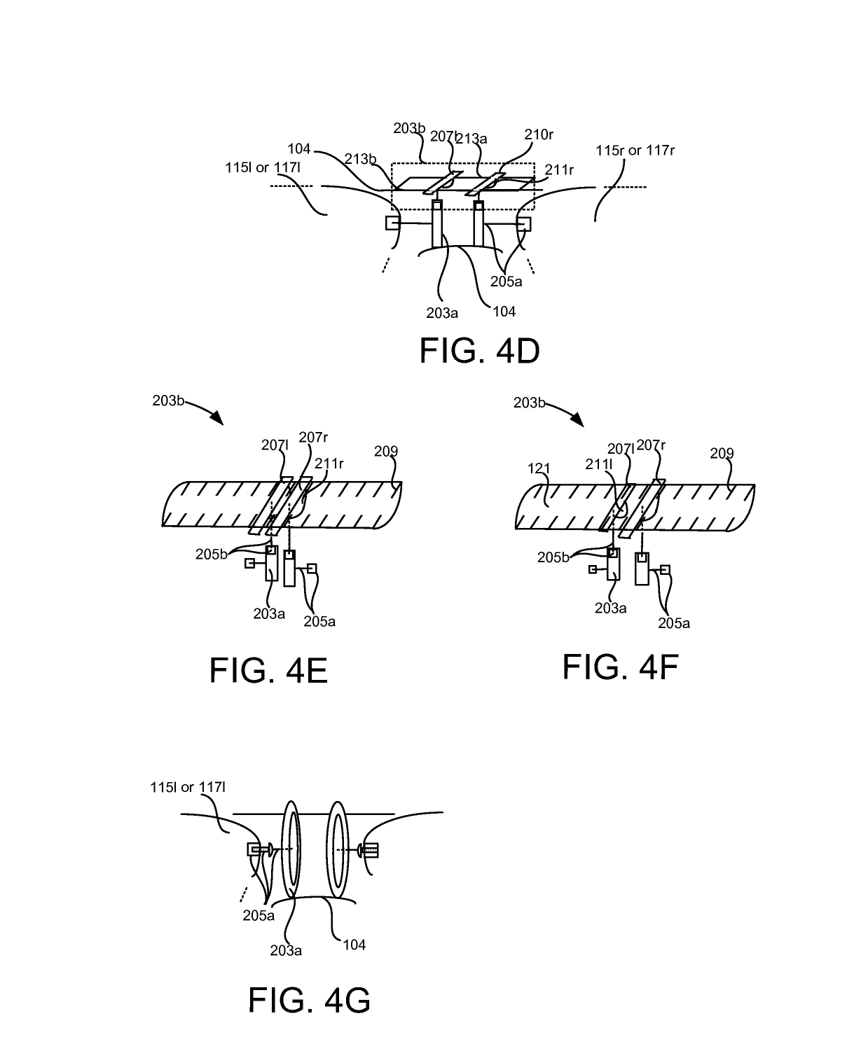

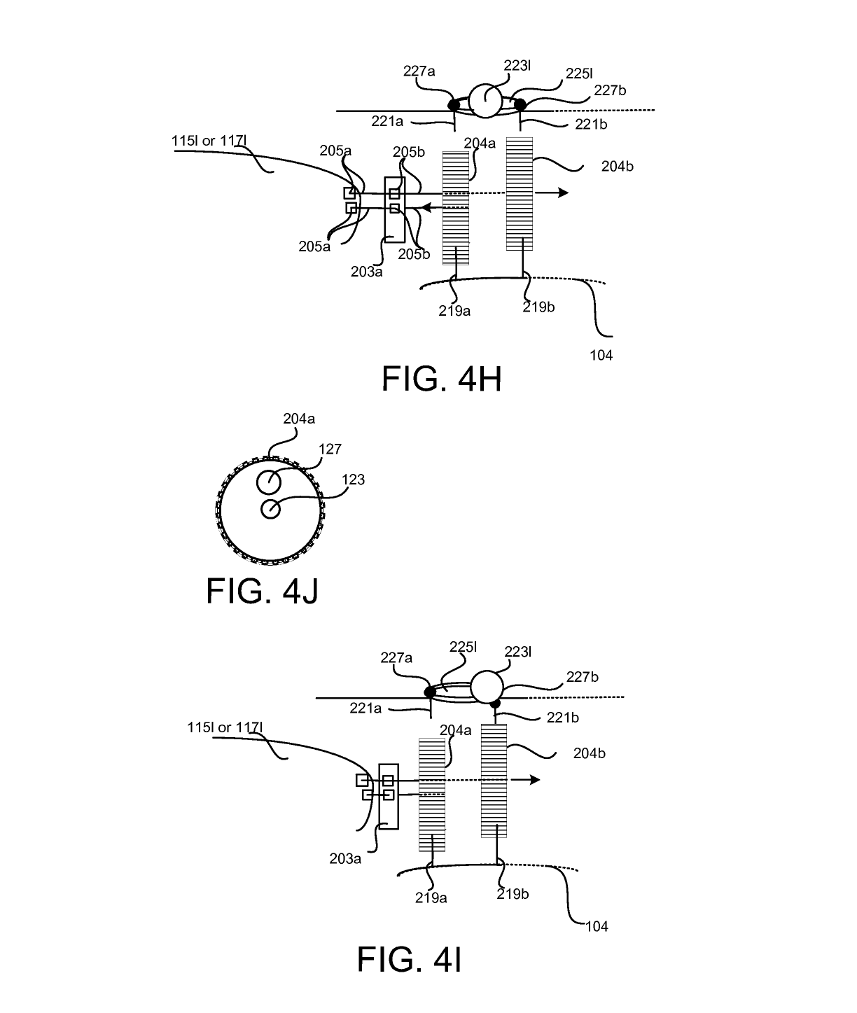

In many embodiments, the display adjustment mechanism includes a mechanical controller which has a calibration for user activation of the controller to correspond to a predetermined distance and direction for movement of at least one display optical system; and the processor determines the content of the instructions based on the calibration. In the examples below for FIGS. 4D through 4J, examples are provided of mechanical display adjustment mechanisms which correlate a mechanical action or user activated action of a wheel turn or button press with a particular distance. Instructions to the user displayed may include a specific sequence of user activations correlating to a predetermined distance. The user is providing the force rather than an electrically controlled component, but the sequence of instructions is determined to result in the desired position change. For example, a cross hair may be displayed as a guide to a user, and the user is told to move a slider three slots to the right. This results in for example, a 3 mm predetermined repositioning of the display optical system.

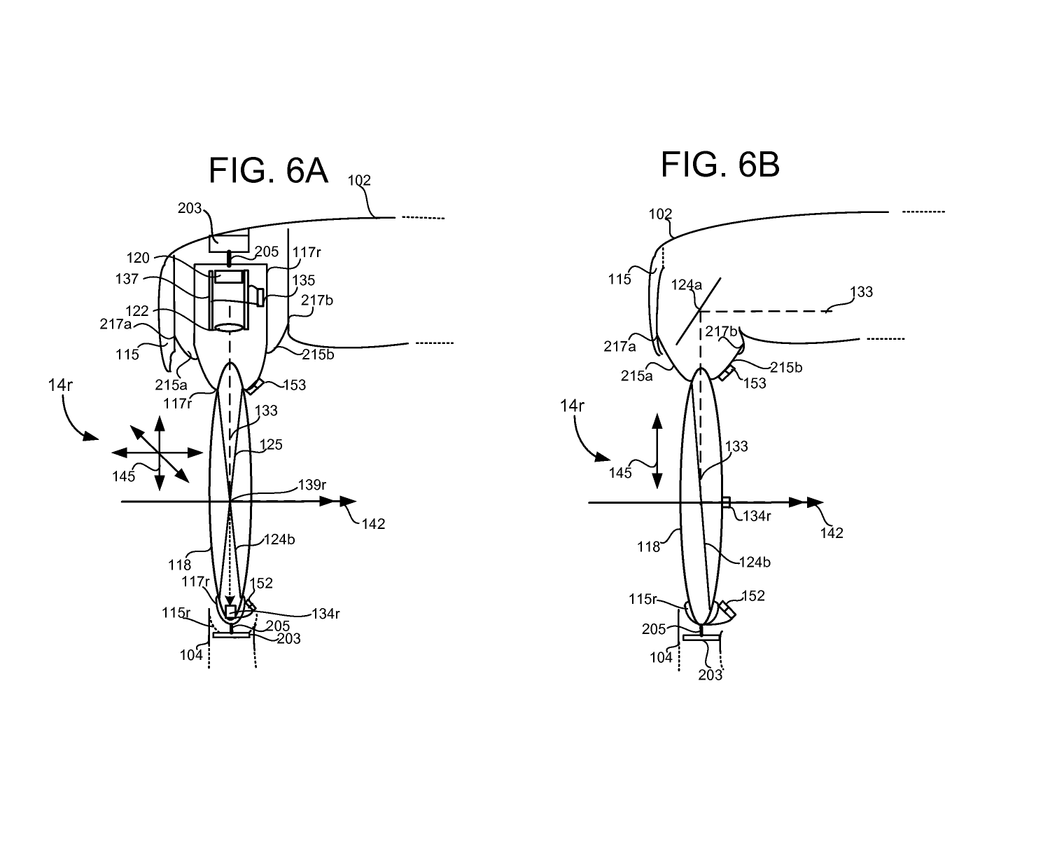

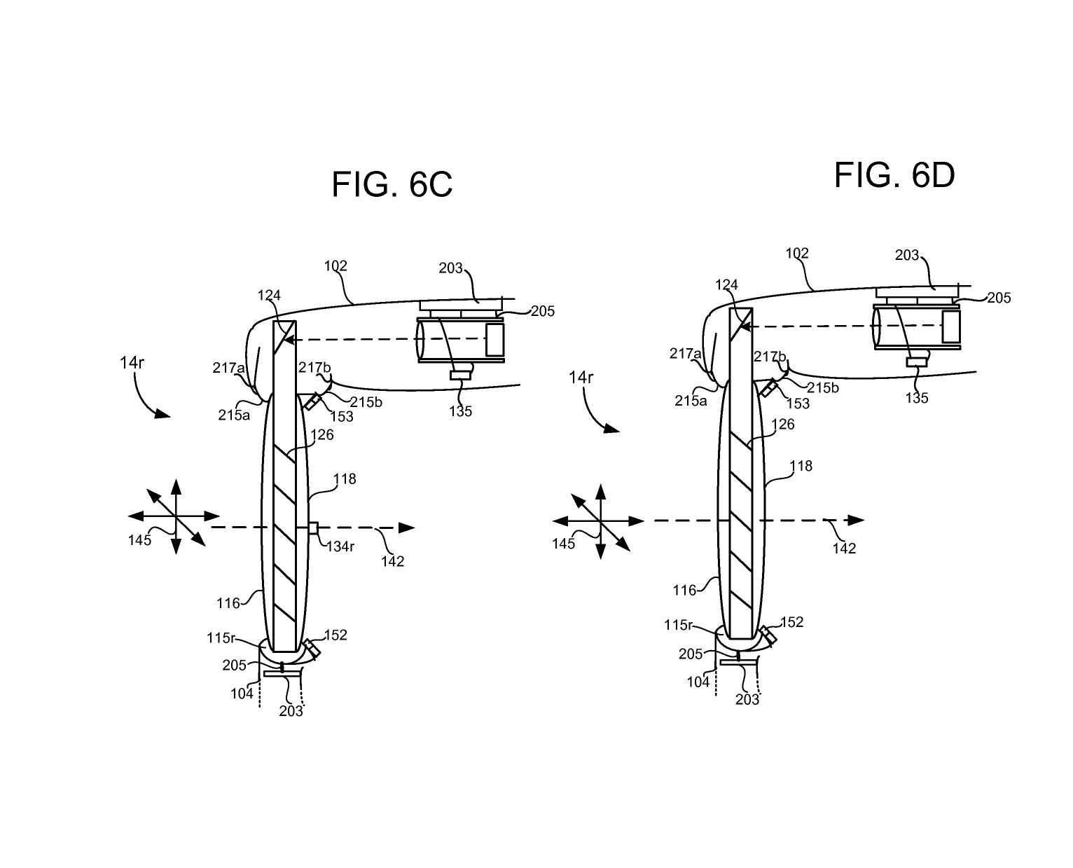

FIG. 4A illustrates an exemplary arrangement of a see through, near-eye, mixed reality display device embodied as eyeglasses with movable display optical systems including gaze detection elements. What appears as a lens for each eye represents a display optical system 14 for each eye, e.g. 14r and 14l. A display optical system includes a see-through lens, e.g. 118 and 116 in FIGS. 6A-6D, as in an ordinary pair of glasses, but also contains optical elements (e.g. mirrors, filters) for seamlessly fusing virtual content with the actual direct real world view seen through the lenses 118, 116. A display optical system 14 has an optical axis which is generally in the center of the see-through lens 118, 116 in which light is generally collimated to provide a distortionless view. For example, when an eye care professional fits an ordinary pair of eyeglasses to a user's face, a goal is that the glasses sit on the user's nose at a position where each pupil is aligned with the center or optical axis of the respective lens resulting in generally collimated light reaching the user's eye for a clear or distortionless view.

In the example of FIG. 4A, a detection area 139r, 1391 of at least one sensor is aligned with the optical axis of its respective display optical system 14r, 14l so that the center of the detection area 139r, 1391 is capturing light along the optical axis. If the display optical system 14 is aligned with the user's pupil, each detection area 139 of the respective sensor 134 is aligned with the user's pupil. Reflected light of the detection area 139 is transferred via one or more optical elements to the actual image sensor 134 of the camera, in this example illustrated by dashed line as being inside the frame 115.

In one example, a visible light camera (also commonly referred to as an RGB camera) may be the sensor. An example of an optical element or light directing element is a visible light reflecting mirror which is partially transmissive and partially reflective. The visible light camera provides image data of the pupil of the user's eye, while IR photodetectors 152 capture glints which are reflections in the IR portion of the spectrum. If a visible light camera is used, reflections of virtual images may appear in the eye data captured by the camera. An image filtering technique may be used to remove the virtual image reflections if desired. An IR camera is not sensitive to the virtual image reflections on the eye.

In other examples, the at least one sensor 134 (134l and 134r) is an IR camera or a position sensitive detector (PSD) to which the IR radiation may be directed. For example, a hot reflecting surface may transmit visible light but reflect IR radiation. The IR radiation reflected from the eye may be from incident radiation of the illuminators 153, other IR illuminators (not shown) or from ambient IR radiation reflected off the eye. In some examples, sensor 134 may be a combination of an RGB and an IR camera, and the light directing elements may include a visible light reflecting or diverting element and an IR radiation reflecting or diverting element. In some examples, a camera may be small, e.g. 2 millimeters (mm) by 2 mm. An example of such a camera sensor is the Omnivision OV7727. In other examples, the camera may be small enough, e.g. the Omnivision OV7727, e.g. that the image sensor or camera 134 may be centered on the optical axis or other location of the display optical system 14. For example, the camera 134 may be embedded within a lens of the system 14. Additionally, an image filtering technique may be applied to blend the camera into a user field of view to lessen any distraction to the user.

In the example of FIG. 4A, there are four sets of an illuminator 153 paired with a photodetector 152 and separated by a barrier 154 to avoid interference between the incident light generated by the illuminator 153 and the reflected light received at the photodetector 152. To avoid unnecessary clutter in the drawings, drawing numerals are shown with respect to a representative pair. Each illuminator may be an infra-red (IR) illuminator which generates a narrow beam of light at about a predetermined wavelength. Each of the photodetectors may be selected to capture light at about the predetermined wavelength. Infra-red may also include near-infrared. As there can be wavelength drift of an illuminator or photodetector or a small range about a wavelength may be acceptable, the illuminator and photodetector may have a tolerance range about a wavelength for generation and detection. In embodiments where the sensor is an IR camera or IR position sensitive detector (PSD), the photodetectors may be additional data capture devices and may also be used to monitor the operation of the illuminators, e.g. wavelength drift, beam width changes, etc. The photodetectors may also provide glint data with a visible light camera as the sensor 134.

As described below, in some embodiments which calculate a cornea center as part of determining a gaze vector, two glints, and therefore two illuminators will suffice. However, other embodiments may use additional glints in determining a pupil position and hence a gaze vector. As eye data representing the glints is repeatedly captured, for example at 30 frames a second or greater, data for one glint may be blocked by an eyelid or even an eyelash, but data may be gathered by a glint generated by another illuminator.

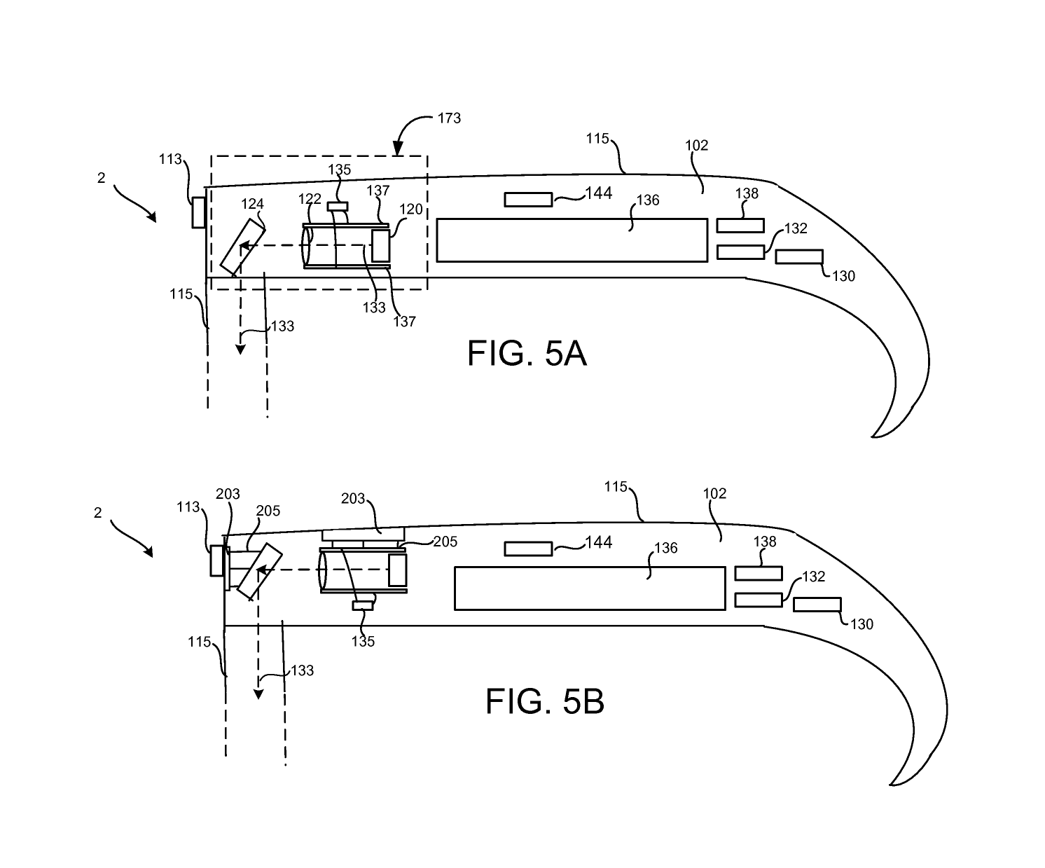

In FIG. 4A, each display optical system 14 and its arrangement of gaze detection elements facing each eye (such as camera 134 and its detection area 139, optical alignment elements [not shown in this Figure; see 6A-6D below], the illuminators 153 and photodetectors 152) are located on a movable inner frame portion 117l, 117r. In this example, a display adjustment mechanism comprises one or more motors 203 having a shaft 205 which attaches to an object for pushing and pulling the object in at least one of three dimensions. In this example, the object is the inner frame portion 117 which slides from left to right or vise versa within the frame 115 under the guidance and power of shafts 205 driven by motors 203. In other embodiments, one motor 203 may drive both inner frames. As discussed with reference to FIGS. 5A and 5B, a processor of control circuitry 136 of the display device 2 is able to connect to the one or more motors 203 via electrical connections within the frame 115 for controlling adjustments in different directions of the shafts 205 by the motors 203. Furthermore, the motors 203 access a power supply via the electrical connections of the frame 115 as well.

FIG. 4B illustrates another exemplary arrangement of a see through, near-eye, mixed reality display device embodied as eyeglasses with movable display optical systems including gaze detection elements. In this embodiment, each display optical system 14 is enclosed in a separate frame portion 115l, 115r, e.g. a separate eyeglass framed section, which is movable individually by the motors 203. In some embodiments, the movement range in any dimension is less than 10 millimeters. In some embodiments, the movement range is less than 6 millimeters depending on the range of frame sizes offered for a product. For the horizontal direction, moving each frame a few millimeters left or right will not impact significantly the width between the eyeglass temples, e.g. 102, which attach the display optical systems 14 to the user's head. Additionally, in this embodiment, two sets of illuminator 153 and photodetector 152 pairs are positioned near the top of each frame portion 115l, 115r for illustrating another example of a geometrical relationship between illuminators and hence the glints they generate. This arrangement of glints may provide more information on a pupil position in the vertical direction. In other embodiments like that in FIG. 4A where the illuminators are closer to one side of the frame portions 115l, 115r, 117l, 117r, the illuminators 153 may be positioned at different angles with respect to the frame portion for directing light at different portions of the eye, for also obtaining more vertical and horizontal components for identifying a pupil position.

FIG. 4C illustrates another exemplary arrangement of a see through, near-eye, mixed reality display device embodied as eyeglasses with movable display optical systems including gaze detection elements. In this example, the sensor 134r, 134l is in line or aligned with the optical axis at about the center of its respective display optical system 14r, 14l but located on the frame 115 below the system 14. Additionally, in some embodiments, the camera 134 may be a depth camera or include a depth sensor. In this example, there are two sets of illuminators 153 and photodetectors 152.

An inter-pupillary distance may describe the distance between a user's pupils in a horizontal direction, but vertical differences may also be determined. Additionally, moving a display optical system in a depth direction between the eye and the display device 2 may also assist in aligning the optical axis with the user's pupil. A user may actually have different depths of their eyeballs within the skull. Movement of the display device in the depth direction with respect to the head may also introduce misalignment between the optical axis of the display optical system 14 and its respective pupil.

In this example, the motors form an example of a XYZ transport mechanism for moving each display optical system 14 in three dimensions. The motors 203 in this example are located on the outer frame 115 and their shafts 205 are attached to the top and bottom of the respective inner frame portion 117. The operation of the motors 203 are synchronized for their shaft movements by the control circuitry 136 processor 210. Additionally, as this is a augmented/mixed reality device, each image generation unit (e.g., microdisplay assembly 173 for creating images of virtual objects or virtual images for display in the respective display optical system 14) is moved by a motor and shaft as well to maintain optical alignment with the display optical system. Examples of microdisplay assemblies 173 are described further below. In this example, the motors 203 are three axis motors or can move their shafts in three dimensions. For example, the shaft may be pushed and pulled in one axis of direction along a center of a cross-hair guide and move in each of two perpendicular directions in the same plane within the perpendicular openings of the cross-hair guide.

FIGS. 4D, 4E and 4F illustrate different views of an example of a mechanical display adjustment mechanism using a sliding mechanism which is an example of a mechanical controller a user may activate for moving a display optical system. FIG. 4D illustrates different components of the slidable display adjustment mechanism 203 example in a side view. In this example, the motors have been replaced with supports 203a. The attachment element 205a for each support 203a to the movable support for the display optical system, e.g. frame portion 115r or inner frame 117r, includes a fastener like a nut and bolt assembly within the movable support 115r, 117r to secure the support 203a to the frame 115r or inner frame 117r. Additionally, another attachment element 205b, in this example an arm and a fastener within the support 203a couples each support to a sliding mechanism 203b including a slider 207 for each frame side having a flexible fitting 211 which holds the slider in a slot defined by slot dividers 209 and can change shape when the slider is actuated to move the slider to another slot. Each slider 207 has a lip 210 which grips on both edges 213a, 213b of the sliding mechanism 203b.

FIG. 4E provides a top view of the sliding mechanism 203b when the supports 203a are in an initial position. A slider 207l, 207r for each support 203a is held in place by flexible fitting 211 between slot dividers 209. As illustrated in FIG. 4F, when a user squeezes both ends of a slider, in the case the slider 207l for the left display optical system, the slider retracts or shortens in length and the flexible fitting 211l contracts in shape so as to move in the central opening 121 past the end of the slot dividers 209 so the user can push or pull the slider to another slot, in this example one slot to the left. In this example, each slot may represent a calibrated distance, e.g. 1 mm, so when instructions are displayed for the user, the instructions may be for a specific number of discrete movements or positions. The user applies the moving force to increase or decrease the IPD, but does not have to determine the amount of adjustment.

FIG. 4G illustrates an example of a mechanical display adjustment mechanism using a turn wheel mechanism which a user may activate for moving a display optical system. In this example, supports 203a in the bridge 104 are replaced by a turn wheel or dial 203a attached to each display optical system. The attachment element to the movable support 115r or 117r includes an arm or shaft from the center of the turn wheel or dial to the top of screw. The end of the arm or shaft on the screw or nut side fits the head of the screw or nut for turning it. A fastener secures the screw to the frame 115l or inner frame 117l. The rotational force generated from turning the wheel causes a linear force on the screw, and the end of the shaft fitted to the screw head also rotates the screw causing a linear force to push the frame portion 115l, 117l to the left.

Each turn wheel or dial extends for a portion outside the from the of bridge 104, e.g. the top portion in this example. The portion of the wheel rotated through the opening section may also be calibrated to an adjustment distance, e.g. 1 mm A user may be instructed to do 2 turns of the left wheel towards his or her nose to cause the screw to also turn down towards the nose and push the frame 115l or inner frame 117l to the left 2 mm.

FIGS. 4H and 4I illustrates different views of an example of a mechanical display adjustment mechanism using a ratcheting mechanism which a user may activate for moving a display optical system. The ratcheting mechanism is shown for moving the left movable support 115l, 117l. One for the right movable support 115r, 117r would work similarly. In this example, support 203a is attached via a fastener, e.g. an arm and nut to the frame portion 115l, 117l on its left side and is itself fastened via a nut and arm for each of two ratcheted wheels 204a and 204b. As shown, each ratchet wheel has teeth. A respective pawl 219a latches a new tooth as the wheel is turned. Each ratchet wheel turns in one direction only and the wheels turn in opposite directions. The rotation in opposite directions produces a linear torque at the centers of the wheels in opposite directions as indicated by the left and right arrows. FIG. 4J illustrates a side view of a ratchet such as may be used in the mechanisms of FIGS. 4H and 4I. Ratchet wheel 204a includes a center opening 123 for connecting to the fastening mechanism 205b and another opening 127 allowing another fastening mechanism 205b to pass through to the center of the other ratchet wheel 204b.

A slider button 223l slides within a grooved guide 225l to push a top 227 of an arm 221 down to rotate each ratcheted wheel 204 one increment, e.g. one tooth spacing which causes a linear torque either pushing or pulling the support 203a. As illustrated in the example of FIG. 41, if the slider 223l pushes down top 227b and arm 221b, the wheel 204b rotates to cause a torque towards the bridge which pulls support 203a via arm 205b through an opening 127 in the other wheel 204a, and hence the frame portion 115l, 117l, towards the bridge 104 as indicated by the dashed extension of the top arm of 205b within ratchet wheel 204b. Similarly, if the slider 223l is positioned to push down the top 227a of the arm 221a, wheel 219a is rotated one increment which causes a torque away from wheel 219a to push support 203a towards the frame portion 115l, 117l. In some embodiments, for each increment the slider returns to the center, so each slide to one side or the other results in one increment and one calibrated adjustment measurement length, e.g. 1 mm.

The examples of FIGS. 4D through 4J are just some examples of mechanical display adjustment mechanisms. Other mechanical mechanisms may also be used for moving the display optical systems.

FIG. 5A is a side view of an eyeglass temple 102 of the frame 115 in an eyeglasses embodiment of a see-through, mixed reality display device. At the front of frame 115 is physical environment facing video camera 113 that can capture video and still images. Particularly in some embodiments, physical environment facing camera 113 may be a depth camera as well as a visible light or RGB camera. For example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a CCD or other type of depth sensor. Other types of visible light camera (RGB camera) and depth cameras can be used. More information about depth cameras can be found in U.S. patent application Ser. No. 12/813,675, filed on Jun. 11, 2010, incorporated herein by reference in its entirety. The data from the sensors may be sent to a processor 210 of the control circuitry 136, or the processing unit 4, 5 or both which may process them but which the unit 4, 5 may also send to a computer system over a network or hub computing system 12 for processing. The processing identifies objects through image segmentation and edge detection techniques and maps depth to the objects in the user's real world field of view. Additionally, the physical environment facing camera 113 may also include a light meter for measuring ambient light.

Control circuits 136 provide various electronics that support the other components of head mounted display device 2. More details of control circuits 136 are provided below with respect to FIG. 7A. Inside, or mounted to temple 102, are ear phones 130, inertial sensors 132, GPS transceiver 144 and temperature sensor 138. In one embodiment inertial sensors 132 include a three axis magnetometer 132A, three axis gyro 132B and three axis accelerometer 132C (See FIG. 7A). The inertial sensors are for sensing position, orientation, and sudden accelerations of head mounted display device 2. From these movements, head position may also be determined.

The display device 2 provides an image generation unit which can create one or more images including one or more virtual objects. In some embodiments a microdisplay may be used as the image generation unit. A microdisplay assembly 173 in this example comprises light processing elements and a variable focus adjuster 135. An example of a light processing element is a microdisplay unit 120. Other examples include one or more optical elements such as one or more lenses of a lens system 122 and one or more reflecting elements such as surfaces 124a and 124b in FIGS. 6A and 6B or 124 in FIGS. 6C and 6D. Lens system 122 may comprise a single lens or a plurality of lenses.

Mounted to or inside temple 102, the microdisplay unit 120 includes an image source and generates an image of a virtual object. The microdisplay unit 120 is optically aligned with the lens system 122 and the reflecting surface 124 or reflecting surfaces 124a and 124b as illustrated in the following Figures. The optical alignment may be along an optical axis 133 or an optical path 133 including one or more optical axes. The microdisplay unit 120 projects the image of the virtual object through lens system 122, which may direct the image light, onto reflecting element 124 which directs the light into lightguide optical element 112 as in FIGS. 6C and 6D or onto reflecting surface 124a (e.g. a mirror or other surface) which directs the light of the virtual image to a partially reflecting element 124b which combines the virtual image view along path 133 with the natural or actual direct view along the optical axis 142 as in FIGS. 6A-6D. The combination of views are directed into a user's eye.

The variable focus adjuster 135 changes the displacement between one or more light processing elements in the optical path of the microdisplay assembly or an optical power of an element in the microdisplay assembly. The optical power of a lens is defined as the reciprocal of its focal length, e.g. 1/focal length, so a change in one effects the other. The change in focal length results in a change in the region of the field of view, e.g. a region at a certain distance, which is in focus for an image generated by the microdisplay assembly 173.

In one example of the microdisplay assembly 173 making displacement changes, the displacement changes are guided within an armature 137 supporting at least one light processing element such as the lens system 122 and the microdisplay 120 in this example. The armature 137 helps stabilize the alignment along the optical path 133 during physical movement of the elements to achieve a selected displacement or optical power. In some examples, the adjuster 135 may move one or more optical elements such as a lens in lens system 122 within the armature 137. In other examples, the armature may have grooves or space in the area around a light processing element so it slides over the element, for example, microdisplay 120, without moving the light processing element. Another element in the armature such as the lens system 122 is attached so that the system 122 or a lens within slides or moves with the moving armature 137. The displacement range is typically on the order of a few millimeters (mm). In one example, the range is 1-2 mm. In other examples, the armature 137 may provide support to the lens system 122 for focal adjustment techniques involving adjustment of other physical parameters than displacement. An example of such a parameter is polarization.

For more information on adjusting a focal distance of a microdisplay assembly, see U.S. patent Ser. No. 12/941,825 entitled “Automatic Variable Virtual Focus for Augmented Reality Displays,” filed Nov. 8, 2010, having inventors Avi Bar-Zeev and John Lewis and which is hereby incorporated by reference.

In one example, the adjuster 135 may be an actuator such as a piezoelectric motor. Other technologies for the actuator may also be used and some examples of such technologies are a voice coil formed of a coil and a permanent magnet, a magnetostriction element, and an electrostriction element.

There are different image generation technologies that can be used to implement microdisplay 120. For example, microdisplay 120 can be implemented using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the system described herein. Additionally, microdisplay 120 can be implemented using an emissive technology where light is generated by the display. For example, a PicoP™ engine from Microvision, Inc. emits a laser signal with a micro mirror steering either onto a tiny screen that acts as a transmissive element or beamed directly into the eye (e.g., laser).

As mentioned above, the configuration of the light processing elements of the microdisplay assembly 173 create a focal distance or focal region in which a virtual object appears in an image. Changing the configuration changes the focal region for the virtual object image. The focal region determined by the light processing elements can be determined and changed based on the equation 1/S1+1/S2=1/f.

The symbol f represents the focal length of a lens such as lens system 122 in the microdisplay assembly 173. The lens system 122 has a front nodal point and a rear nodal point. If light rays are directed toward either nodal point at a given angle relative to the optical axis, the light rays will emerge from the other nodal point at an equivalent angle relative to the optical axis. In one example, the rear nodal point of lens system 122 would be between itself and the microdisplay 120. The distance from the rear nodal point to the microdisplay 120 may be denoted as S2. The front nodal point is typically within a few mm of lens system 122. The target location is the location of the virtual object image to be generated by the microdisplay 120 in a three-dimensional physical space. The distance from the front nodal point to the target location of the virtual image may be denoted as S1. Since the image is to be a virtual image appearing on the same side of the lens as the microdisplay 120, sign conventions give that S1 has a negative value.

If the focal length of the lens is fixed, S1 and S2 are varied to focus virtual objects at different depths. For example, an initial position may have S1 set to infinity, and S2 equal to the focal length of lens system 122. Assuming lens system 122 has a focal length of 10 mm, consider an example in which the virtual object is to be placed about 1 foot or 300 mm into the user's field of view. S1 is now about −300 mm, f is 10 mm and S2 is set currently at the initial position of the focal length, 10 mm, meaning the rear nodal point of lens system 122 is 10 mm from the microdisplay 120. The new distance or new displacement between the lens 122 and microdisplay 120 is determined based on 1/(−300)+1/S2=1/10 with all in units of mm. The result is about 9.67 mm for S2.

In one example, one or more processors such as in the control circuitry, the processing unit 4, 5 or both can calculate the displacement values for S1 and S2, leaving the focal length f fixed and cause the control circuitry 136 to cause a variable adjuster driver 237 (see FIG. 7A) to send drive signals to have the variable virtual focus adjuster 135 move the lens system 122 along the optical path 133 for example. In other embodiments, the microdisplay unit 120 may be moved instead or in addition to moving the lens system 122. In other embodiments, the focal length of at least one lens in the lens system 122 may be changed instead or with changes in the displacement along the optical path 133 as well.

FIG. 5B is a side view of an eyeglass temple in another embodiment of a mixed reality display device providing support for hardware and software components and three dimensional adjustment of a microdisplay assembly. Some of the numerals illustrated in the FIG. 5A above have been removed to avoid clutter in the drawing. In embodiments where the display optical system 14 is moved in any of three dimensions, the optical elements represented by reflecting surface 124 and the other elements of the microdisplay assembly 173, e.g. 120, 122 may also be moved for maintaining the optical path 133 of the light of a virtual image to the display optical system. An XYZ transport mechanism in this example made up of one or more motors represented by motor block 203 and shafts 205 under control of the processor 210 of control circuitry 136 (see FIG. 7A) control movement of the elements of the microdisplay assembly 173. An example of motors which may be used are piezoelectric motors. In the illustrated example, one motor is attached to the armature 137 and moves the variable focus adjuster 135 as well, and another representative motor 203 controls the movement of the reflecting element 124.

FIG. 6A is a top view of an embodiment of a movable display optical system 14 of a see-through, near-eye, mixed reality device 2 including an arrangement of gaze detection elements. A portion of the frame 115 of the near-eye display device 2 will surround a display optical system 14 and provides support for elements of an embodiment of a microdisplay assembly 173 including microdisplay 120 and its accompanying elements as illustrated. In order to show the components of the display system 14, in this case 14r for the right eye system, a top portion of the frame 115 surrounding the display optical system is not depicted. Additionally, the microphone 110 in bridge 104 is not shown in this view to focus attention on the operation of the display adjustment mechanism 203. As in the example of FIG. 4C, the display optical system 14 in this embodiment is moved by moving an inner frame 117r, which in this example surrounds the microdisplay assembly 173 as well. The display adjustment mechanism is embodied in this embodiment as three axis motors 203 which attach their shafts 205 to inner frame 117r to translate the display optical system 14, which in this embodiment includes the microdisplay assembly 173, in any of three dimensions as denoted by symbol 144 indicating three (3) axes of movement.

The display optical system 14 in this embodiment has an optical axis 142 and includes a see-through lens 118 allowing the user an actual direct view of the real world. In this example, the see-through lens 118 is a standard lens used in eye glasses and can be made to any prescription (including no prescription). In another embodiment, see-through lens 118 can be replaced by a variable prescription lens. In some embodiments, see-through, near-eye display device 2 will include additional lenses.

The display optical system 14 further comprises reflecting surfaces 124a and 124b. In this embodiment, light from the microdisplay 120 is directed along optical path 133 via a reflecting element 124a to a partially reflective element 124b embedded in lens 118 which combines the virtual object image view traveling along optical path 133 with the natural or actual direct view along the optical axis 142 so that the combined views are directed into a user's eye, right one in this example, at the optical axis, the position with the most collimated light for a clearest view.

A detection area 139r of a light sensor is also part of the display optical system 14r. An optical element 125 embodies the detection area 139r by capturing reflected light from the user's eye received along the optical axis 142 and directs the captured light to the sensor 134r, in this example positioned in the lens 118 within the inner frame 117r. As shown, the arrangement allows the detection area 139 of the sensor 134r to have its center aligned with the center of the display optical system 14. For example, if sensor 134r is an image sensor, sensor 134r captures the detection area 139, so an image captured at the image sensor is centered on the optical axis because the detection area 139 is. In one example, sensor 134r is a visible light camera or a combination of RGB/IR camera, and the optical element 125 includes an optical element which reflects visible light reflected from the user's eye, for example a partially reflective mirror.

In other embodiments, the sensor 134r is an IR sensitive device such as an IR camera, and the element 125 includes a hot reflecting surface which lets visible light pass through it and reflects IR radiation to the sensor 134r. An IR camera may capture not only glints, but also an infra-red or near infra-red image of the user's eye including the pupil.

In other embodiments, the IR sensor device 134r is a position sensitive device (PSD), sometimes referred to as an optical position sensor. The position of detected light on the surface of the sensor is identified. A PSD can be selected which is sensitive to a wavelength range or about a predetermined wavelength of IR illuminators for the glints. When light within the wavelength range or about the predetermined wavelength of the position sensitive device is detected on the sensor or light sensitive portion of the device, an electrical signal is generated which identifies the location on the surface of the detector. In some embodiments, the surface of a PSD is divided into discrete sensors like pixels from which the location of the light can be determined. In other examples, a PSD isotropic sensor may be used in which a change in local resistance on the surface can be used to identify the location of the light spot on the PSD. Other embodiments of PSDs may also be used. By operating the illuminators 153 in a predetermined sequence, the location of the reflection of glints on the PSD can be identified and hence related back to their location on a cornea surface.

The depiction of the light directing elements, in this case reflecting elements, 125, 124, 124a and 124b in FIGS. 6A-6D are representative of their functions. The elements may take any number of forms and be implemented with one or more optical components in one or more arrangements for directing light to its intended destination such as a camera sensor or a user's eye. As shown, the arrangement allows the detection area 139 of the sensor to have its center aligned with the center of the display optical system 14. The image sensor 134r captures the detection area 139, so an image captured at the image sensor is centered on the optical axis because the detection area 139 is.

As discussed in FIGS. 2A and 2B above and in the Figures below, when the user is looking straight ahead, and the center of the user's pupil is centered in an image captured of the user's eye when a detection area 139 or an image sensor 134r is effectively centered on the optical axis of the display, the display optical system 14r is aligned with the pupil. When both display optical systems 14 are aligned with their respective pupils, the distance between the optical centers matches or is aligned with the user's inter-pupillary distance. In the example of FIG. 6A, the inter-pupillary distance can be aligned with the display optical systems 14 in three dimensions.

In one embodiment, if the data captured by the sensor 134 indicates the pupil is not aligned with the optical axis, one or more processors in the processing unit 4, 5 or the control circuitry 136 or both use a mapping criteria which correlates a distance or length measurement unit to a pixel or other discrete unit or area of the image for determining how far off the center of the pupil is from the optical axis 142. Based on the distance determined, the one or more processors determine adjustments of how much distance and in which direction the display optical system 14r is to be moved to align the optical axis 142 with the pupil. Control signals are applied by one or more display adjustment mechanism drivers 245 to each of the components, e.g. motors 203, making up one or more display adjustment mechanisms 203. In the case of motors in this example, the motors move their shafts 205 to move the inner frame 117r in at least one direction indicated by the control signals. On the temple side of the inner frame 117r are flexible sections 215a, 215b of the frame 115 which are attached to the inner frame 117r at one end and slide within grooves 217a and 217b within the interior of the temple frame 115 to anchor the inner frame 117 to the frame 115 as the display optical system 14 is move in any of three directions for width, height or depth changes with respect to the respective pupil.

In addition to the sensor, the display optical system 14 includes other gaze detection elements. In this embodiment, attached to frame 117r on the sides of lens 118, are at least two (2) but may be more, infra-red (IR) illuminating devices 153 which direct narrow infra-red light beams within a particular wavelength range or about a predetermined wavelength at the user's eye to each generate a respective glint on a surface of the respective cornea. In other embodiments, the illuminators and any photodiodes may be on the lenses, for example at the corners or edges. In this embodiment, in addition to the at least 2 infra-red (IR) illuminating devices 153 are IR photodetectors 152. Each photodetector 152 is sensitive to IR radiation within the particular wavelength range of its corresponding IR illuminator 153 across the lens 118 and is positioned to detect a respective glint. As shown in FIGS. 4A-4C, the illuminator and photodetector are separated by a barrier 154 so that incident IR light from the illuminator 153 does not interfere with reflected IR light being received at the photodetector 152. In the case where the sensor 134 is an IR sensor, the photodetectors 152 may not be needed or may be an additional glint data capture source. With a visible light camera, the photodetectors 152 capture light from glints and generate glint intensity values.

In FIGS. 6A-6D, the positions of the gaze detection elements, e.g. the detection area 139 and the illuminators 153 and photodetectors 152 are fixed with respect to the optical axis of the display optical system 14. These elements may move with the display optical system 14r, and hence its optical axis, on the inner frame, but their spatial relationship to the optical axis 142 does not change.

FIG. 6B is a top view of another embodiment of a movable display optical system of a see-through, near-eye, mixed reality device including an arrangement of gaze detection elements. In this embodiment, light sensor 134r may be embodied as a visible light camera, sometimes referred to as an RGB camera, or it may be embodied as an IR camera or a camera capable of processing light in both the visible and IR ranges, e.g. a depth camera. In this example, the image sensor 134r is the detection area 139r. The image sensor 134 of the camera is located vertically on the optical axis 142 of the display optical system. In some examples, the camera may be located on frame 115 either above or below see-through lens 118 or embedded in the lens 118. In some embodiments, the illuminators 153 provide light for the camera, and in other embodiments the camera captures images with ambient lighting or light from its own light source. Image data captured may be used to determine alignment of the pupil with the optical axis. Gaze determination techniques based on image data, glint data or both may be used based on the geometry of the gaze detection elements.

In this example, the motor 203 in bridge 104 moves the display optical system 14r in a horizontal direction with respect to the user's eye as indicated by directional symbol 145. The flexible frame portions 215a and 215b slide within grooves 217a and 217b as the system 14 is moved. In this example, reflecting element 124a of an microdisplay assembly 173 embodiment is stationery. As the IPD is typically determined once and stored, any adjustment of the focal length between the microdisplay 120 and the reflecting element 124a that may be done may be accomplished by the microdisplay assembly, for example via adjustment of the microdisplay elements within the armature 137.

FIG. 6C is a top view of a third embodiment of a movable display optical system of a see-through, near-eye, mixed reality device including an arrangement of gaze detection elements. The display optical system 14 has a similar arrangement of gaze detection elements including IR illuminators 153 and photodetectors 152, and a light sensor 134r located on the frame 115 or lens 118 below or above optical axis 142. In this example, the display optical system 14 includes a light guide optical element 112 as the reflective element for directing the images into the user's eye and is situated between an additional see-through lens 116 and see-through lens 118. As reflecting element 124 is within the lightguide optical element and moves with the element 112, an embodiment of a microdisplay assembly 173 is attached on the temple 102 in this example to a display adjustment mechanism 203 for the display optical system 14 embodied as a set of three axis motor 203 with shafts 205 include at least one for moving the microdisplay assembly. One or more motors 203 on the bridge 104 are representative of the other components of the display adjustment mechanism 203 which provides three axes of movement 145. In another embodiment, the motors may operate to only move the devices via their attached shafts 205 in the horizontal direction. The motor 203 for the microdisplay assembly 173 would also move it horizontally for maintaining alignment between the light coming out of the microdisplay 120 and the reflecting element 124. A processor 210 of the control circuitry (see FIG. 7A) coordinates their movement.

Lightguide optical element 112 transmits light from microdisplay 120 to the eye of the user wearing head mounted display device 2. Lightguide optical element 112 also allows light from in front of the head mounted display device 2 to be transmitted through lightguide optical element 112 to the user's eye thereby allowing the user to have an actual direct view of the space in front of head mounted display device 2 in addition to receiving a virtual image from microdisplay 120. Thus, the walls of lightguide optical element 112 are see-through. Lightguide optical element 112 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar, substrate comprising lightguide optical element 112 by internal reflection.

After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye of the user. More details of a lightguide optical element can be found in United States Patent Application Publication 2008/0285140, Ser. No. 12/214,366, published on Nov. 20, 2008, “Substrate-Guided Optical Devices” incorporated herein by reference in its entirety. In one embodiment, each eye will have its own lightguide optical element 112.

FIG. 6D is a top view of a fourth embodiment of a movable display optical system of a see-through, near-eye, mixed reality device including an arrangement of gaze detection elements. This embodiment is similar to FIG. 6C's embodiment including a light guide optical element 112. However, the only light detectors are the IR photodetectors 152, so this embodiment relies on glint detection only for gaze detection as discussed in the examples below.

In the embodiments of FIGS. 6A-6D, the positions of the gaze detection elements, e.g. the detection area 139 and the illuminators 153 and photodetectors 152 are fixed with respect to each other. In these examples, they are also fixed in relation to the optical axis of the display optical system 14.

In the embodiments above, the specific number of lenses shown are just examples. Other numbers and configurations of lenses operating on the same principles may be used. Additionally, in the examples above, only the right side of the see-through, near-eye display 2 are shown. A full near-eye, mixed reality display device would include as examples another set of lenses 116 and/or 118, another lightguide optical element 112 for the embodiments of FIGS. 6C and 6D, another micro display 120, another lens system 122, likely another environment facing camera 113, another eye tracking camera 134 for the embodiments of FIGS. 6A to 6C, earphones 130, and a temperature sensor 138.

FIG. 7A is a block diagram of one embodiment of hardware and software components of a see-through, near-eye, mixed reality display unit 2 as may be used with one or more embodiments. FIG. 7B is a block diagram describing the various components of a processing unit 4, 5. In this embodiment, near-eye display device 2, receives instructions about a virtual image from processing unit 4, 5 and provides the sensor information back to processing unit 4, 5. Software and hardware components which may be embodied in a processing unit 4, 5 are depicted in FIG. 7B, will receive the sensory information from the display device 2 and may also receive sensory information from hub computing device 12 (See FIG. 1A). Based on that information, processing unit 4, 5 will determine where and when to provide a virtual image to the user and send instructions accordingly to the control circuitry 136 of the display device 2.

Note that some of the components of FIG. 7A (e.g., physical environment facing camera 113, eye camera 134, variable virtual focus adjuster 135, photodetector interface 139, micro display 120, illumination device 153 or illuminators, earphones 130, temperature sensor 138, display adjustment mechanism 203) are shown in shadow to indicate that there are at least two of each of those devices, at least one for the left side and at least one for the right side of head mounted display device 2. FIG. 7A shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230. In one embodiment, all of components of control circuit 220 are in communication with each other via dedicated lines of one or more buses. In another embodiment, each of the components of control circuit 200 are in communication with processor 210.

Camera interface 216 provides an interface to the two physical environment facing cameras 113 and each eye camera 134 and stores respective images received from the cameras 113, 134 in camera buffer 218. Display driver 220 will drive microdisplay 120. Display formatter 222 may provide information, about the virtual image being displayed on microdisplay 120 to one or more processors of one or more computer systems, e.g. 4, 5, 12, 210 performing processing for the augmented reality system. Timing generator 226 is used to provide timing data for the system. Display out 228 is a buffer for providing images from physical environment facing cameras 113 and the eye cameras 134 to the processing unit 4, 5. Display in 230 is a buffer for receiving images such as a virtual image to be displayed on microdisplay 120. Display out 228 and display in 230 communicate with band interface 232 which is an interface to processing unit 4, 5.

Power management circuit 202 includes voltage regulator 234, eye tracking illumination driver 236, variable adjuster driver 237, photodetector interface 239, audio DAC and amplifier 238, microphone preamplifier and audio ADC 240, temperature sensor interface 242, display adjustment mechanism driver(s) 245 and clock generator 244. Voltage regulator 234 receives power from processing unit 4, 5 via band interface 232 and provides that power to the other components of head mounted display device 2. Illumination driver 236 controls, for example via a drive current or voltage, the illumination devices 153 to operate about a predetermined wavelength or within a wavelength range. Audio DAC and amplifier 238 receives the audio information from earphones 130. Microphone preamplifier and audio ADC 240 provides an interface for microphone 110. Temperature sensor interface 242 is an interface for temperature sensor 138. One or more display adjustment drivers 245 provide control signals to one or more motors or other devices making up each display adjustment mechanism 203 which represent adjustment amounts of movement in at least one of three directions. Power management unit 202 also provides power and receives data back from three axis magnetometer 132A, three axis gyro 132B and three axis accelerometer 132C. Power management unit 202 also provides power and receives data back from and sends data to GPS transceiver 144.

The variable adjuster driver 237 provides a control signal, for example a drive current or a drive voltage, to the adjuster 135 to move one or more elements of the microdisplay assembly 173 to achieve a displacement for a focal region calculated by software executing in a processor 210 of the control circuitry 13, or the processing unit 4, 5 or the hub computer 12 or both. In embodiments of sweeping through a range of displacements and, hence, a range of focal regions, the variable adjuster driver 237 receives timing signals from the timing generator 226, or alternatively, the clock generator 244 to operate at a programmed rate or frequency.

The photodetector interface 239 performs any analog to digital conversion needed for voltage or current readings from each photodetector, stores the readings in a processor readable format in memory via the memory controller 212, and monitors the operation parameters of the photodetectors 152 such as temperature and wavelength accuracy.

FIG. 7B is a block diagram of one embodiment of the hardware and software components of a processing unit 4 associated with a see-through, near-eye, mixed reality display unit. The mobile device 5 may include this embodiment of hardware and software components as well as similar components which perform similar functions. FIG. 7B shows controls circuit 304 in communication with power management circuit 306. Control circuit 304 includes a central processing unit (CPU) 320, graphics processing unit (GPU) 322, cache 324, RAM 326, memory control 328 in communication with memory 330 (e.g., D-RAM), flash memory controller 332 in communication with flash memory 334 (or other type of non-volatile storage), display out buffer 336 in communication with see-through, near-eye display device 2 via band interface 302 and band interface 232, display in buffer 338 in communication with near-eye display device 2 via band interface 302 and band interface 232, microphone interface 340 in communication with an external microphone connector 342 for connecting to a microphone, PCI express interface for connecting to a wireless communication device 346, and USB port(s) 348.

In one embodiment, wireless communication component 346 can include a Wi-Fi enabled communication device, Bluetooth communication device, infrared communication device, etc. The USB port can be used to dock the processing unit 4, 5 to hub computing device 12 in order to load data or software onto processing unit 4, 5, as well as charge processing unit 4, 5. In one embodiment, CPU 320 and GPU 322 are the main workhorses for determining where, when and how to insert images into the view of the user.

Power management circuit 306 includes clock generator 360, analog to digital converter 362, battery charger 364, voltage regulator 366, see-through, near-eye display power source 376, and temperature sensor interface 372 in communication with temperature sensor 374 (located on the wrist band of processing unit 4). An alternating current to direct current converter 362 is connected to a charging jack 370 for receiving an AC supply and creating a DC supply for the system. Voltage regulator 366 is in communication with battery 368 for supplying power to the system. Battery charger 364 is used to charge battery 368 (via voltage regulator 366) upon receiving power from charging jack 370. Device power interface 376 provides power to the display device 2.

The Figures above provide examples of geometries of elements for a display optical system which provide a basis for different methods of aligning an IPD as discussed in the following Figures. The method embodiments may refer to elements of the systems and structures above for illustrative context; however, the method embodiments may operate in system or structural embodiments other than those described above.

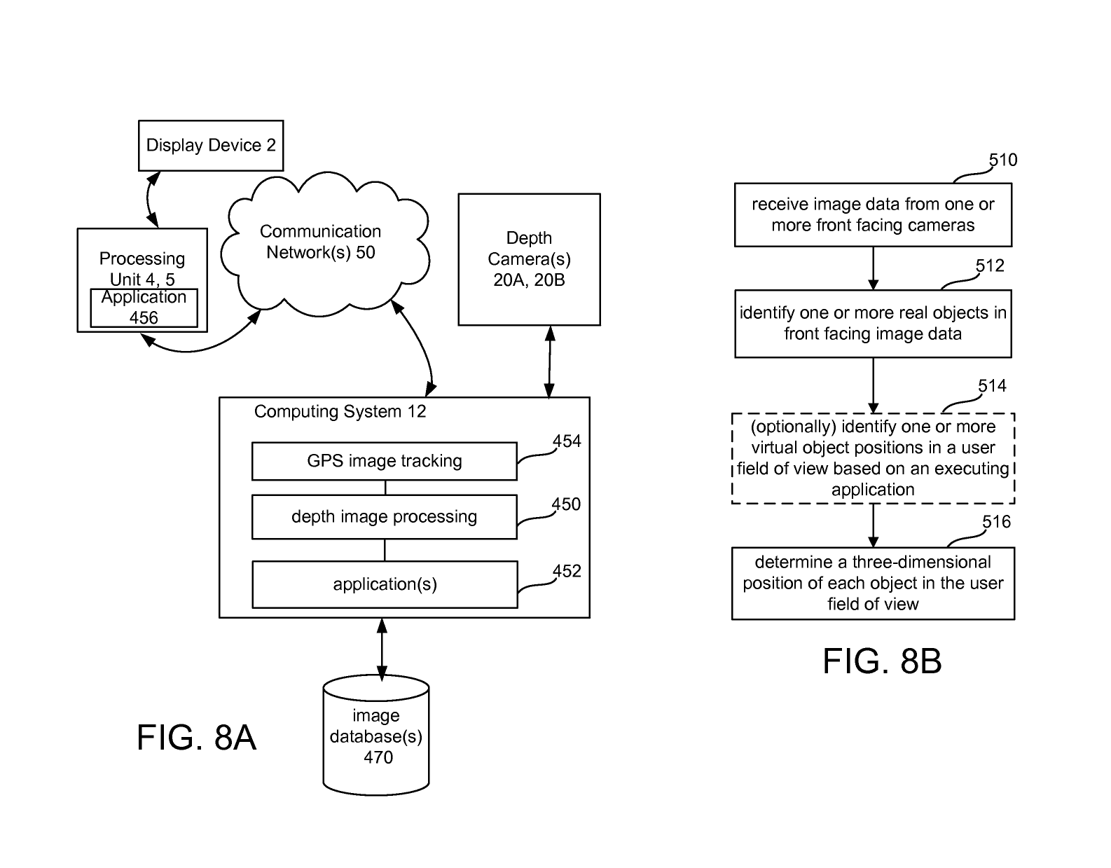

The method embodiments below identify or provide one or more objects of focus for aligning an IPD. FIGS. 8A and 8B discuss some embodiments for determining positions of objects within a field of view of a user wearing the display device.

FIG. 8A is a block diagram of a system embodiment for determining positions of objects within a user field of view of a see-through, near-eye, mixed reality display device. This embodiment illustrates how the various devices may leverage networked computers to map a three-dimensional model of a user field of view and the real and virtual objects within the model. An application 456 executing in a processing unit 4, 5 communicatively coupled to a display device 2 can communicate over one or more communication networks 50 with a computing system 12 for processing of image data to determine and track a user field of view in three dimensions. The computing system 12 may be executing an application 452 remotely for the processing unit 4, 5 for providing images of one or more virtual objects. As mentioned above, in some embodiments, the software and hardware components of the processing unit are integrated into the display device 2. Either or both of the applications 456 and 452 working together may map a 3D model of space around the user. A depth image processing application 450 detects objects, identifies objects and their locations in the model. The application 450 may perform its processing based on depth image data from depth camera like 20A and 20B, two-dimensional or depth image data from one or more front facing cameras 113, and GPS metadata associated with objects in the image data obtained from a GPS image tracking application 454.

The GPS image tracking application 454 identifies images of the user's location in one or more image database(s) 470 based on GPS data received from the processing unit 4, 5 or other GPS units identified as being within a vicinity of the user, or both. Additionally, the image database(s) may provide accessible images of a location with metadata like GPS data and identifying data uploaded by users who wish to share their images. The GPS image tracking application provides distances between objects in an image based on GPS data to the depth image processing application 450. Additionally, the application 456 may perform processing for mapping and locating objects in a 3D user space locally and may interact with the GPS image tracking application 454 for receiving distances between objects. Many combinations of shared processing are possible between the applications by leveraging network connectivity.

FIG. 8B is a flowchart of a method embodiment for determining a three-dimensional user field of view of a see-through, near-eye, mixed reality display device. In step 510, one or more processors of the control circuitry 136, the processing unit 4, 5, the hub computing system 12 or a combination of these receive image data from one or more front facing cameras 113, and in step 512 identify one or more real objects in front facing image data. Based on the position of the front facing camera 113 or a front facing camera 113 for each display optical system, the image data from the front facing camera approximates the user field of view. The data from two cameras 113 may be aligned and offsets for the positions of the front facing cameras 113 with respect to the display optical axes accounted for. Data from the orientation sensor 132, e.g. the three axis accelerometer 132C and the three axis magnetometer 132A, can also be used with the front facing camera 113 image data for mapping what is around the user, the position of the user's face and head in order to determine which objects, real or virtual, he or she is likely focusing on at the time. Optionally, based on an executing application, the one or more processors in step 514 identify virtual object positions in a user field of view which may be determined to be the field of view captured in the front facing image data. In step 516, a three-dimensional position is determined for each object in the user field of view. In other words, where each object is located with respect to the display device 2, for example with respect to the optical axis 142 of each display optical system 14.

In some examples for identifying one or more real objects in the front facing image data, GPS data via a GPS unit, e.g. GPS unit 965 in the mobile device 5 or GPS transceiver 144 on the display device 2 may identify the location of the user. This location may be communicated over a network from the device 2 or via the processing unit 4, 5 to a computer system 12 having access to a database of images 470 which may be accessed based on the GPS data. Based on pattern recognition of objects in the front facing image data and images of the location, the one or more processors determines a relative position of one or more objects in the front facing image data to one or more GPS tracked objects in the location. A position of the user from the one or more real objects is determined based on the one or more relative positions.

In other examples, each front facing camera is a depth camera providing depth image data or has a depth sensor for providing depth data which can be combined with image data to provide depth image data. The one or more processors of the control circuitry, e.g. 210, and the processing unit 4, 5 identify one or more real objects including their three-dimensional positions in a user field of view based on the depth image data from the front facing cameras. Additionally, orientation sensor 132 data may also be used to refine which image data currently represents the user field of view. Additionally, a remote computer system 12 may also provide additional processing power to the other processors for identifying the objects and mapping the user field of view based on depth image data from the front facing image data.

In other examples, a user wearing the display device may be in an environment in which a computer system with depth cameras, like the example of the hub computing system 12 with depth cameras 20A and 20B in system 10 in FIG. 1A, maps in three-dimensions the environment or space and tracks real and virtual objects in the space based on the depth image data from its cameras and an executing application. For example, when a user enters a store, a store computer system may map the three-dimensional space. Depth images from multiple perspectives, include depth images from one or more display devices in some examples, may be combined by a depth image processing application 450 based on a common coordinate system for the space. Objects are detected, e.g. edge detection, in the space, and identified by pattern recognition techniques including facial recognition techniques with reference images of things and people from image databases. Such a system can send data such as the position of the user within the space and positions of objects around the user which the one or more processors of the device 2 and the processing unit 4, 5 may use in detecting and identifying which objects are in the user field of view. Furthermore, the one or more processors of the display device 2 or the processing unit 4, 5 may send the front facing image data and orientation data to the computer system 12 which performs the object detection, identification and object position tracking within the user field of view and sends updates to the processing unit 4, 5.

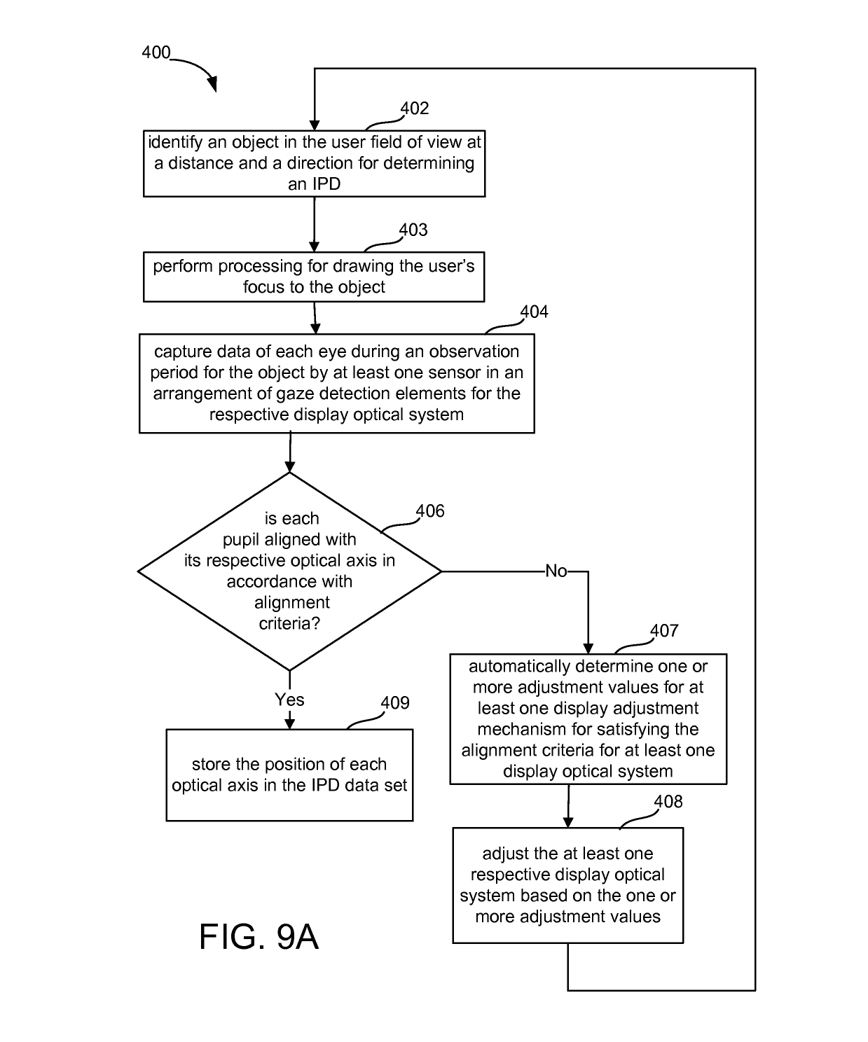

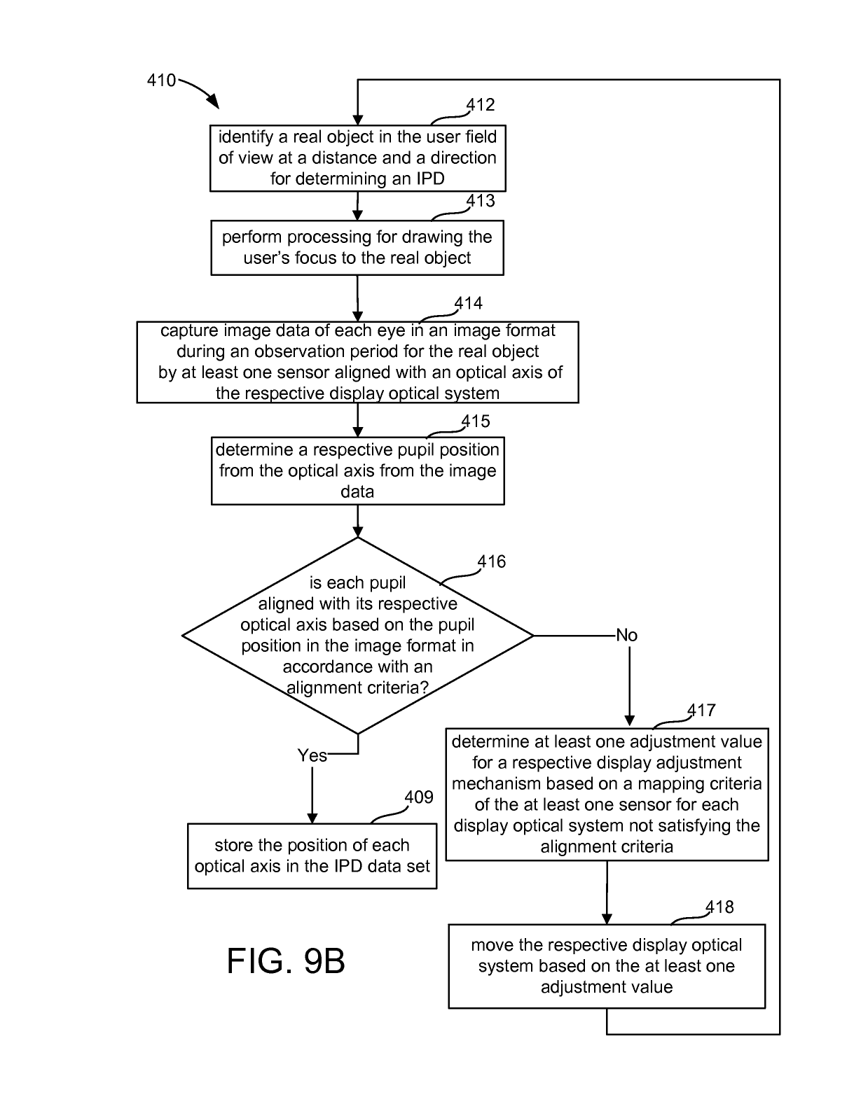

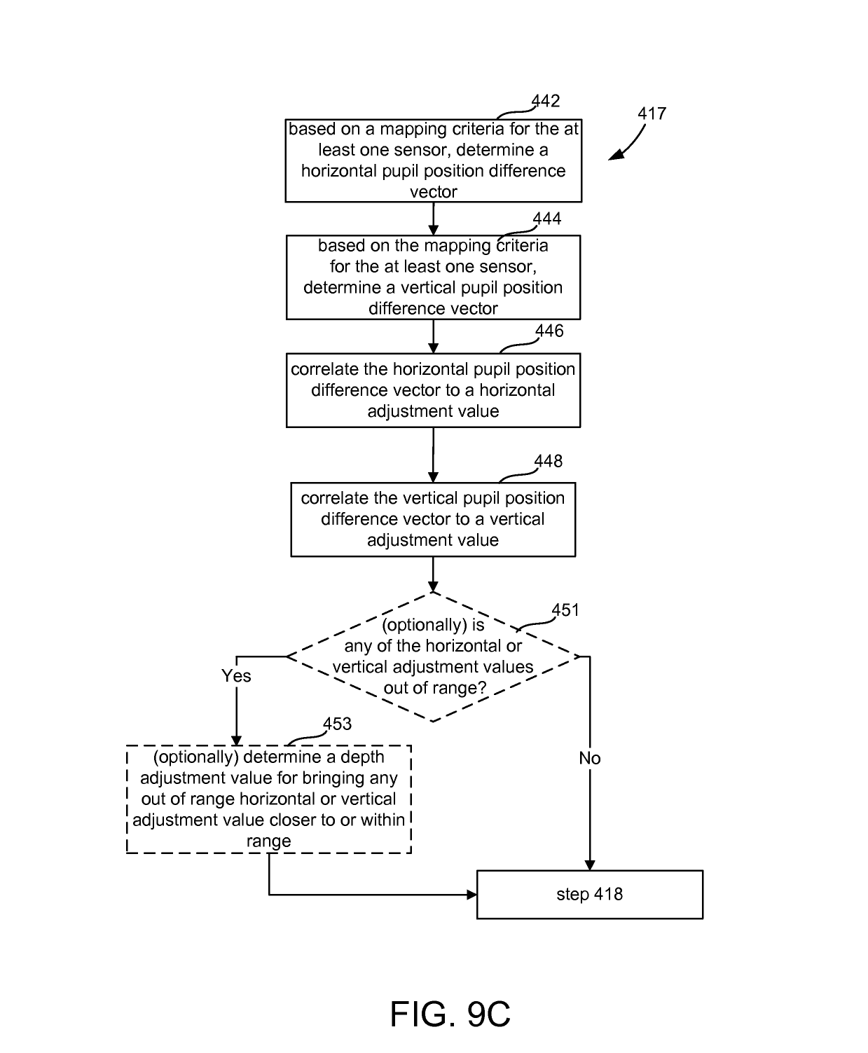

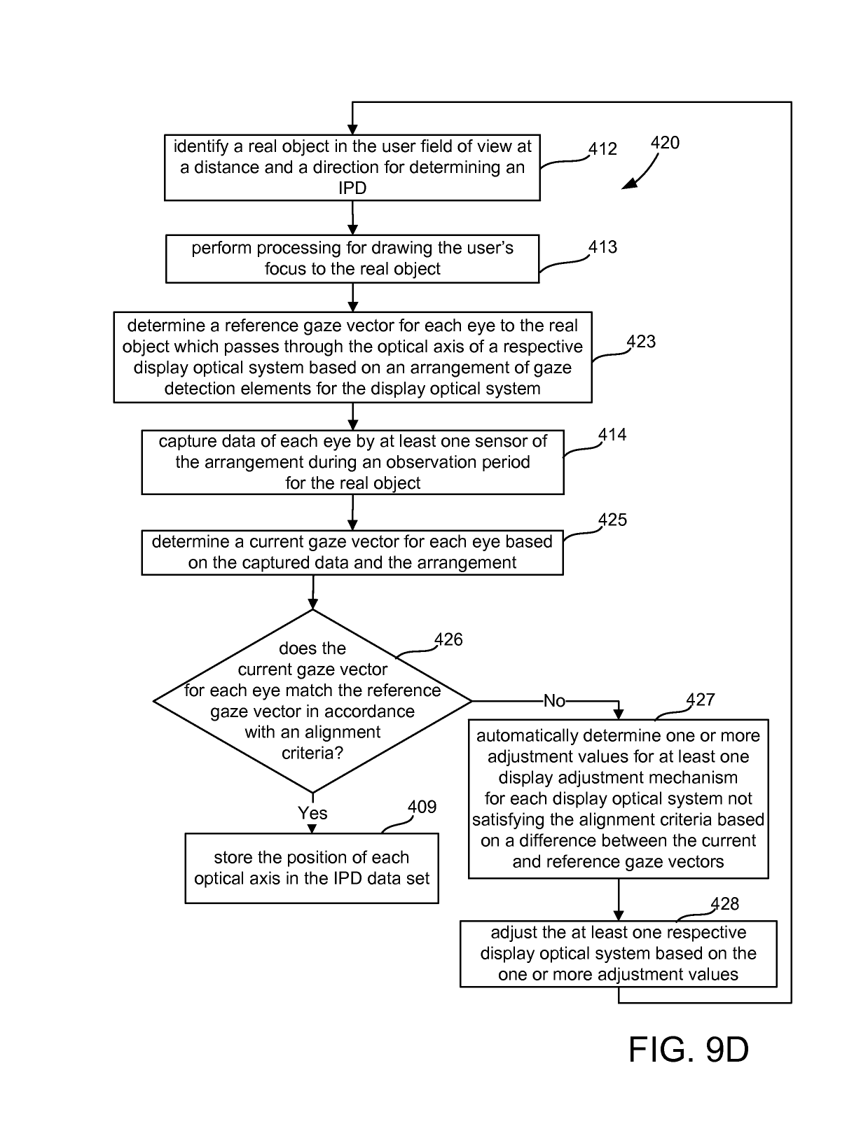

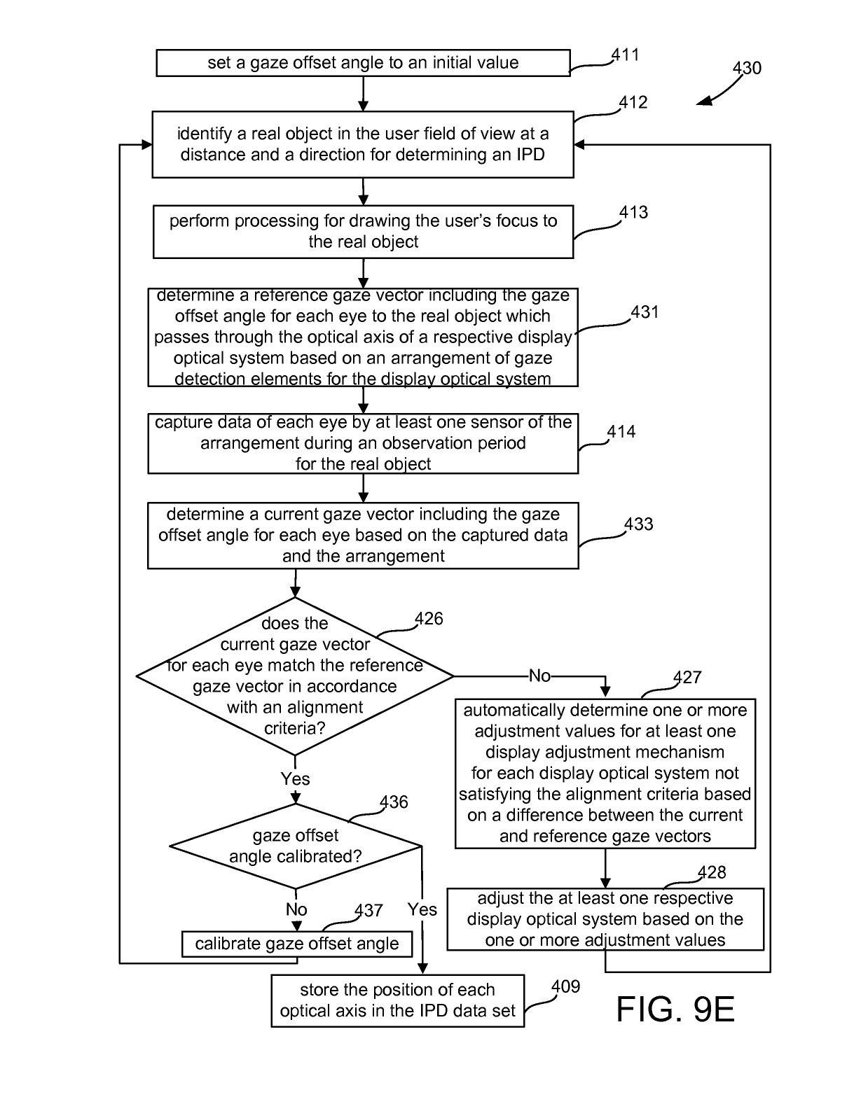

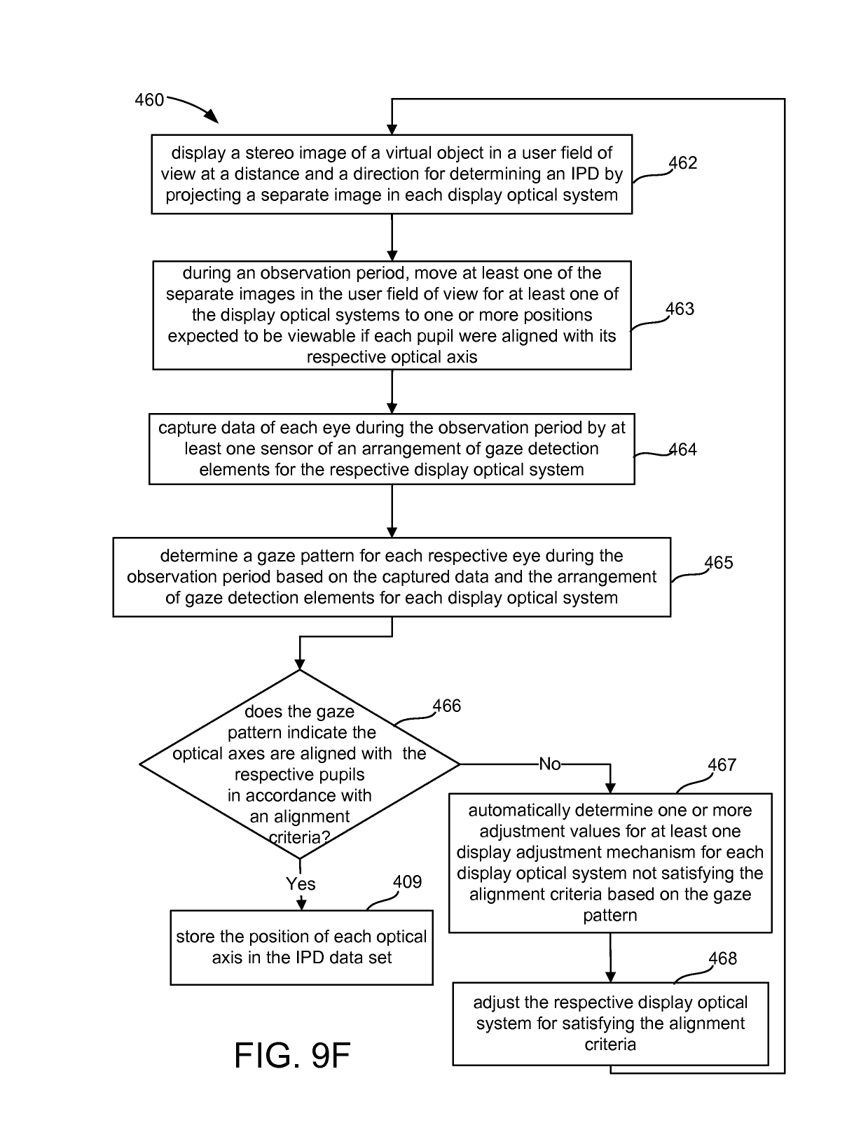

FIG. 9A is a flowchart of a method embodiment 400 for aligning a see-through, near-eye, mixed reality display with an IPD. steps 402 to 406 illustrate more details of an example of step 301 for automatically determining whether a see-through, near-eye, mixed reality display device is aligned with an IPD of a user in accordance with an alignment criteria. steps 407 to 408 illustrate more detailed steps of an example for adjusting the display device for bringing the device into alignment with the user IPD as in step 302. As discussed for FIG. 3C, the adjustment may be automatically performed by the processor or instructions electronically provided to the user for mechanical adjustment.

In step 402, the one or more processors of the see-through, near-eye, mixed reality system such as processor 210 of the control circuitry, that in processing unit 4, the mobile device 5, or the hub computing system 12, alone or in combination, identify an object in the user field of view at a distance and a direction for determining an IPD. For the far IPD, the distance is at effective infinity, e.g. more than 5 feet, the direction is straight ahead with respect to the optical axis of each display optical system. In other words, the distance and direction are such that when each pupil is aligned with each optical axis, the user is looking straight ahead. In step 403, the one or more processors perform processing for drawing the user's focus to the object. In one example, the one or more processors electronically provide instructions requesting the user to look at the identified real object. In some instances, the user may be asked simply to look straight ahead. Some examples of electronically provided instructions are instructions displayed by the image generation unit 120, the mobile device 5 or on a display 16 by the hub computing system 12 or audio instructions through speakers 130 of the display device 2. In other examples, the object may have image enhancements applied to it for attracting the user's eyes to focus on it. For example, eye catching visual effects may be applied to the object during an observation period. Some examples of such visual effects are highlighting, blinking, and movement.

In step 404, the at least one sensor such as sensor 134r or the photodetectors 152 or both in an arrangement of gaze detection elements for the respective display optical system capture data for each eye during an observation period for the object. In one example, the captured data may be IR image data and glints reflecting from each eye captured by an IR camera. The glints are generated by IR illuminators 153. In other examples, the at least one sensor is an IR sensor like a position sensitive detector. The at least one sensor may also be the IR photodetectors 152. In some examples, the at least one sensor 134 may be a visible light camera. However, as previously mentioned, if an image of a virtual object is used in a process for determining IPD alignment, the reflections of the virtual object in the user's eye may be accounted for, for example, by filtering them out. If visible light illuminators generate glints, the user's eyes may react to the visible light of the illuminators.

In step 406, the one or more processors determine based on the captured data and the arrangement of the gaze detection elements whether each pupil is aligned with the optical axis of its respective display optical system in accordance with an alignment criteria. An alignment criteria may be a distance from the optical axis, e.g. 2 millimeters (mm). If so, the display device 2 has been aligned with each pupil and hence the IPD, and the one or more processors in step 409 store the position of each optical axis in the IPD data set.

If the alignment criteria is not satisfied, then in step 407, the one or more processors automatically determine one or more adjustment values for at least one display adjustment mechanism for satisfying the alignment criteria for at least one display optical system. By “automatically determines” means the one or more processors determine the values without a user identifying the adjustment values through mechanical manipulation. In many embodiments, based on stored device configuration data, the current position of the optical axis with respect to a fixed point of the support structure is tracked. In step 408, the processor causes adjustment of the at least one respective display optical system based on the one or more adjustment values. In automatic adjustment, the one or more processors control the at least one display adjustment mechanism 203 via the one or more display adjustment mechanism drivers 245 to move the at least one respective display optical system based on the one or more adjustment values. In the mechanical adjustment approach, the processor electronically provides instructions to the user for applying the one or more adjustment values to the at least one display adjustment mechanism via a mechanical controller. The instructions may provide a specific number of user activations which are calibrated to predetermined distances to avoid guesswork on the part of the user. Again in such an example, the user avoids the guesswork of how much to activate a mechanical controller while providing the physical force to move the at least one display optical system rather than a motor requiring a power source. The steps of the method embodiment may be repeated a predetermined number of times or until the alignment criteria is satisfied.

FIG. 9B is a flowchart of one embodiment of a method 410 aligning a see-through, near-eye, mixed reality display device with an IPD of a user based on image data of a pupil for each eye in an image format. An image format has a predetermined size and shape, for example as may be set by an image sensor size and shape. An example of an image format is an image frame. The format is to provide a coordinate system, e.g. a center as an origin, for tracking a position within the image data. When the detection area 139 of an image sensor, e.g. an IR camera, or visible light camera if desired, is centered on the optical axis 142 of a display optical system 14, the image data in the image format is centered on the optical axis 142. How far off a pupil center is from the image center is a basis for determining whether the pupil is satisfactorily aligned with the optical axis. As in the examples of FIG. 4C, the image sensor 134 may be on the movable support 117 so as to be aligned along an axis passing though the optical axis 142. In processing the image data, the one or more processors factor in the offset vector of the image sensor 134 from the optical axis for determining whether the pupil is aligned with the optical axis.

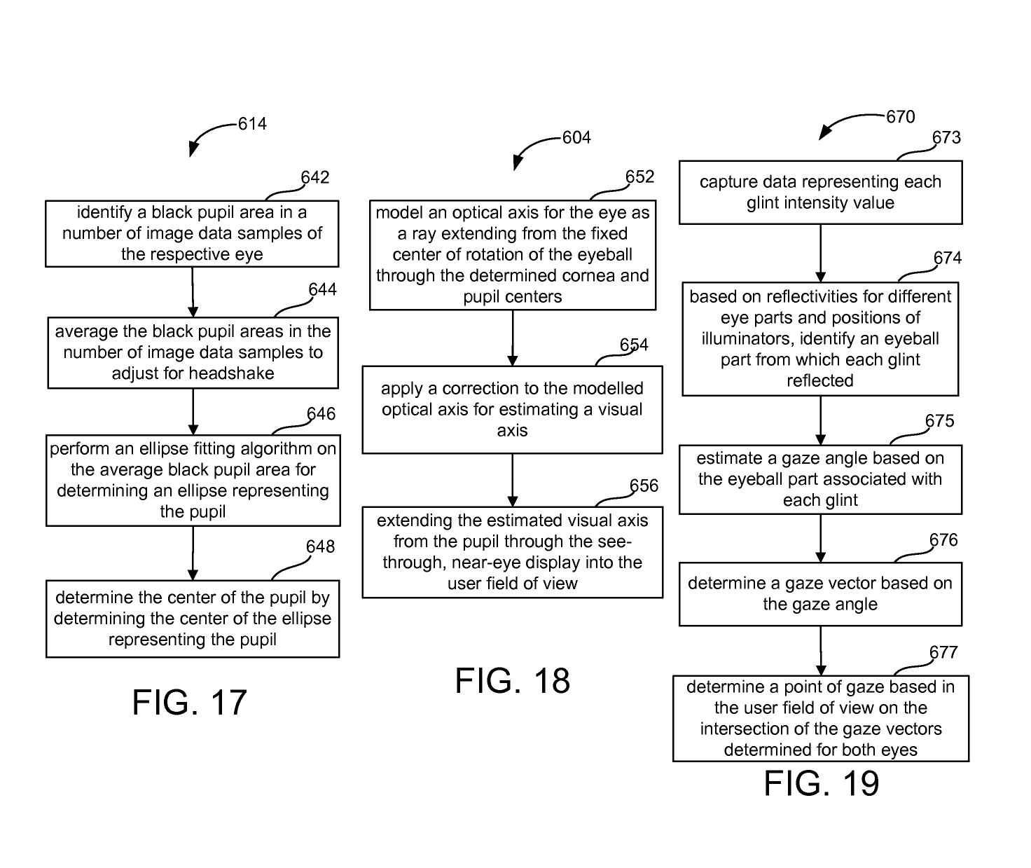

In step 412, a real object is identified in the user field of view at a distance and a direction for determining an IPD, and in step 413, the one or more processors perform processing for drawing the user's focus to the real object. In step 414, image data of each eye is captured in an image format during an observation period for the real object by at least one sensor aligned with an optical axis of the respective display optical system. A respective pupil position with respect to the respective optical axis is determined from the image data in step 415. A pupil area in the image data may be identified by thresholding intensity values. An ellipse fitting algorithm may be applied for approximating the size and shape of the pupil, and a center of a resulting ellipse may be selected as the center of the pupil. Ideally, the center of the pupil is aligned with the optical axis of the display optical system. FIG. 17 discussed below provides an embodiment of a method for determining a pupil center from image data which may be used for implementing step 415 as well. In step 416, the one or more processors determine whether each pupil is aligned with the respective optical axis based on the pupil position in the image format, e.g. image frame, in accordance with an alignment criteria. In the case in which the detection area 139 is centered on the optical axis 142, the one or more processors determine whether the pupil position is centered in the image format, e.g. centered in the image frame, in accordance with an alignment criteria. The pupil position may be determined in horizontal and vertical directions for each eye with respect to the optical axis.

If the alignment criteria is satisfied, the one or more processors in step 409 store the position of each optical axis in the IPD data set. If not, in step 417, the one or more processors determine at least one adjustment value for a respective display adjustment mechanism based on a mapping criteria of the at least one sensor for each display optical system not satisfying the alignment criteria. In step 418, the one or more processors control the respective display adjustment mechanism to move the respective display optical system based on the at least one adjustment value. The steps of the method embodiment may be repeated a predetermined number of times or until the alignment criteria is satisfied.

Again, as illustrated in some of the Figures above, the detection area of the camera may not be centered on the optical axis, e.g. 142 although aligned with it. For example, in FIGS. 4C, 6B and 6C, the camera image sensor 134 is in vertical alignment with the optical axis 142 as it is located above or below the optical axis 142, e.g. on frame 115.

FIG. 9C is a flowchart of one embodiment of a method for implementing step 417 for determining at least one adjustment value for a display adjustment mechanism based on a mapping criteria of at least one sensor for a display optical system not satisfying an alignment criteria. In step 442, based on a mapping criteria for the at least one sensor, the one or more processors determine a horizontal pupil position difference vector. A pixel to distance mapping criteria may be used for each direction for which adjustment is provided. The mapping criteria may be different for vertical than for horizontal depending on the shape of the detection area of the image sensor. In step 444, based on the mapping criteria for the at least one sensor, a vertical pupil position difference vector is determined as well. In step 446, the one or more processors correlate the horizontal pupil position difference vector to a horizontal adjustment value, and in step 448, correlate the vertical pupil position difference vector to a vertical adjustment value.

As the horizontal IPD may have a range between 25 to 30 mm, a display adjustment mechanism typically has a range limit of distance to move a display optical system in any direction. A depth adjustment may assist with bringing an out of range adjustment value in the horizontal or vertical direction to being within range. Optional steps 451 and 453 may be performed. The one or more processors determine in optional step 451 whether any of the horizontal or vertical adjustment values are out of range. If not, alignment of the display optical system can be accomplished by movement in a two dimensional plane, and step 418 may be performed. If at least one adjustment value is out of range, the one or more processors determine in optional step 453 a depth adjustment value for bringing any out of range horizontal or vertical adjustment value closer to or within the range limit, and step 418 may be performed to adjust the display optical system.

As an illustrative example, if the optical axis is 12 mm to the right and the display adjustment mechanism can only move the display optical system 6 mm to the left, by increasing the depth between the display optical system and the pupil, the angle from the pupil when looking straight ahead to the position of the optical axis decreases, so a depth increase in combination with the 6 mm adjustment to the left brings the optical axis closer to aligning with the pupil in accordance with an alignment criteria. The effect of the depth change on the vertical dimension may also be taken into account so a vertical adjustment may also be necessary or the depth adjustment value modified.

The embodiments of FIGS. 9B and 9C may also be applied for glint data from each eye when the glints have a geometrical relationship to one another, and the sensor has a surface of discrete sensors such as pixels. For example, the glints for an eye generated by the illuminators form a box or other geometric shape aligned with the optical axis of the respective display optical system for the eye by the positions of the illuminators. If the sensor is a position sensitive detector (PSD) for detecting glints, a position on the sensor and the intensity value detected for a glint generated from a fixed illuminator are used to map a position of the pupil. Image data from an IR camera, or even a visible camera, provides greater accuracy for pupil position determination, but the glint data approach processes less data and is therefore computationally less intensive.

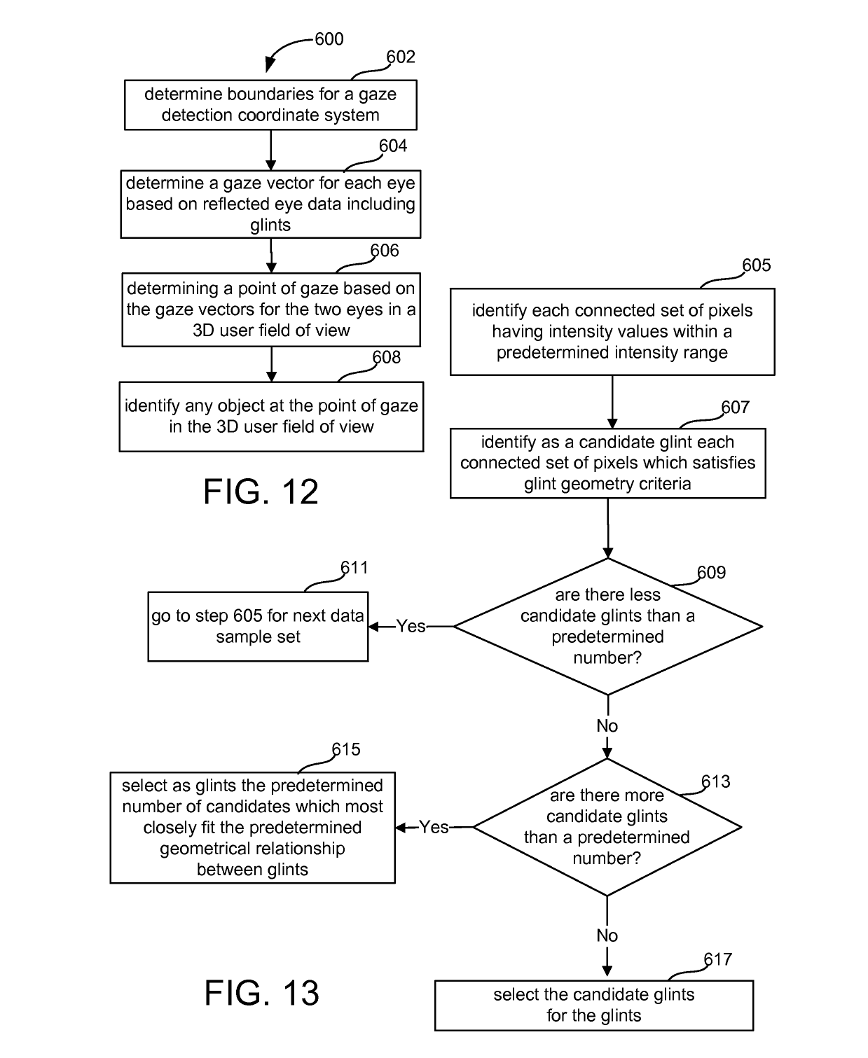

FIG. 9D depicts a flowchart of one embodiment of a method 420 for aligning a see-through, near-eye, mixed reality display with an IPD based on gaze data. steps 412 and 413 are performed as discussed above in FIG. 9B. In step 423, the one or more processors determine a reference gaze vector for each eye to the real object which passes through the optical axis of a respective display optical system based on an arrangement of gaze detection elements for the display optical system. Embodiments for gaze determination methods are discussed in FIGS. 12 through 19. Embodiments of arrangements or systems of gaze detection elements in which those methods may operate are illustrated in FIGS. 4A-4C and 6A-6D. As discussed with respect to the embodiments of FIGS. 8A and 8B, the position of the real object is tracked in the user field of view. In the case of a far IPD, a pupil position based on the user looking straight ahead is estimated, and a reference gaze vector is estimated by modeling a ray from the estimated pupil position through the optical axis to the real object.

In step 414, at least one sensor of the arrangement captures data of each eye during an observation period for the real object, and in step 425, the one or more processors determine a current gaze vector for each eye based on the captured data and the arrangement. In step 426, the one or more processors determine whether the current gaze vector matches the reference gaze vector in accordance with an alignment criteria. If so, the display device 2 has been aligned with each pupil and hence the IPD, and the one or more processors in step 409 store the position of each optical axis in the IPD data set.

If at least one of the current gaze vectors does not satisfy the alignment criteria, in step 427, the one or more processors automatically determine one or more adjustment values for at least one display adjustment mechanism for each display optical system not satisfying the alignment criteria based on a difference between the current and reference gaze vectors. The difference in the current and reference gaze vectors may be represented as a three-dimensional position difference vector, and at least one of a horizontal, a vertical and a depth adjustment value may be determined for bringing the three-dimensional position difference vector within the alignment criteria, e.g. a position difference tolerance in one or more directions.

In step 428, the one or more processors cause the at least one display adjustment mechanism to adjust the at least one respective display optical system based on the one or more adjustment values.

The method embodiment of FIG. 9D may be performed with various methods for determining gaze vectors. For example, the gaze determination method embodiment of FIG. 19 may be used. Additionally, the gaze determination method of FIGS. 12 to 18 which determines a gaze vector based on image data and glint data from an inner eye part to an object may be used. In this method, the initial vector determined models an optical axis of the eye. However, as noted previously, a gaze vector in a human is the visual axis or line of sight from the fovea through the pupil center. Photoreceptors in the fovea region of the human retina are more densely packed than in the rest of the retina. This area provides the highest visual acuity or clearness of vision, and also provides stereoscopic vision of nearby objects. After determining the optical axis, a default gaze offset angle may be applied so that the optical axis approximates the visual axis and is selected as the gaze vector. In some instances, one may determine pupil alignment with the optical axis of a display optical system based on the optical axis vector determined from a center of eyeball rotation through the determined cornea and pupil centers without correcting to the visual axis. However, in other examples, the correction is applied to approximate a gaze vector from the fovea more accurately.

FIG. 9E is a flowchart of a method embodiment 430 for an implementation example of the method 420 in FIG. 9D which applies the gaze offset angle. In this example, uncorrected current and reference gaze vectors are used for a coarse alignment of the pupils with their respective optical axes. Then the gaze offset angle is calibrated for the user, and the alignment check is performed again with the gaze offset angle applied to the vectors for a more fine tuned or accurate alignment with the respective optical axis. As discussed further below with respect to FIG. 18, calibration of the gaze offset angle is performed by displaying one or more images of virtual objects at different distances in the user field of view and determining the gaze offset vector based on distance vectors between the initial optical axis vectors and the positions of the one or more images in the user field of view. Virtual object images will appear clearer to a user when the IPD is properly aligned.

In step 411, a gaze offset angle is set to an initial value. steps 412 and 413 are performed as discussed above in FIG. 9B. In step 431, the one or more processors determine a reference gaze vector to the real object which passes through the optical axis of a display optical system based on an arrangement of gaze detection elements like in step 423 except the reference gaze vector includes the gaze offset angle. Initially if the gaze offset angle is zero, the reference gaze vector is the vector extending from the optical axis of the eye. In step 414, data of each eye is captured during an observation period for the real object by at least one sensor of the arrangement. In step 433, like in step 425, a current gaze vector is determined except it includes the gaze offset angle. As in FIG. 9D, step 426 is performed. If the alignment determination fails for the optical axis of at least one display optical system, steps 427 and 428 are performed and the process beginning at step 426 is repeated.

If it is determined in step 426 that the current gaze vector matches the reference gaze vector in accordance with the alignment criteria, the one or more processors determine in step 436 whether the gaze offset angle has been calibrated. For example, the initial value may act as a flag indicating calibration has not been done or a flag otherwise stored in a memory of the display device may indicate calibration has been performed. If calibration has not been performed, the one or more processors cause the gaze offset angle to be calibrated in step 437, and the process repeats from step 412. From now on, however, the reference and gaze vectors more closely approximate the visual axis of line of sight from the user's eye. If the alignment determination in step 426 indicates satisfactory alignment, and now the gaze offset angle has been calibrated as determined in step 436, the position of each optical axis is stored in the IPD data set.

FIG. 9F is a flowchart of a method embodiment for aligning a see-through, near-eye, mixed reality display with an IPD based on gaze data with respect to an image of a virtual object. In this example, the user's view of the virtual object may not be very clear to begin with as the IPD may be misaligned. However, the one or more processors have more control over virtual objects than real objects and thus more leeway in placing them in the user field of view for determining IPD. By moving the virtual stereo image in each display optical system together or separately, a gaze pattern indicates where in the field of view each user eye is not tracking the object. From where in the field of view the user is not tracking the object, the one or more processors can determine how to adjust each display optical system to better align with its respective pupil.

In step 462, the one or more processors cause the image generation unit, e.g. microdisplay 120, to display a stereo image of a virtual object in a user field of view at a distance and a direction for determining an IPD by projecting a separate image in each display optical system. The two separate images make up the stereo image. In step 463, during an observation period, the one or more processors cause the image generation unit 120 to move at least one of the separate images in the user field of view for at least one of the display optical systems to one or more positions expected to be viewable if each pupil were aligned with its respective optical axis. In step 464, the one or more processors cause the at least one sensor of an arrangement of gaze detection elements for the respective display optical system to capture data of each eye during the observation period in step 464.

The one or more processors determine a gaze pattern for each eye during the observation period based on the captured data and the arrangement of gaze detection elements for each display optical system in step 465. A gaze pattern is a collection of gaze vectors determined for each position of the virtual object image in the user field of view during the observation period. In other words, the gaze pattern reflects the gaze changes during the observation period. In step 466, the one or more processors determine whether the gaze pattern indicates the optical axes are aligned with the respective pupils in accordance with an alignment criteria.

As part of the determination of step 466, the one or more processors determine whether each gaze vector calculated during a period when the virtual object was at a position in the user field of view intersected the virtual object at the position.

If the alignment criteria is satisfied, the one or more processors in step 409 store the position of each optical axis in the IPD data set. If the alignment criteria is not satisfied, the one or more processors in step 467 automatically determine one or more adjustment values for at least one display adjustment mechanism for each display optical system not satisfying the alignment criteria based on the gaze pattern, and in step 468 causes the display adjustment mechanism to adjust the respective display optical system for satisfying the alignment criteria.

The one or more adjustment values may be determined based on a distance vector between each gaze vector which failed to intersect the virtual object and the position of the virtual object at the time period of expected intersection.

A method embodiment such as the described in FIGS. 9D and 9F may be used when glint data is used to determine gaze. In one embodiment, glint reflections can estimate gaze based on a few data points of the intensity values detected for the glints, rather than processing much, much larger sets of image data of eyes. The position of the illuminators 153 on the eyeglass frame 115 or other support structure of a near-eye display device may be fixed so that the position of glints detected by one or more sensors is fixed in the sensor detection area. The cornea and hence the iris and the pupil rotate with the eyeball about a fixed center. The iris, pupil and the sclera which is sometimes referred to as the white portion of the eyeball, move underneath the glint as the user's gaze changes. So a glint detected at a same sensor location may result in different intensity values due to different reflectivities associated with the different eye parts. As the pupil is a hole with tissue that absorbs most incoming light, the intensity value for it would be very low or near zero, while that for the iris would be a higher intensity value due to its higher reflectivity. An intensity value for the sclera may be highest as the sclera has the highest reflectivity.

In some examples, an illuminator may be positioned as in FIGS. 6A through 6D on either side of the display optical system 14 and hence on either side of the pupil of the user's eye. In other embodiments, additional illuminators may be positioned on the frame 115 or lens 118, for example, four illuminators may be positioned to generate a surrounding geometric shape, e.g. a box, of glints on the eyeball which would be approximately centered on the pupil when a user is looking straight ahead. The microdisplay assembly 173 can display a virtual image or send a message, e.g. a visual virtual image or an audio instruction to a user to cause the user to look straight ahead for initializing the glints on or near the pupil. In other embodiments, gaze detection based on glints is based on intensity values generated from illuminators with the glint positioning being independent of being centered on the pupil.

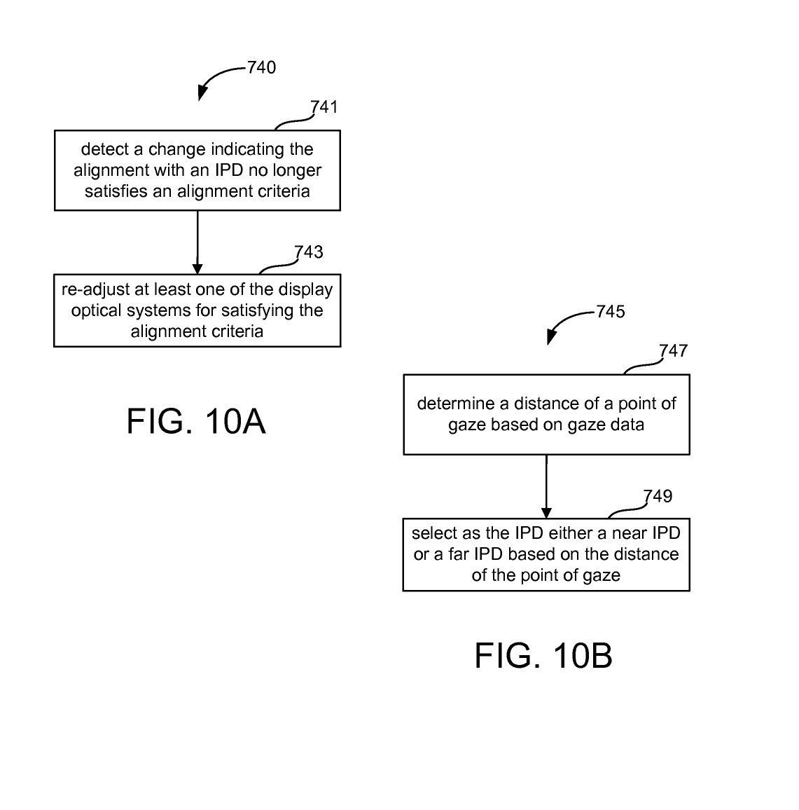

FIG. 10A is a flowchart illustrating a method embodiment for re-aligning a see-through, near-eye, mixed reality display device with an inter-pupillary distance (IPD). In step 741, a change is detected by the processing unit 4, 5 indicating the alignment with the selected IPD no longer satisfies an alignment criteria which triggers the one or more processors in step 743 to re-adjust at least one of the display optical systems for satisfying the alignment criteria. Again the alignment criteria may be a distance of a few millimeters, e.g. 3 mm. A gaze determination method, which is continually being done for tracking the focus of the user may detect the change.

FIG. 10B is a flowchart illustrating a method embodiment for selecting an IPD from a near IPD or a far IPD based on gaze data. The processing unit 4, 5 determines in step 752 a distance of a point of gaze based on gaze data, and in step 754 selects as the IPD either a near IPD or a far IPD based on the distance of the point of gaze. In one example, the user's point of gaze is initially determined to be seven feet or so in front of the user. The display device in this example uses two feet as the point of gaze distance for triggering changes between near and far IPD. The user's focus changes and the point of gaze determined by a gaze determination method indicates the point of gaze is within the two feet threshold for adjusting the IPD from the far or regular IPD initially selected to the near IPD. The processing unit 4, 5 monitors the point of gaze and checks the distance for detecting this change for re-adjusting between IPDs.

Other types of detected changes which may trigger re-adjustment of a display optical system is movement of the display optical system with respect to the eye. Head movement can cause the display device to shift on the user's face.

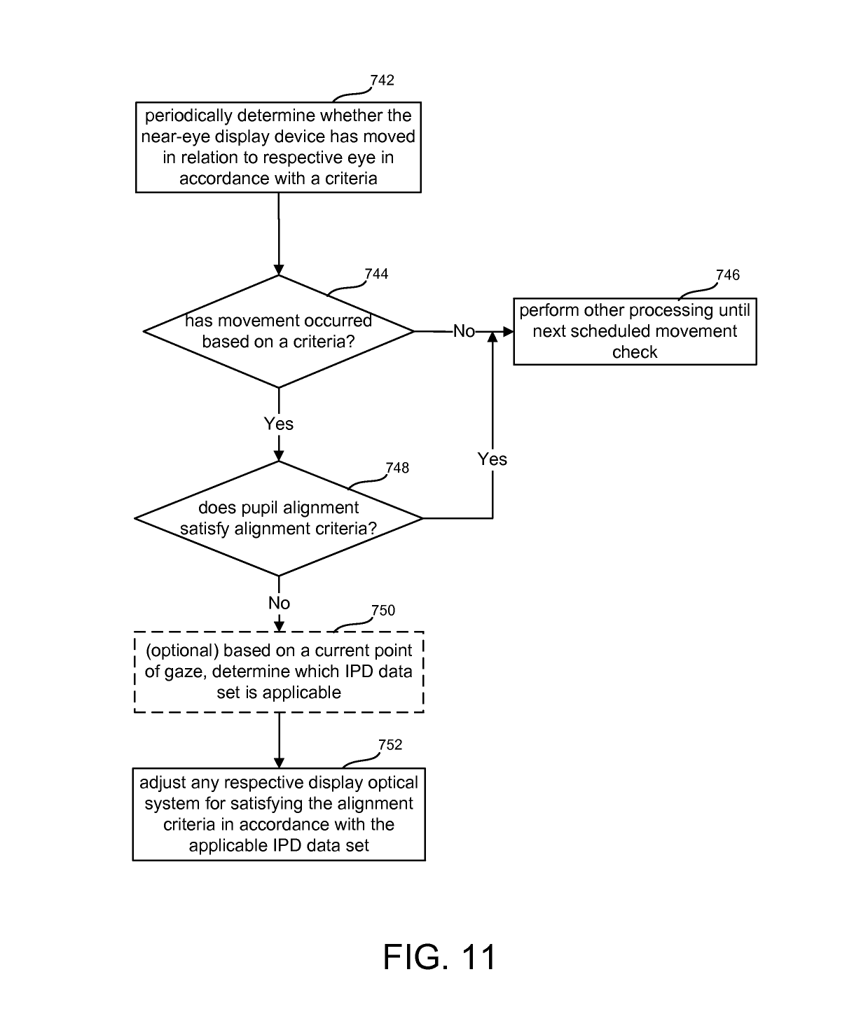

FIG. 11 is a flowchart illustrating a method embodiment for determining whether a change has been detected indicating the alignment with the selected IPD no longer satisfies an alignment criteria. In step 742, the processing unit 4, 5 periodically determines whether the near-eye display device has moved in relation to the respective eye in accordance with a criteria. In step 744, if the result indicates no movement has occurred based on the criteria, the processing unit 4, 5 in step 746 performs other processing until the next scheduled movement check. If movement did occur based on the criteria, a determination is made in step 748 of whether the pupil alignment still satisfies alignment criteria. If yes, the processing unit 4, 5 in step 746 performs other processing until the next scheduled movement check. If the pupil alignment no longer satisfies the alignment criteria, an optional step 750 may be performed in which the processing unit 4, 5 determines which IPD data set, near or far, is applicable based on the current point of gaze. In step 752, the processing unit 4, 5 adjusts any respective display optical system for satisfying the alignment criteria in accordance with the applicable IPD data set.

Based on the different geometries of gaze detection elements discussed above, movement can be detected during different gaze determination method embodiments. The processing unit 4, 5 can monitor the gaze results to determine if the re-adjustment for pupil alignment is to be done. Again, in an embodiment providing both near and far IPD alignment, the distance to the point of gaze may be monitored for triggering a switch between near and far IPD alignment.

FIG. 12 is a flowchart of a method embodiment for determining gaze in a see-through, near-eye mixed reality display system and provides an overall view of how a near-eye display device can leverage its geometry of optical components to determine gaze and a depth change between the eyeball and a display optical system. One or more processors of the mixed reality system such as processor 210 of the control circuitry, that in processing unit 4, the mobile device 5, or the hub computing system 12, alone or in combination, determine in step 602 boundaries for a gaze detection coordinate system. In step 604, a gaze vector for each eye is determined based on reflected eye data including glints, and in step 606 a point of gaze, e.g. what the user is looking at, is determined for the two eyes in a three-dimensional (3D) user field of view. As the positions and identity of objects in the user field of view are tracked, for example, by embodiments like in FIGS. 8A-8B, in step 608, any object at the point of gaze in the 3D user field of view is identified. In many embodiments, the three-dimensional user field of view includes displayed virtual objects and an actual direct view of real objects. The term object includes a person.

The method of FIG. 12 and other method embodiments discussed below which use glint data for other ways of detecting gaze, may identify such glints from image data of the eye. When IR illuminators are used, typically an IR image sensor is used as well. The following method may also work with a discrete surface position sensitive detector (PSD), e.g. one with pixels. FIG. 13 is a flowchart of a method embodiment for identifying glints in image data. As noted above, a glint is a very small and often very bright reflection of light from a light source off of a specularly reflective surface such as the cornea of an eye. In the method embodiment below, each of the steps is performed for a data sample set. In some examples, that may include data from one image or image frame, and in others, the data sample set may be for a number of images or image frames. In step 605, the processor identifies each connected set of pixels having their intensity values within a predetermined intensity range, for example, the range of intensity values may begin at 220 and end at the brightest pixel value 255. In step 607, the candidate glints are pruned by identifying as a candidate glint each connected set of pixels which satisfies glint geometry criteria. An example of glint geometry criteria is size and shape for the glints. Some may be too large, too small, or have too irregular a shape. Furthermore, the illuminators are positioned for the resulting glints to have a spatial or geometric relationship to each other. For example, the illuminators 153 are arranged for the glints to form a rectangle. In the embodiment discussed in FIG. 14 in which a pupil center is determined from image data as well, a spatial relationship to the pupil may also be a criteria, e.g. a distance too far from the pupil may indicate a connected set is not a candidate glint.

In step 609, the one or more processors determine whether there are less candidate glints than a predetermined number. For example, for four illuminators, four glints are expected but the predetermined number may be two. In the example of the rectangle as the geometric relationship, two glints which form a horizontal line or a diagonal line of a predetermined length may have been selected as candidates. There may be an eyelid or eyelash obstruction for the other glints. If there are less than the predetermined number of glints, the data sample set is dropped for further processing, and processing returns in step 611 to step 605 of a next data sample set. If there are not less candidates than a predetermined number, then step 613 determines whether there are more candidate glints than a predetermined number. If there are more candidates, in step 615, the one or more processors select as glints the predetermined number of candidates which most closely fit the predetermined geometrical relationship between the glints. For example, for the rectangle, which candidates most closely form the rectangle of the predetermined size and shape. If there are not more candidates than the number, the number of candidates matches the predetermined number of glints, and the candidates are selected as the glints in step 617.

Due to the geometry of the placement of illuminators for generating the glints as discussed above, the glints appear in the same locations, barring movement of the frame 115 with respect to the eye. Furthermore, as the positioning of the illuminators with respect to each other on the support structure of the frame 115 or lens 118 is fixed, the spatial relationship of the glints to each other in the image is fixed as well. As for size, as the glints are very small, the number of pixels making up the glint area on the sensor and in the sensed image would be correspondingly small. For example, if the image sensor of the camera has a 1000 pixels, each glint may take up less than ten pixels. Glints may be monitored in each image frame taken for example at 30 or 60 frames a second and an area may be identified as a glint from a number of frame samples. There may not be glint data in every frame. Sampling accommodates or smoothes out obstructions of glint, and pupil data, in different image frames such as due to factors like an eyelid or eyelash covering the glint and/or pupil. An image frame is an example of an image format.

FIG. 14 is a flowchart of a method embodiment which may be used to implement step 602 of determining boundaries for a gaze detection coordinate system. One or more processors determines a position of a center 164 of a cornea of each eye with respect to the illuminators 153 and at least one light sensor, e.g. 134 or 152, based on glints in step 612. Based on image data provided by the at least one sensor, in step 614, the one or more processors determine a pupil center of each eye. In step 616, the position of the center of eyeball rotation, which may be treated as fixed, is determined relative to the cornea and pupil centers. For example, based on the pupil center, a ray can be extended back through the determined cornea center 164 to the fixed center 166 of eyeball rotation. Additionally, distance or length approximations are used for approximating the length on the optical axis between the pupil and the cornea, for example about 3 mm, and the length on the optical axis between the center of curvature of the cornea and the center of eyeball rotation, about 6 mm. These values have been determined from population studies of human eye parameters such as those compiled by Gullstrand. (See Hennessey, p. 88).

Optionally, the one or more processors in step 618 determine a position of the fixed center of eyeball rotation with respect to the illuminators and the at least one sensor for the respective eye. This position determined in step 618 provides a depth distance between a fixed point, or one that can be approximated as fixed for accuracy considerations of gaze detection, and the display optical system. In effect, a depth axis has been defined for the gaze detection coordinate system. Changes detected along the depth axis may be used to indicate that the near-eye display system has moved and triggering an alignment check of each optical axis with its respective pupil to see if the alignment criteria is still satisfied. If not, automatic readjustment is performed as per step 752. FIGS. 9A through 9D provide some examples of how the readjustment may be performed.

FIG. 15 illustrates a method embodiment for determining a position of the center of the cornea in the coordinate system with optical elements of the see-through, near-eye, mixed reality display. The one or more processors generate in step 622 a first plane including points including positions of a first illuminator for generating a first glint, a pupil center of the at least one image sensor, e.g. camera entrance pupil center, and the first glint. As in the embodiment of FIG. 3A, the pupil center of the camera may be positioned in relation to the detection area 139 which acts as an image plane and which directs the light it receives to an image sensor in another location. In other examples, like in FIGS. 3B and 3C, the detection area 139 may be the image sensor itself which is the image plane. This first plane will also include a position of the cornea center. Similarly, the one or more processors generate in step 624 a second plane including points including positions of a second illuminator for generating a second glint, the same pupil center of at least one sensor and the second glint. The two planes share the same camera pupil center as an origin and a distance vector to each illuminator is fixed with respect to the camera pupil center as the image sensor and illuminators are positioned on the near-eye display device at predetermined locations. These predetermined locations allow the various points in the planes to be related to each other in a third coordinate system including the two illuminators, the position of the camera pupil center, and the cornea center of curvature. The processor determines in step 626 the position of the cornea center of curvature based on the intersection of the first and second planes

FIG. 16 provides an illustrative example of the geometry of a gaze detection coordinate system 500 which may be used by the embodiment of FIG. 15 to find the cornea center. In this embodiment, the at least one sensor is a camera modeled as a pin-hole camera. The geometry depicted is a slightly modified version of FIG. 3 on page 89 of (Hennessey et al. “A Single Camera Eye-Gaze Tracking System with Free Head Motion,” ETRA 2006, San Diego, Calif., ACM p. 88, pp. 87-94 (hereafter Hennessey), which is hereby incorporated by reference. A list of variables is provided as follows:

\hat{q}ᵢ is a position of an illuminatorᵢ, the light of which produces glint ĝ_{i,} (e.g. 174)

ĝᵢ is the glint produced by illuminator, (153) on a cornea surface,

ô is a camera pupil center of the pin-hole camera model,

\hat{I}ᵢ is the image of glint ĝᵢ on the image plane which is the detection area 139 of the camera sensor,

length, is the scalar distance or length from point ô to \hat{q}ᵢ,

Îᵢ is the vector from the camera pupil center ô to the image \hat{I}ᵢ on the image sensor of the glint ĝᵢ,

\hat{Q}ᵢ is the vector from the camera pupil center ô to the position \hat{q}ᵢ of illuminatorᵢ,

the \hat{X}ᵢ axis is defined along \hat{Q}ᵢ, in this example

and the \hat{Z}ᵢ axis of the coordinate system is such so that Îᵢ which connects the image \hat{I}ᵢ of the glint ĝᵢ on image plane 139 (detection area) lies in a plane formed by the \hat{X}ᵢ and \hat{Z}ᵢ axes.

\hat{β} is an angle formed in the \hat{X}ᵢ\hat{Z}ᵢ plane between a line 502 representing the incident ray of light from the illuminator (153) position \hat{q}ᵢ to the glint ĝᵢ (174) on a cornea surface.

\hat{α} is the angle formed in the \hat{X}ᵢ\hat{Z}ᵢ plane between a line 504 representing the reflected ray from the glint ĝᵢ to the camera pupil center of the camera, ô, which is also the origin of the coordinate system.

ĉ is the position of the cornea center which also lies in the \hat{X}ᵢ\hat{Z}ᵢ plane.

As the cornea is modeled as a sphere, r is the radius of the corneal sphere, and each glint ĝi is a point on the first or external surface of the sphere, so each glint is separated from the cornea center by the radius r. In the above example, the glint ĝi is modeled as a point on the exterior surface or first surface of the cornea. In such a model, the light of the illuminator is bouncing off the cornea in the same medium, air, of the same index of refraction as the reflected light of the glint directed back to the camera sensor.

As shown in FIG. 16, a line or ray 506 normal to the glint ĝi on the surface of the cornea can be extended from the glint in the direction of the cornea and also extended to intersect with the \hat{X}i axis of the \hat{X}i\hat{Z}i plane of the coordinate system. Also as shown in FIG. 16, the incident ray 502 and the reflected ray 504 make a right triangle with the line lengthi between the position of the illuminator \hat{q}i and the camera pupil center ô. Thus angle A and angle D is each represented by

$$\frac{π - {\hat{α}}_{i} - {\hat{β}}_{i}}{2}$$

wherein

$${\hat{α}}_{i} = {cos}^{- 1} ( \frac{- {\hat{I}}_{i} \cdot {\hat{Q}}_{i}}{‖ - {\hat{I}}_{i} ‖ \cdot ‖ {\hat{Q}}_{i} ‖} )$$

and

$${\hat{β}}_{i} = {tan}^{- 1} ( \frac{{\hat{g}}_{ix} \cdot tan ( {\hat{α}}_{i} )}{{\hat{I}}_{i} - {\hat{g}}_{ix}} ) .$$

According to Hennessey, the center of the cornea ĉᵢ can be defined in the coordinate system 500 in terms of the unknown parameter ĝᵢₓ resulting in 3 equations for 4 unknowns (ĉᵢₓ, ĉ_{iy}, ĉ_{iz}, ĝᵢₓ) as follows:

$$[ \begin{matrix}{\hat{c}}_{ix} \\ {\hat{c}}_{iy} \\ {\hat{c}}_{iz}\end{matrix} ] = [ \begin{matrix}{\hat{g}}_{ix} - r \cdot sin ( \frac{{\hat{α}}_{i} - {\hat{β}}_{i}}{2} ) \\ 0 \\ {\hat{g}}_{ix} \cdot tan ( {\hat{α}}_{i} ) + r \cdot cos ( \frac{{\hat{α}}_{i} - {\hat{β}}_{i}}{2} )\end{matrix} ]$$

Another two-dimensional plane including the cornea center, ĉ, another glint ĝᵢ, the camera pupil center ô of the camera and a position \hat{q}ᵢ of another illuminator is also formed. The camera pupil center ô of the camera and the cornea center are the same in each plane although the camera pupil center ô position is known. This will result in 6 equations with 8 unknowns. In Hennessey, the gaze detection coordinate system is treated as an auxiliary coordinate system for which a rotation matrix \hat{R}ᵢ can transform points between the auxiliary coordinate systems for each plane and a single world coordinate system such as the third coordinate system which relates the position of the detection area 139 to the illuminators 153. A constraint exists in which the cornea center defined for each glint is the same in the world coordinate system, e.g. ĉ₁=ĉ₂ and 3 equations result for the different axis components, e.g., ĉ₁ₓ=ĉ₂ₓ, ĉ_{1y}=ĉ_{2y}, and ĉ_{1z}=ĉ_{2z}, thus providing 9 equations with 8 unknowns. Hennessey (p. 90) states to solve numerically for ĉ using a gradient descent algorithm. Thus, the position center 164 of the cornea 168 is defined with respect to the positions of the illuminators and the image plane or detection area 139.

FIG. 17 illustrates a method embodiment for determining a pupil center from image data generated by a sensor. In step 642, the one or more processors identify a black pupil area in a number of image data samples of the respective eye and in step 644 averages the black pupil areas in the number of image data samples to adjust for headshake. An assumption may be made that a pupil is a circle and when viewed from an angle is an ellipse. One axis of the ellipse, the major axis, remains constant as it represents the diameter of the pupil which does not change, provided the lighting does not change, as pupil size changes with lighting changes.

The pupil appears as a circle in an image format such as an image frame of a camera having its detection area centered on the optical axis of the display when the pupil is looking straight ahead through the display. As the pupil changes its gaze and moves from the center of the image frame, the pupil appears as an ellipse, as a circle viewed from an angle appears as an ellipse. The width of the minor axis of the ellipse changes with gaze changes. A narrow ellipse to the left of the center of the image frame indicates the user is looking to the far right. A wider ellipse a distance less to the right of the center of the image frame indicates the user is looking left but not far left.

The center of the pupil is the center of the ellipse. The ellipse is fitted from detected edge points in the image. Because such edge points are noisy and not all of them are on the ellipse, the ellipse fitting process is repeated many times over randomly selected subsets of all edge points. The subset that is most consistent with all the edge points is used to obtain the final ellipse. The processor in step 646 performs an ellipse fitting algorithm on the average black pupil area for determining an ellipse representing the pupil, and in step 648 determines the center of the pupil by determining the center of the ellipse representing the pupil.

With the center of rotation, the cornea center and the pupil center identified, one can extend a ray from the center of rotation through the cornea and pupil centers to obtain an optical axis for the eye. However, as noted previously, a gaze vector in a human is the visual axis or line of sight from the fovea through the pupil center. Photoreceptors in the fovea region of the human retina are more densely packed than in the rest of the retina. This area provides the highest visual acuity or clearness of vision, and also provides stereoscopic vision of nearby objects. After determining the optical axis, a default gaze offset angle may be applied so that the optical axis approximates the visual axis and is selected as the gaze vector.

FIG. 18 illustrates a method embodiment for determining a gaze vector based on the determined centers for the pupil, the cornea and the center of rotation of the eyeball and which embodiment may be used to implement step 604. In step 652, the one or more processors model an optical axis 178 for the eye as a ray extending from the fixed center of rotation of the eyeball through the determined cornea and pupil centers and in step 654 applies a correction to the modeled optical axis for estimating a visual axis. In step 656, the one or more processors extend the estimated visual axis from the pupil through the display optical system of the see-through, near-eye display into the user field of view.

In one embodiment, with the fixed positioning of the illuminators as a basis, the effect of different areas of the eye on reflectivity and hence on the amount or intensity of light reflected is used as a basis for gaze detection. Intensity data from either IR or visible light sensors may be used to determine gaze, so the reflectivity data may be based on IR based reflectivity or visible light reflectivity. For illustration, the sclera is more reflective than other areas of the eye like the pupil and the iris. If a user looks to the user's far left, an illuminator 153 located on the frame 115 at the user's far right causes a glint reflection on the right sclera of the user's right eye. PSD 134r or as in FIG. 6B, photodetector 152 on the inner right frame near bridge 104 receives more reflected light represented in a data reading while the light from reflection at the other photodector 152 or position on the PSD when the illuminator 153 nearest the bridge is turned on receives a lower amount of reflected light in a range associated with the black pupil. The reflectivity of the iris may also be captured by camera 134 and stored for the user by the processor 210, the processing unit 4 or a mobile device 5 embodying the processing unit 4.

The accuracy may not be as much as those based on images of the full eye, but may suffice for many applications. Additionally, such a gaze detection may be useful as an auxiliary or backup gaze detection technique. For example, during computationally intensive periods of generating complex virtual images, such a glint based technique relieves some processor overhead. Furthermore, such a glint-based technique can be executed many more times in a time period than an image based technique which processes more data or a computationally intensive but more accurate technique which may be run at a slower rate to recalibrate accuracy of gaze detection periodically. An example of a gaze detection technique which is both image based and more computationally intensive is one for determining a gaze vector with respect to inner parts of the eye based on glint data and pupil image data like the embodiments described in FIGS. 12 to 18 which may be run at a slower rate to recalibrate accuracy of gaze detection periodically. For example, an embodiment of the more computationally intensive technique based in part on image data may be run at ten (10) times a second while the glint based gaze detection technique may be run at a faster rate of one hundred (100) times per second or even five (500) hundred in some instances.

FIG. 19 is a flowchart illustrating a method embodiment for determining gaze based on glint data. In step 673, data is captured representing each glint intensity value. Based on specular reflectivities of different eye parts, and positions of illuminators, an eyeball part is identified in step 674 based on the intensity value detected for each glint position in a geometrical relationship of the glints. In step 675, a gaze angle is estimated based on the eyeball part associated with each of the glint positions. As described in previous examples, an eyeball part may be an iris, a pupil or a sclera of the eyeball. The positions of the illuminators form a geometry for the glints, e.g. a box, a circle, a rectangle, etc. which frame or surround the pupil, at least on two sides. A gaze vector is determined in step 676 based on the gaze angle, and a point of gaze in the 3D user field of view is determined in step 677 based on the intersection of the gaze vectors determined for both eyes.

As noted above, different methods with different accuracies may be employed at different periodic rates to trade accuracy for speed. A method embodiment based on glint intensity values such as that described in FIG. 19 is an example of a technique with a low computational intensity which may be employed.

Other tests for movement may be performed based on a facial feature with a fixed characteristic in image data. In one embodiment, an eye camera may capture about 5 to 10 mm of area around the visible eyeball portion of the cornea bulge, sclera, iris and pupil so as to capture part of an eyelid and eyelashes. A positionally fixed facial feature like a mole or freckle on skin such as an eyelid or on the bottom rim of the skin encasing the lower eyeball may also be present in the image data of the eye. In image samples, the position of the mole or freckle may be monitored for a change in position. If the facial feature has moved up, down, right or left, a vertical or horizontal shift can be detected. If the facial feature appears larger or smaller, a depth change in the spatial relationship between eye and display device 2 can be determined. There may be a criteria range in the change of position to trigger recalibration of the training images due to things like camera resolution, etc.

In another example, although lighting is a factor which changes the size of the pupil and the ratio of pupil area to visible iris area within the circumference or perimeter of the iris, the size of the perimeter or circumference of the iris does not change with gaze change or lighting change; hence, the perimeter or circumference is a fixed characteristic of the iris as a facial feature. Through ellipse fitting of the iris, processor 210 or a processor of the processing unit 4, 5 of the display device 2 can determine whether the iris has become larger or smaller in image data in accordance with criteria. If larger, the display device 2 with its illuminators 153 and at least one sensor 134 has moved closer in depth to the user's eye; if smaller, the display device 2 has moved farther away. A change in a fixed characteristic can trigger an IPD alignment check.

Besides depth changes, vertical and horizontal changes in pupil alignment can also be determined by a periodic check displaying a virtual object at a predetermined distance for the user to see when looking straight ahead, and seeing if the pupil is centered on the optical axis as per being centered in image data or in a predetermined glint position. Vertical and horizontal changes can also trigger readjustment. As shown in the examples above, the display adjustment mechanism in some embodiments provides for movement in any of three dimensions.

FIG. 20 is a block diagram of an exemplary mobile device which may operate in embodiments of the technology described herein (e.g. device 5). Exemplary electronic circuitry of a typical mobile phone is depicted. The phone 900 includes one or more microprocessors 912, and memory 1010 (e.g., non-volatile memory such as ROM and volatile memory such as RAM) which stores processor-readable code which is executed by one or more processors of the control processor 912 to implement the functionality described herein.

Mobile device 900 may include, for example, processors 912, memory 1010 including applications and non-volatile storage. The processor 912 can implement communications, as well as any number of applications, including the interaction applications discussed herein. Memory 1010 can be any variety of memory storage media types, including non-volatile and volatile memory. A device operating system handles the different operations of the mobile device 900 and may contain user interfaces for operations, such as placing and receiving phone calls, text messaging, checking voicemail, and the like. The applications 1030 can be any assortment of programs, such as a camera application for photos and/or videos, an address book, a calendar application, a media player, an Internet browser, games, other multimedia applications, an alarm application, other third party applications, the interaction application discussed herein, and the like. The non-volatile storage component 1040 in memory 1010 contains data such as web caches, music, photos, contact data, scheduling data, and other files.

The processor 912 also communicates with RF transmit/receive circuitry 906 which in turn is coupled to an antenna 902, with an infrared transmitted/receiver 908, with any additional communication channels 1060 like Wi-Fi or Bluetooth, and with a movement/orientation sensor 914 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 912 further communicates with a ringer/vibrator 916, a user interface keypad/screen, biometric sensor system 918, a speaker 1020, a microphone 922, a camera 924, a light sensor 926 and a temperature sensor 928.

The processor 912 controls transmission and reception of wireless signals. During a transmission mode, the processor 912 provides a voice signal from microphone 922, or other data signal, to the RF transmit/receive circuitry 906. The transmit/receive circuitry 906 transmits the signal to a remote station (e.g., a fixed station, operator, other cellular phones, etc.) for communication through the antenna 902. The ringer/vibrator 916 is used to signal an incoming call, text message, calendar reminder, alarm clock reminder, or other notification to the user. During a receiving mode, the transmit/receive circuitry 906 receives a voice or other data signal from a remote station through the antenna 902. A received voice signal is provided to the speaker 1020 while other received data signals are also processed appropriately.

Additionally, a physical connector 988 can be used to connect the mobile device 900 to an external power source, such as an AC adapter or powered docking station. The physical connector 988 can also be used as a data connection to a computing device. The data connection allows for operations such as synchronizing mobile device data with the computing data on another device.

A GPS transceiver 965 utilizing satellite-based radio navigation to relay the position of the user applications is enabled for such service.

The example computer systems illustrated in the Figures include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

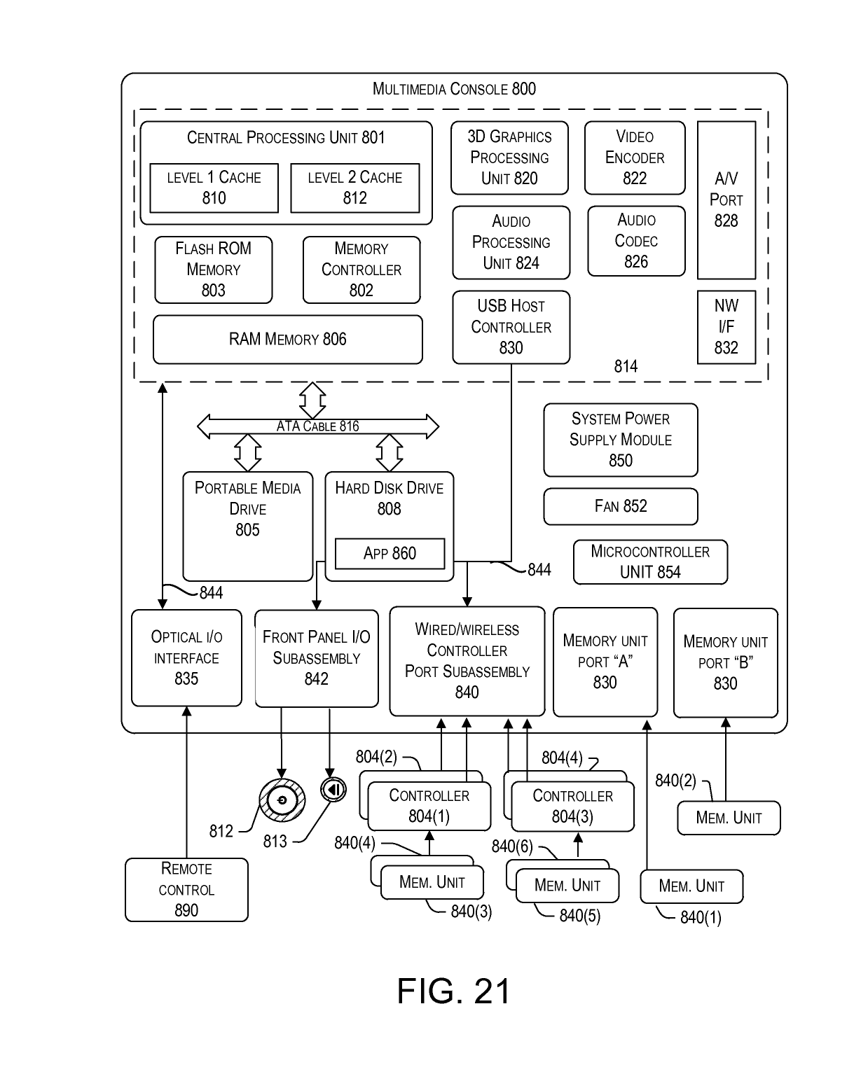

FIG. 21 is a block diagram of one embodiment of a computing system that can be used to implement a hub computing system like that of FIGS. 1A and 1B. In this embodiment, the computing system is a multimedia console 800, such as a gaming console. As shown in FIG. 18, the multimedia console 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 806. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is conFigured as a flash ROM that is connected to memory controller 802 via a PCI bus and a ROM bus (neither of which are shown). RAM 806 is conFigured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an A/V (audio/video) port 828 for transmission to a television or other display. In the illustrated implementation, video and audio processing components 820-828 are mounted on module 214.

FIG. 21 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 21 console 800 includes a controller support subassembly 840 for supporting four controllers 804(1)-804(4). The controller support subassembly 840 includes any hardware and software components needed to support wired and wireless operation with an external control device, such as for example, a media and game controller. A front panel I/O subassembly 842 supports the multiple functionalities of power button 812, the eject button 813, as well as any LEDs (light emitting diodes) or other indicators exposed on the outer surface of console 802. Subassemblies 840 and 842 are in communication with module 814 via one or more cable assemblies 844. In other implementations, console 800 can include additional controller subassemblies. The illustrated implementation also shows an optical I/O interface 835 that is conFigured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be conFigured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into console 800 or a controller, MU 840 can be accessed by memory controller 802. A system power supply module 850 provides power to the components of gaming system 800. A fan 852 cools the circuitry within console 800. A microcontroller unit 854 is also provided.

An application 860 comprising machine instructions is stored on hard disk drive 808. When console 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Gaming and media system 800 may be operated as a standalone system by simply connecting the system to monitor 16 (FIG. 1A), a television, a video projector, or other display device. In this standalone mode, gaming and media system 800 enables one or more players to play games, or enjoy digital media, e.g., by watching movies, or listening to music. However, with the integration of broadband connectivity made available through network interface 832, gaming and media system 800 may further be operated as a participant in a larger network gaming community.

The system described above can be used to add virtual images to a user's view such that the virtual images are mixed with real images that the user see. In one example, the virtual images are added in a manner such that they appear to be part of the original scene. Examples of adding the virtual images can be found U.S. patent application Ser. No. 13/112,919, “Event Augmentation With Real-Time Information,” filed on May 20, 2011; and U.S. patent application Ser. No. 12/905,952, “Fusing Virtual Content Into Real Content,” filed on Oct. 15, 2010; both applications are incorporated herein by reference in their entirety.

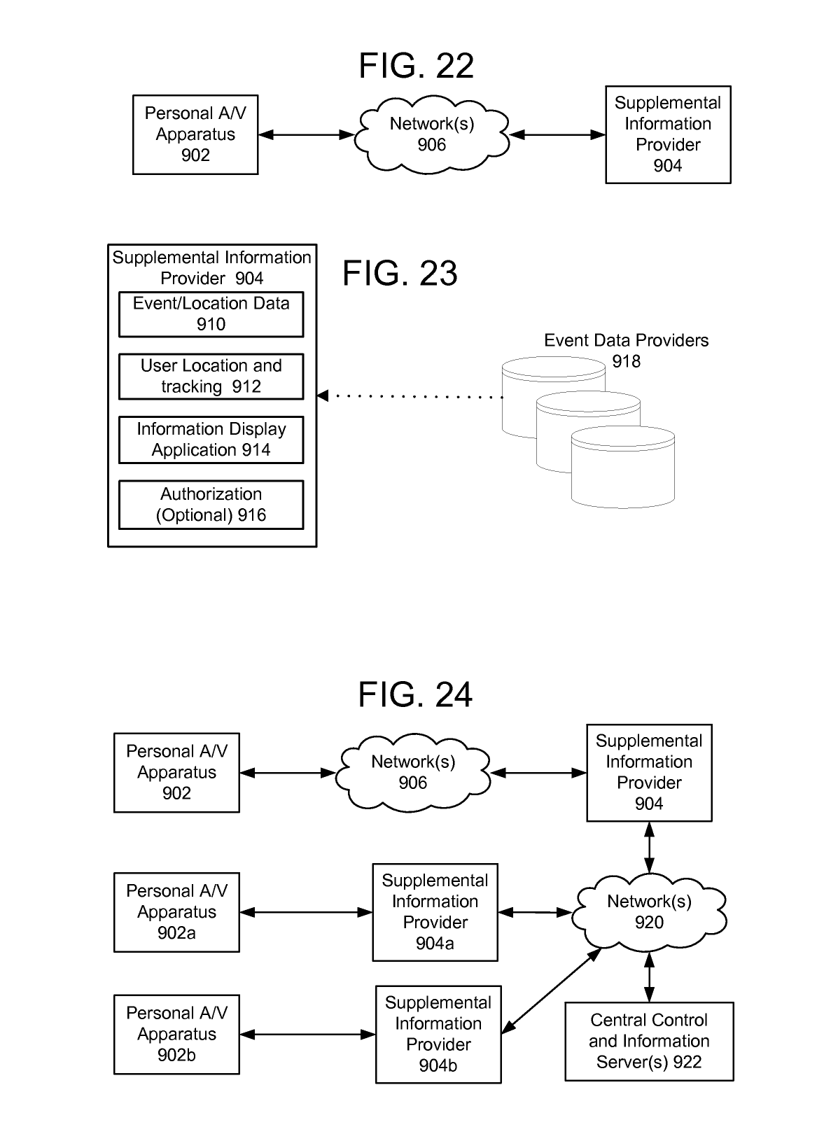

Technology is presented below for augmenting a user experience at various situations. In one embodiment, an information provider prepares supplemental information regarding actions and objects occurring within an event. A user wearing an at least partially see-through, head mounted display can register (passively or actively) their presence at an event or location and a desire to receive information about the event or location. FIG. 22 illustrates a block diagram of a system for implementing the augmenting of the user experience. For example, FIG. 22 shows a personal audio/visual (“A/V”) apparatus 902 in communication with a Supplemental Information Provider 904 via one or more networks 906.

In one embodiment, the personal A/V apparatus 902 can be head mounted display device 2 (or other A/V apparatus) in communication with a local processing apparatus (e.g., processing unit 4 of FIG. 1A, mobile device 5 of FIG. 1B or other suitable data processing device). One or more networks 906 can include wired and/or wireless networks, such as a LAN, WAN, WiFi, the Internet, an Intranet, cellular network etc. No specific type of network or communication means is required. In one embodiment, Supplemental Information Provider 904 is implemented in hub computing system 12 (See FIG. 1A). However, Supplemental Information Provider 904 can also be implemented in other types of computing devices (e.g., desktop computers, laptop computers, servers, mobile computing devices, tablet computers, mobile telephones, etc.). Supplemental Information Provider 904 can be implemented as one computing devices or multiple computing devices. In one embodiment, Supplemental Information Provider 904 is located locally to personal A/V apparatus 902 so that they communication over a local area network, WiFi, Bluetooth or other short range communication means. In another embodiment, Supplemental Information Provider 904 is located remotely from personal A/V apparatus 902 so that they communication over the Internet, cellular network or other longer range communication means.

FIG. 23 shows an example architecture for one or more processes and/or software running on Supplemental Information Provider 904. Supplemental Information Provider 904 may create and provide supplemental event or location data, or may provide services which transmit event or location data from third party event data providers 918 to a user's personal A/V apparatus 902. Multiple supplemental information providers and third party event data providers may be utilized with the present technology. A supplemental information provider 39 will include data storage for supplemental live event information 31, user location and tracking data, information display applications 35, and an authorization component 37.

Supplemental Information Provider 904 includes the supplemental event data for one or more events or locations for which the service is utilized. Event and/or location data can include supplemental event and location data 910 about one or more events known to occur within specific periods and/or about one or more locations that provide a customized experience. User location and tracking module 912 keeps track of various users which are utilizing the system. Users can be identified by unique user identifiers, location and other elements. An information display application 914 allows customization of both the type of display information to be provided to users and the manner in which it is displayed. The information display application 914 can be utilized in conjunction with an information display application on the personal A/V apparatus 902. In one embodiment, the display processing occurs at the Supplemental Information Provider 904. In alternative embodiments, information is provided to personal A/V apparatus 902 so that personal A/V apparatus 902 determines which information should be displayed and where, within the display, the information should be located. Third party supplemental information providers 904 can provide various types of data for various types of events, as discussed herein.

Various types of information display applications can be utilized in accordance with the present technology. Different applications can be provided for different events and locations. Different providers may provide different applications for the same live event. Applications may be segregated based on the amount of information provided, the amount of interaction allowed or other feature. Applications can provide different types of experiences within the event or location, and different applications can compete for the ability to provide information to users during the same event or at the same location. Application processing can be split between the application on the supplemental information providers 904 and on the personal A/V apparatus 902.

FIG. 24 shows another configuration/embodiment in which Supplemental Information Provider 904 is located locally to personal A/V apparatus 902, and Supplemental Information Provider 904 is in communication with Central Control and Information Server(s) 922 via one or more networks 920. In one embodiment, one or more networks 920 can include wired and/or wireless networks, such as a LAN, WAN, WiFi, the Internet, an Intranet, cellular network etc. No specific type of network is required. Central Control and Information Server(s) 922 is/are located remotely from Supplemental Information Provider 904.

In one embodiment, Central Control and Information Server(s) 922 provide central control and data storage for multiple Supplemental Information Providers 904, 904a, 904b, . . . which are in communication with respective personal A/V apparatus 902, 902a, 902b, . . . . Each of the Supplemental Information Providers 904, 904a, 904b, . . . are at different locations and able to connect to any personal A/V apparatus that is within a geographic region of the respective Supplemental Information Provider.

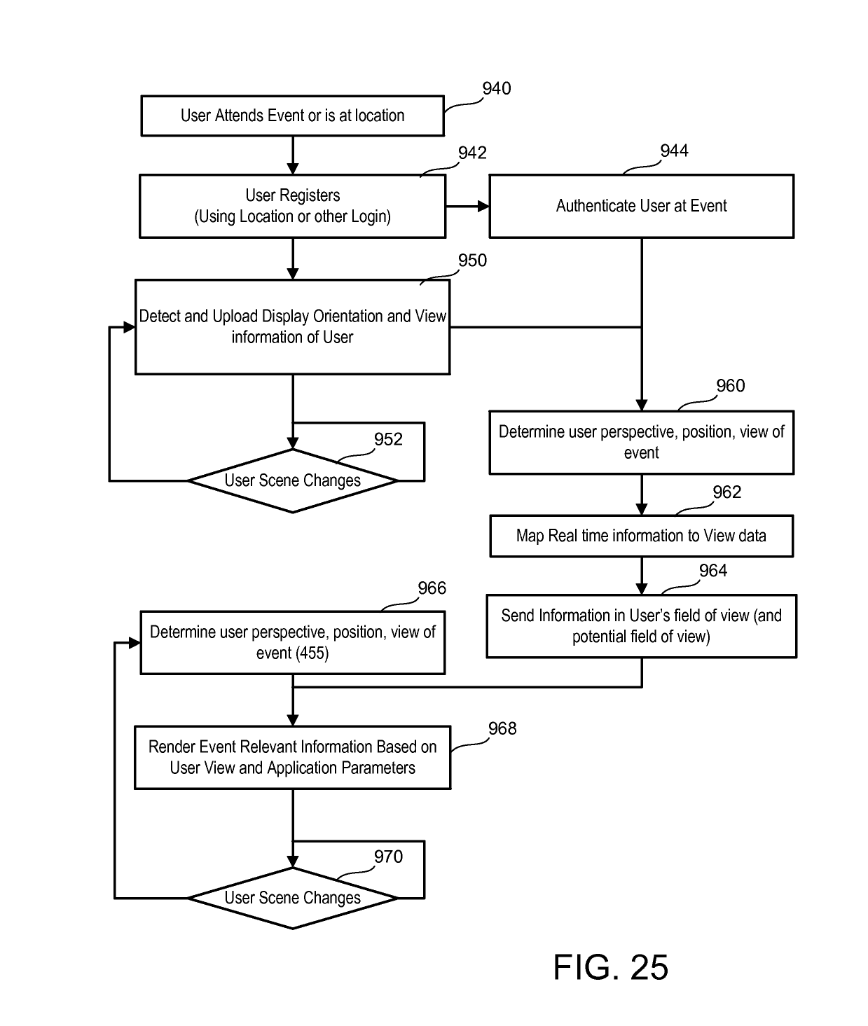

FIG. 25 is a flow chart illustrating one embodiment of a method for providing a customized experience using technology described herein. Elements shown on the left side of the diagram are actions which occur on the personal A/V apparatus 902, while those on the right side are those provided by Supplemental Information Provider 904. At step 940, a user attends a live event or goes to a location providing the service described herein. When a user attends a live event or goes to a location providing the service described herein, registration of the user at the event may occur at step 942. Registration can occur through physical presence at the event by determining the user's location, or some affirmative action on a part of the user to indicate to a supplemental information provider that the user in attendance at the event and wishes to receive supplemental information. An authentication 944 may be required by the Supplemental Information Provider 904. An authentication may occur through various numbers of types of mechanisms including the user login or a location check in using a social networking service

At step 950, user location, display orientation and view information for the user is provided to the Supplemental Information Provider 904. This is performed by the sensors provided personal A/V apparatus 902. Position information will be uploaded to the Supplemental Information Provider 904 to allow the Supplemental Information Provider 904 to determine the field of view and type of supplemental information which needs to be provided to the user. When a user changes its their field of view (952), either due to a physical movement of the user due to rotation, or repositioning of the user's head, or the entire user's body, additional detection and uploading of the display orientation and view information of the user will occur at step 950 and may be uploaded to the Supplemental Information Provider 904 in order to allow Supplemental Information Provider 904 to determine whether an adjustment in the type of supplemental information should occur.

At step 960, a determination will be made by the Supplemental Information Provider 904 of the user's perspective, position, and field of view of the live event. Once a determination of the field of view of the user at the event is made, real time supplemental information concerning the event or location is mapped to objects within the user's field of view in step 962. In one embodiment, information is matched to the actual objects which are determined to be within the user's field of view. In another alternative embodiment, objects within the user's field of view as well as objects which may come within the field of view in some future time are mapped. In this alternative embodiment, information can be downloaded to the personal A/V apparatus 902 to allow the local processor to anticipate actions within an event and to more rapidly process supplemental information which needs to be provided for a user. Once the information is mapped to the user's view data, the supplemental information for objects within the user's field of view is sent to the personal A/V apparatus 902 at step 964.

In step 968, the personal A/V apparatus 902 renders the supplemental information based on the user view and application parameters. Once again, if the user's position or orientation moves (970), the personal A/V apparatus 902 can change the rendering of the information by determining new user perspective, position and view at step 966. In this manner, cooperation between the personal A/V apparatus 902 and the Supplemental Information Provider 904 ensures a seamless display experience for the user. More information about the structures of FIGS. 22-24 and the process of FIG. 25 can be found in U.S. patent application Ser. No. 13/112,929, “Event Augmentation With Real-Time Information,” filed on May 20, 2011, incorporated herein by reference in its entirety.

The supplemental information is provided in real-time as the live event proceeds or as the user interacts at the location of interest. Various types of supplemental information and presentations may be utilized in accordance with the teachings below.

### A. Broadcast Telemetry

An augmented reality system can provide a personalized experience for the user in relation to a sporting event being viewed remote from the event. For example, a user wearing the personal A/V apparatus described above may be viewing a sporting event (e.g., automobile race, baseball game, American football game, soccer match, etc.) on a television (e.g., display 16) at home or other location. Various content can be presented to the user via the personal A/V apparatus to create a customized experience for the user that includes the user choosing to view a different camera feed, the user choosing to highlight certain players or objects in the personal A/V apparatus, the user manually scrolling through video, the system automatically presenting highlights (e.g., in response to crowd noise), highlighting the players on a user's fantasy team and automatically presenting video related to the user's fantasy team. In this manner, the experience is split between the main television and the user's personal A/V apparatus, with the user having the ability to switch the presentations between the two devices. Additional information can be found in U.S. patent application Ser. No. 12/031,033, “Life Streaming,” filed on Feb. 18, 2011, incorporated herein by reference.

One embodiment includes a method for presenting a customized experience to a user of a personal A/V apparatus, comprising: receiving video of an event; receiving data for an event; presenting a first portion of the video on a public display device and presenting a different first portion of the video on the personal A/V apparatus; and adding one or more virtual graphics that highlight a portion of the video presented in the personal A/V apparatus based on orientation of the personal A/V apparatus.

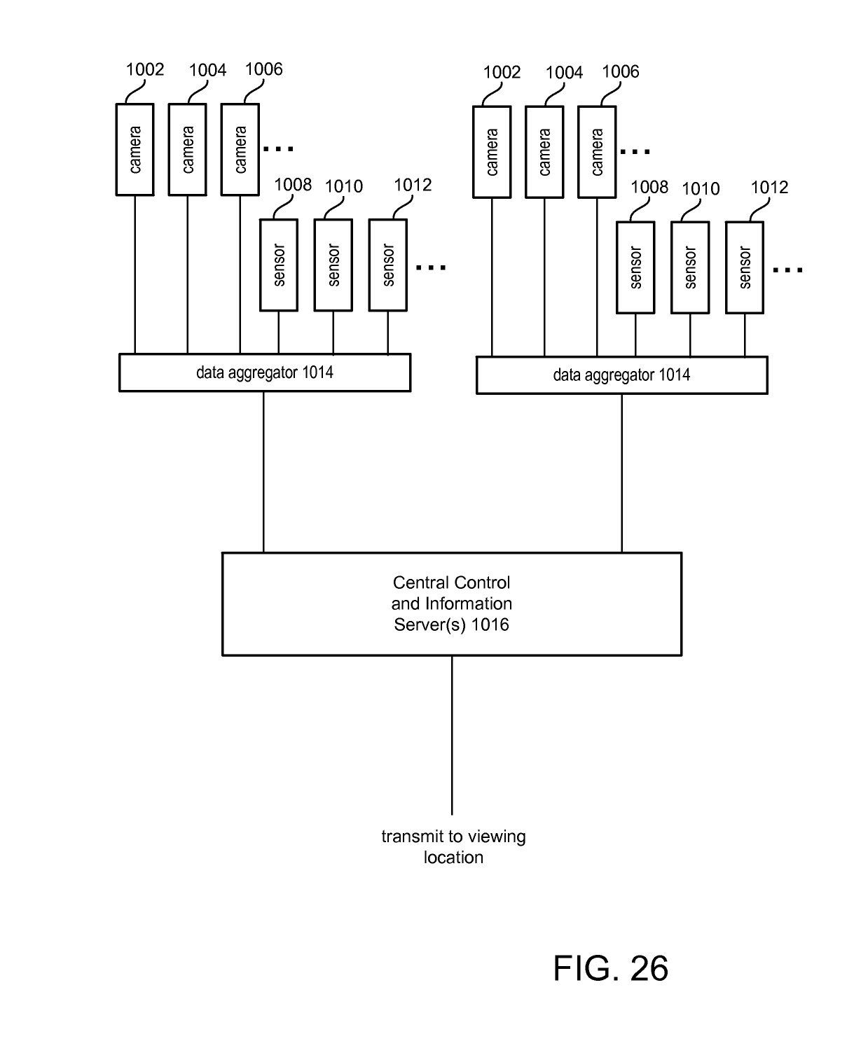

FIG. 26 is a block diagraming describing one embodiment of a system that can be used to provide a customized experience during a sporting event. FIG. 26 shows a set of cameras 1002, 1004, 1006, . . . at a sporting event depicting various points of view of the event. The number of cameras can vary, with each camera showing a different perspective from a different location at the event. FIG. 26 also shows a number of sensors 1008, 1010, 1012, . . . at the event. The sensors can be used to determine location and/or orientation of players, moving objects (balls, bats, racquets, automobiles, . . . ) and cameras. Additionally, one or more sensors can be used to manually input data about the sporting event.

The video from the cameras and the data from the sensors are provided to data aggregator 1014 which packages the data and transmits it to Central Control and Information Servers 1016. In one embodiment, data aggregator 1014 includes one or more computers that can communicate with the one or more computers comprising Central Control and Information Servers 1016. Communication between data aggregator 1014 and Central Control and Information Servers 1016 is provided via a dedicated wired communication link, wireless communication link, the Internet, an Intranet, etc. In one embodiment, there can be one set of cameras, sensors and data aggregator at each event. FIG. 26 shows two sets of data aggregators, cameras, sensors (one for each of two events). However, in other embodiments, there can be more than two events serviced concurrently such that each event has its own data aggregator 1014, cameras 1002, 1004, 1006 and sensors 1008, 1010, and 1012.

Central control and information servers 1016 will package the data from each of the events and provide the data for all or subset of events to the user by transmitting that information to the user's location. The data can be transferred via the vertical blanking interval of a television signal, via the Internet, via wireless connection using other communication means.

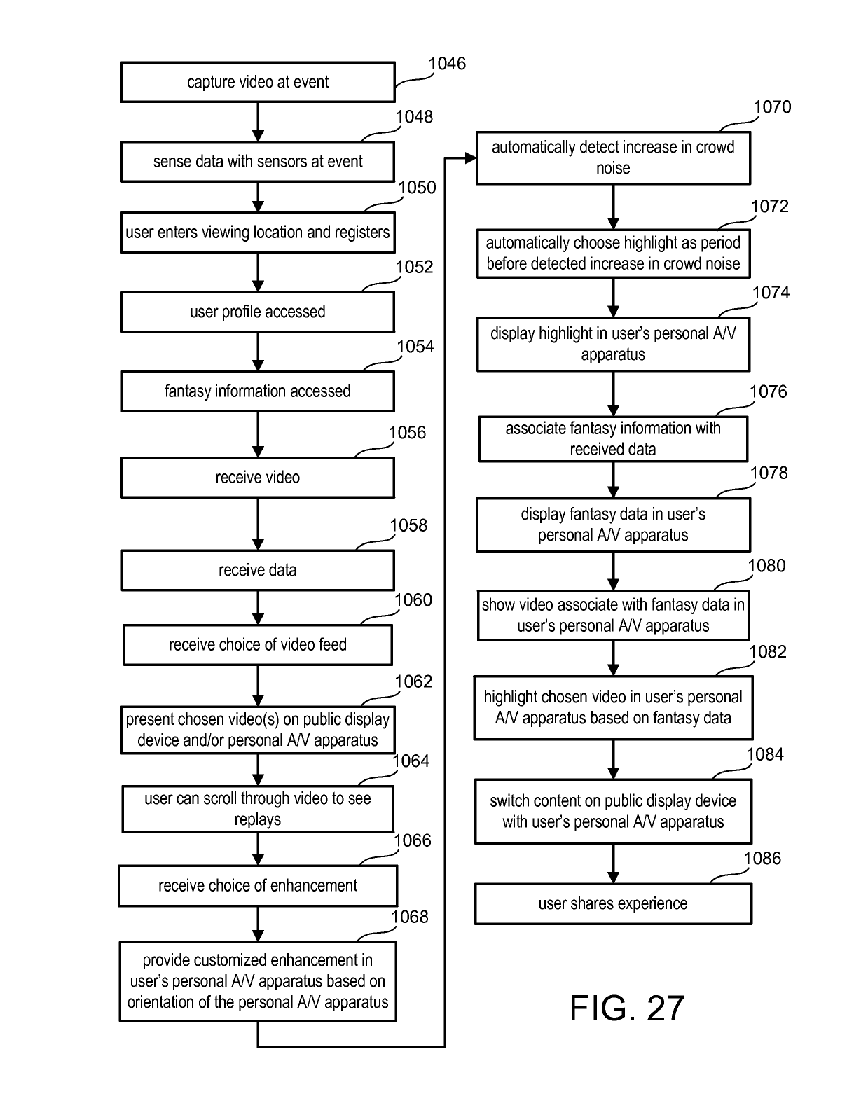

FIG. 27 is a flowchart describing one embodiment of a method for providing a user with a customize experience while viewing a sporting event using the system of FIG. 26. In step 1046, video is captured at the event using the various cameras at the event, with each camera capturing a different perspective from a different location. In step 1048, data is sensed at the event using the various sensors depicted in FIG. 26. Examples of sensors include GPS sensors, radar, infrared sensors, pan sensors, tilt sensors, zoom sensors, gyros, inclinometers, compass, biometric sensors (e.g., heart rate) for players, goal sensors, out-of-bounds-sensors, game clock information, etc. In step 1050, a user will enter the viewing location and register. In one embodiment, step 1050 includes the user walking into a room having a television (see FIG. 1). Registration could happen automatically or manually. In automatic registration, the system will automatically detect the user's presence in the room (e.g., using the depth camera and/or video camera described above) or using location sensors (described above). Alternatively, the user can log in and manually register. In step 1052, the user's profile is accessed. In step 1054, fantasy information for the user is accessed from the user profile. Fantasy information includes various fantasy teams in fantasy leagues which a user is participating in.

In step 1056, video is received for the public display device. Looking back at FIG. 1, display 16 is an example of a public display device because multiple people can view display 16 (e.g., television) without any special permissions. Public display device 16 will include console 12 which can be any type of computing system (including desktop computer, set top box, video game console, etc.). The public display device 26 receives the video in step 1056 and the data from the sensors in step 1058. A default video perspective will be displayed on display 16. In step 1060, the system will receive a choice of video feed. Step 1060 can include the user choosing a video feed for the public dipslay device 16 and choosing a video feed for the user's personal A/V apparatus (e.g. head mounted display 2 of FIG. 1A). In one embodiment, the personal A/V apparatus will display a menu of choices of video feeds to the user (privately within the lens of the personal A/V apparatus). The user will use his or her hands to point to the virtual menu. In one embodiment, the depth cameras of 20B and 20A can determine which menu option the user is choosing. In another embodiment, any of the video cameras associated with the personal A/V apparatus can see where the user is pointed to.

The user can also use other pointing devices or other selection devices to choose a menu option. The chosen video is displayed on the public display device (e.g. display 16). Simultaneously, a different chosen video (or the same video) can be displayed on the user's personal A/V apparatus.

In step 1064, user can scroll through the video. By using his/her hands, the user can drag the video on either the personal A/V apparatus or the public display 16 to the left or to the right. When dragging to the left, the user will go back in time (e.g. showing replays). When the user drags to the right, the video will go forward in time (from replay toward current video).

The user will have the option to make enhancements to the video. The choice of enhancements will be made in step 1066. In step 1068, a customized enhancement will be made within the user's personal A/V apparatus based on the choice made in 1066 and the orientation (location) of the user's personal A/V apparatus. Many different enhancements can be made. For example, the user can choose to highlight and follow a particular player or a particular object (e.g., puck, ball, automobile, etc.). The user may choose to highlight a portion of a playing field. That particular enhancement is chosen in step 1066. The system will use the data from the sensors (received in step 1058) and the received video (received in step 1056) in addition to the sensed orientation of the personal A/V apparatus (using the sensors on the personal A/V apparatus described above) to determine when and where to put the enhancements. For example, arrows can point to the device being tracked or graphics can be used to highlight the device being tracked. An example of a graphic is an image of a cloud placed above or behind the object or adding a swatch of a yellow highlight. The enhancement can be placed in a video from any of the video feeds received (including any of the different videos at the stadium as well as cameras on various players and objects such as helmet cameras, in goal cameras, in-dash car cameras, etc.).

Step 1064 (described above) explains a user can manually choose to view replays. The system can also provide replays automatically. In one embodiment, the system will automatically detect increases in crowd noise in step 1070. In response to detecting the increase in crowd noise, the system will automatically choose a highlight (e.g., instant replay) as a portion of video taking place the period before detecting the increase in crowd noise (step 1072). In one example, each instant replay is 30 seconds long. However, other time periods can be used. The system can choose a camera that is closest to the crowd noise, closest to the majority of objects being tracked, or a camera that covers the biggest portion of the field. The chosen highlight/instant replay is then displayed within the user's personal A/V apparatus in step 1074.

As described above, a user may participate in fantasy leagues. In step 1054 (discussed above), the user status information is accessed. In step 1076, that accessed fantasy information is associated with data received from the various sensors (see step 1058). In step 1078, any of the received data that is relevant to the user's fantasy information is displayed within the user's personal A/V apparatus. By displaying in the user's personal A/V apparatus, only the user wearing the head mounted display can actually see the graphics as it is projected into the user's field of view using the projection system described above. Examples of fantasy information that can be provided include points and statistics for the players on the user's fantasy team in the game being watched as well as other games. Additionally, the system may report where the user's fantasy players are and what they are doing. In step 1080, the system will show video of the user's fantasy players on the user's personal A/V apparatus. By knowing which players are on the user's team and whether the players are in the video or not (based on the sensor data and/or the logic that performed based off of the sensor data), the system can determine which video feeds for the game being watched (or other out-of-town games) will include video of the user's fantasy players. Snippets of those videos of the user's fantasy players can be sent to the user's personal A/V apparatus and displayed on the user's personal A/V apparatus. In step 1082, the user's personal A/V apparatus will project highlights behind, in front of or otherwise indicating any player depicted on display 16 (the public display device). For example if one of the user's fantasy players are playing in the game, while the user is watching the game on display 16, an arrow can be drawn in the personal A/V apparatus that points to the player on display device 16. As the user moves and changes orientation of the personal A/V device, the arrow will also change its orientation and location. In one embodiment, if a user is watching a game, they should see their fantasy players highlighted on the field and get their scores on their HMD. It should change the focal point of the game watching away from most active or interesting point perhaps to focus more on fantasy team members.

As explained above, the presentation of the sporting event includes a split presentation where some of the content is shown on the public display device 16 and some of the content is shown on the user's personal A/V apparatus. In step 1086, the user can request that the content be switched so that whatever was being displayed on the public display device 16 is now displayed on the user's personal A/V apparatus, and whatever was displayed on the user's personal A/V apparatus is now displayed on the public display device 16.

In step 1086, the user (using the personal A/V apparatus) can share the user's experience. For example, there may be other users in the same room who have their own personal A/V apparatus having their own personalized experiences. The user can contact any one of those users and send over videos or data that the user has just viewed so that the other user (e.g. a friend) can see what the user just viewed.

Video should also be related as not just standard 2D video, but also 3D stereoscopic video, or even fully realized 3D scenes that are being broadcast live that the user can interact with, each having increasingly sophisticated controls to allow users to choose viewing vantage points and/or enhancements.

### B. Enhancing Live Viewing Experience

An augmented reality system can provide a personalized experience for the user in relation to a sporting event being viewed at the event. There are systems that enhance video of an event for people watching a television broadcast of the event. The personal A/V apparatus described above allows a user at the event watching the actual event through the personal A/V apparatus to also view virtual graphics. For example, a user watching a baseball game at the baseball stadium where the game is being played, will see the actual baseball game (not a video rendition of the game) through the personal A/V apparatus, as the personal A/V apparatus has a see-through lens (as discussed above). The system described herein can project a virtual image in the personal A/V apparatus. For example, during a baseball game, an image of the strike zone (e.g., a rectangle, cube, geometric solid, rectangular prism, hexahedron, etc) can be projected into the field of view of the user wearing the personal A/V apparatus based on the location and orientation of the personal A/V apparatus, as well as the gaze (where the user's eyes are looking at) of the user. Alternatively, a user at a hockey game can view the hockey game through the personal A/V apparatus and have an image be projected into the user's field of view by the personal A/V apparatus that shows the position of the hockey puck. The information to perform these enhancements can be calculated specifically for the personal A/V apparatus or can be taken from the stream of data used to enhance broadcast television. The personal A/V apparatus can also be used to display help information as well as news from other events.

One embodiment includes a method for presenting a customized experience to a user of a personal A/V apparatus, comprising: sensing information about one or more moving objects; calculating three dimensional real world space locations of the one or more moving objects based on the sensing; determining real world space three dimensional locations of graphics based on the calculated three dimensional real world space locations of the one or more moving objects; determining the three dimensional real world space location of the personal A/V apparatus; determining an orientation of the personal A/V apparatus; determining gaze of the user of the personal A/V apparatus; determining a position in the field of view of the user wearing the personal A/V apparatus that corresponds to the three dimensional location of one of the graphics (the first graphic) based on the determined gaze, an orientation of the personal A/V apparatus and three dimensional real world space location of the personal A/V apparatus; and rendering the first graphic at the determined position. In one embodiment, the rendered first graphic is displayed in a manner that does not occlude any people at the event.

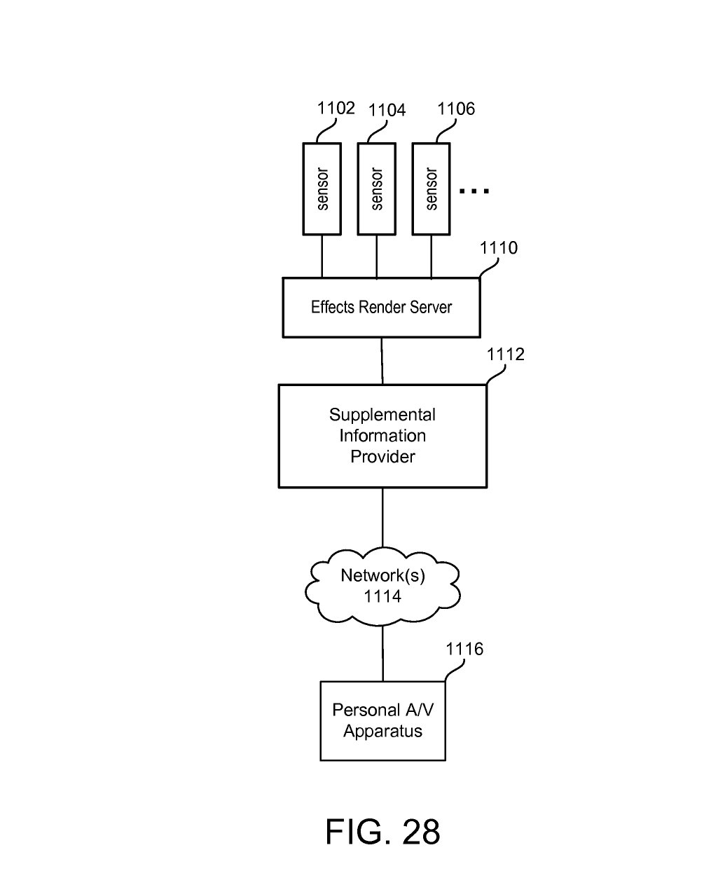

FIG. 28 is a block diagram of one embodiment of a system (or portion of a system) used to provide a customized experience during a sporting event for a user at the sporting event. FIG. 28 shows sensors 1102, 1104, 1106, . . . at the event. Although FIG. 28 shows three sensors; however, more or less than three sensors could be used. Sensors 1102, 1104, and 1106 can be used to track one or more moving (or stationary) objects at a sporting event. For example, sensors can detect the location of a ball, puck, stick, bat, person, wall, field location, etc. Example of the sensors include GPS sensors, infrared sensors, x-ray sensors, radar sensors, video cameras (with image recognition software), etc. No particular type of sensor is required.

The sensors detect information about the location of various objects at an event and report that data to effects renderer server 1110. In one embodiment, effects renderer server 1110 be located at the event. In one example, the sensors are located throughout the stadium on or above the playing field, while effects renderer server 1110 is located underneath the stadium or the parking lot (in a production truck). Long term could be done in cloud. Effects renderer server 1110 will determine the location of the various objects being tracked based on the data from the sensors, where graphics should be added and various metrics. The information from effects renderer server 1110 will be provided to Supplemental Information Provider 1112, which can be one or more servers at the event (or located remote from the event). Supplemental Information Provider 1112 will send the information from effects renderer server 1110 to personal A/V apparatus 1116. Although FIG. 20 only shows personal A/V apparatus 1116, multiple such apparatuses can also be used and be in communication with Supplemental Information Provider 1112 to simultaneously receive different personalized experiences. The data from Supplemental Information Provider 1112 is sent to the personal A/V apparatus 1116 via one or more networks 1114, which can include WiFi, RF communication, microwave band communication, wired communication, LANs, WAN, Internet, Intranet, or other communication means. No particular type of network or communication means is required.

Based on the data received from the Supplemental Information Provider 1112, each personal A/V apparatus 1116 will render graphics in the field of view of the user looking through the personal A/V apparatus so that the user will see these virtual graphics superimposed on the real world scene. In one embodiment, the virtual graphics are superimposed so that they do not occlude any of the players at the game. To accomplish this, the system will either track the positions of the player so that the graphics are rendered appropriately or look at the color of each pixel so that colors associated with player uniforms will not be occluded. In this manner, there will be a metadata stream (information about the graphics to add to the field of view of the user) that is sent to the personal A/V apparatus while the user is watching the event. In another event you just dock metadata to the sides of your field of view so that as you turn your head you can put what you want to see in your main focal area.

In one embodiment, there can be a Supplemental Information Provider 1112 at each of multiple sporting events such that Supplemental Information Providers communicate with each other. Therefore, each Supplemental Information Provider will have statistics and scoring information for all other events simultaneously occurring. This statistical and scoring information from other events will be provided to personal A/V apparatus 1116 for display on personal A/V apparatus 1116.

In one embodiment, each of the broadcast cameras at the event will have sensors for sensing the pan, tilt, zoom, 2× extender, and focal length of the camera. This information can be used to generate graphics for inserting the video from the camera such that the video from the camera and the inserted graphics can also be provided to and displayed on personal A/V apparatus 1116.

In another embodiment, Supplemental Information Provider 1112 can provide various statistics about different players, objects and facets of the game being viewed. Based on detecting the gaze of the user of personal A/V apparatus 1116, personal A/V apparatus 11116 can determine which of the data is most relevant. For example, if the user is focusing on a particular player, data for that particular player is most relevant and will be displayed in the personal A/V apparatus 1116. Thus, although a large superset of data can be sent to personal A/V apparatus 1116, only a subset of that data will be displayed based on the gaze of the user such that only the subset of objects being gazed upon will have the relevant data populated within the field of view of the personal A/V apparatus 1116. Additional relevant information can be found in U.S. patent Ser. No. 13/112,919, “Event Augmentation With Real-Time Information,” filed on May 20, 2011.

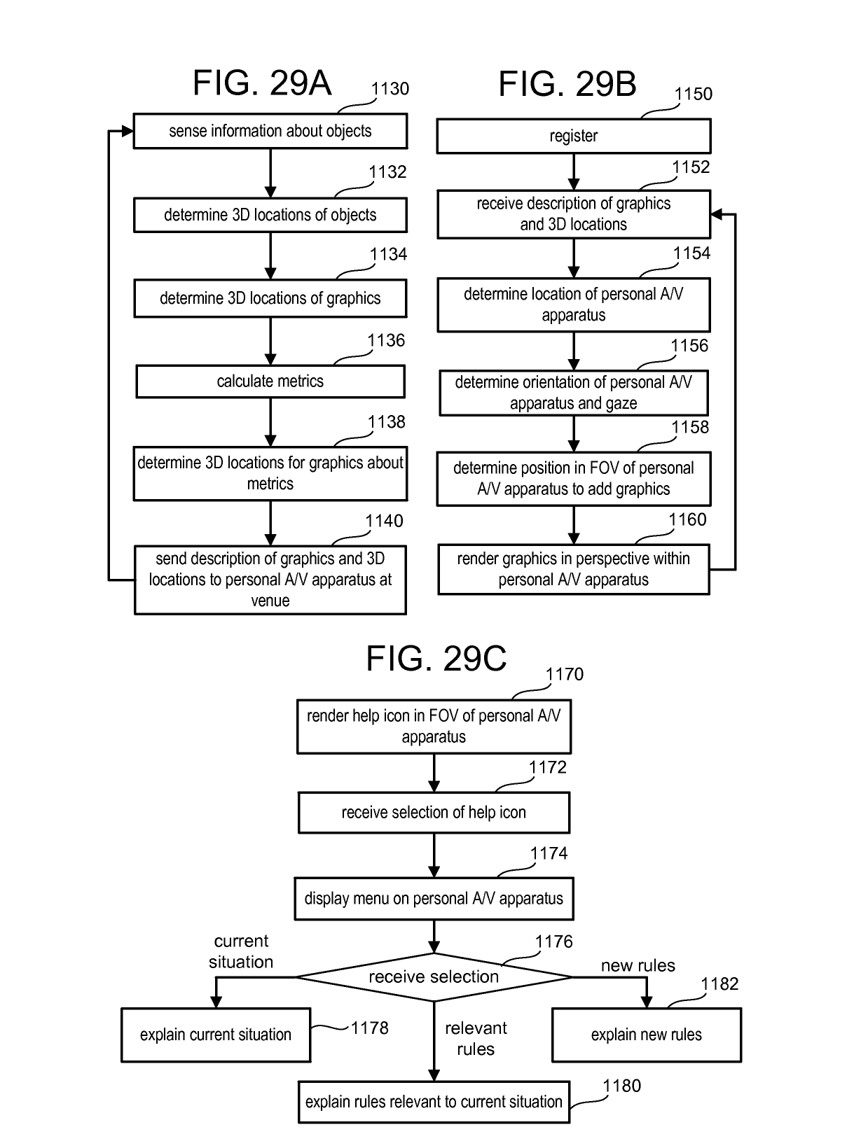

FIGS. 29A-C are flowcharts describing one embodiment of a method for providing the customized experience during a sporting event for a user of the personal A/V apparatus who is at the event. The process of FIG. 29A is performed by the sensors, effects renderer server 1110 and Supplemental Information Provider 1112. The process of FIG. 29B is performed by personal A/V apparatus 1116. The process of FIG. 29C is also performed by personal A/V apparatus 1116, with support by Supplemental Information Provider 1112 and effects renderer 1110.

In step 1130 of FIG. 29A, the system will sense information about one or more moving or stationary objects at the event using the sensors depicted in FIG. 28. In step 1132, the system will determine real world three dimensional locations of the object being sensed. In step 1134, the system will determine real world three dimensional locations of graphics for the objects being sensed based on the determined three dimensional locations of the objects. For example, if one of the objects being tracked is a player moving, step 1132 will determine the three dimensional location of the player. Step 1134 can include inserting any graphic of a trail behind the player (showing the path of the player). Adding the path is based on the location of the player at each sample. The system described above can also be used to track other objects moving at an event.

Step 1136 includes calculating metrics. For example, the system may determine the speed that the ball is being pitched. In step 1138, the system will determine a three dimensional location for a graphic that displays the metric. For example, the system will determine the three dimensional location of the ball in the previous step and put a box above where the ball traveled that indicates the speed of the ball.

Steps 1132-1138 are performed by effects renderer server 1110, which includes one or more computing devices (such as servers). In step 1140, performed by Supplemental Information Provider 1112, descriptions of each of the graphics displayed and the three dimensional locations of those graphics are transmitted to one or more personal A/V apparatuses 1116 that are at the venue.

In step 1150 of FIG. 29B, personal A/V apparatus 1116 will register (which in one embodiment includes authenticating and/or authorizing). In one embodiment, step for registering is optional. In step 1152, personal A/V apparatus 1116 will receive the description of the graphics and the three dimensional locations of the graphics (sent in step 1140 of FIG. 29A). In step 1154 of FIG. 29B, personal A/V apparatus 1116 will determine the location of the personal A/V apparatus using the sensors described above. In step 1156, the personal A/V apparatus will determine its orientation. Step 1156 also includes the personal A/V apparatus determining the gaze of the user of the personal A/V apparatus, as described above. In step 1158, the personal A/V apparatus will determine the position in the field of view of the user (looking through the personal A/V apparatus) to add the one or more virtual graphics. The position determined in step 1158 is based on the location of the personal A/V apparatus, the orientation of the personal A/V apparatus and the gaze of the user. In step 1160, the one or more graphics are rendered in perspective at the calculated position (determined at step 1158) within the personal A/V apparatus.

In one embodiment, the processes of FIGS. 29A and 29B are continually repeated multiple times throughout the event. This is depicted by the arrow from step 1140 of FIG. 29A to the step 1130. Steps 1152-1160 of FIG. 29B are also repeated, as indicated by the arrow connecting step 1160 to 1152. In one embodiment, these processes are repeated 30 times a second. In other embodiments, these processes can be repeated more or less than 30 times a second.

In one embodiment, the personal A/V apparatus can also provide help information. FIG. 29C describes one embodiment of a process for providing such help information. In step 1170 of FIG. 29C, the personal A/V apparatus will render a help icon in the field of view of the user looking through the personal A/V apparatus 1116. A shape and color help icon can vary based on the look and feel of other objects in the field of view. In one embodiment, the help icon is the word HELP or a question mark. If the user does not select the help icon, then the remainder of the process of FIG. 29C will not be performed. If the user does select the help icon (by saying the word help, pointing to where the word help is in the user's field of view, and/or other means), then the selection will be received by the personal A/V apparatus in step 1172. In step 1174, the personal A/V apparatus will display a menu of help options to the user in response to the selection received in step 1172. In one embodiment, the menu will include at least the following three options: (1) explain the current situation, (2) explain rules relevant to the current situation, and (3) explain new rules for the game being viewed.

In step 1176, one of the three above-described options is selected. If the user selects to receive an explanation of the current situation, then the current situation will be explained by the personal A/V apparatus in step 1178. For example, the personal A/V apparatus will contact Supplemental Information Provider 1112 for an explanation of the current situation. In response, Supplemental Information Provider 1112 will provide a text explanation of what is happening. For example, a user watching a baseball game may be provided with an explanation of why the infield of a baseball team has moved closer to home plate. This could occur as random toasts or as shown in drawing 29c.

If, in step 1176, the user selected to receive an explanation of rules relevant to the current situation, then personal A/V apparatus 1116 will send a request for rules information to Supplemental Information Provider 1112, which will respond with identification of the rules relevant to the current situation and an explanation of what those rules mean.

If the user selected to explain new rules (step 1182), then personal A/V apparatus 1116 will send a request to Supplemental Information Provider 1112 for indication of any new rules relevant to the current event. For example, if the user is at a baseball game and in the previous off season the league adopted new rules, those new rules would be displayed (in text form) to the user.

The technology described above for displaying help information can be used with any of the systems described herein and in conjunction with any of the processes described herein.

### C. Golf Applications for Personal A/V Apparatus

An augmented reality system can provide a personalized experience for the user while playing a sport. In one embodiment, a user operating the personal A/V apparatus will be provided with assistance during a game. For example, in golf the personal A/V apparatus can act like a virtual caddy that suggests shots, suggests clubs, advises for weather conditions, provides strategy and automatically tracks the ball after being hit. In one embodiment, the personal A/V apparatus will also display the results of another player (e.g., a friend or famous player) for the same golf course so that the user can play against the other player. This technology can be used for sports other than golf. In one embodiment, a user could actually play with the other player. A hologram of that player could appear on the course and tee up before or after the user. This would be previously captured data that has been uploaded and would then be specific to that course over generic image of the player hitting at any course.

One embodiment includes a method for presenting a customized experience to a user of a personal A/V apparatus, comprising: determining a three dimensional position of the personal A/V apparatus; determining an orientation of the personal A/V apparatus; determining a gaze of the user; determining a three dimensional location of a ball; determining and reporting the effects of weather; determining and reporting a high risk play; determining and reporting a low risk play; determining and reporting club selection; determining and reporting a manner to address the ball; adjusting the manner, club selection, high risk play and low risk play based on a user profile for the user of the personal A/V apparatus; and displaying in the personal A/V apparatus another player's results for the same course.

One embodiment of the system that can provide a personalized experience for the user while the user is playing a sport will be implemented using the system of FIG. 24, where a personal A/V apparatus 902 will be in communication with a Supplemental Information Provider 904 via a local (or short distance) communication means (wired or wireless). Supplemental Information Provider 904 will act as a conduit between personal A/V apparatus 902 and a central communication and information server 922.

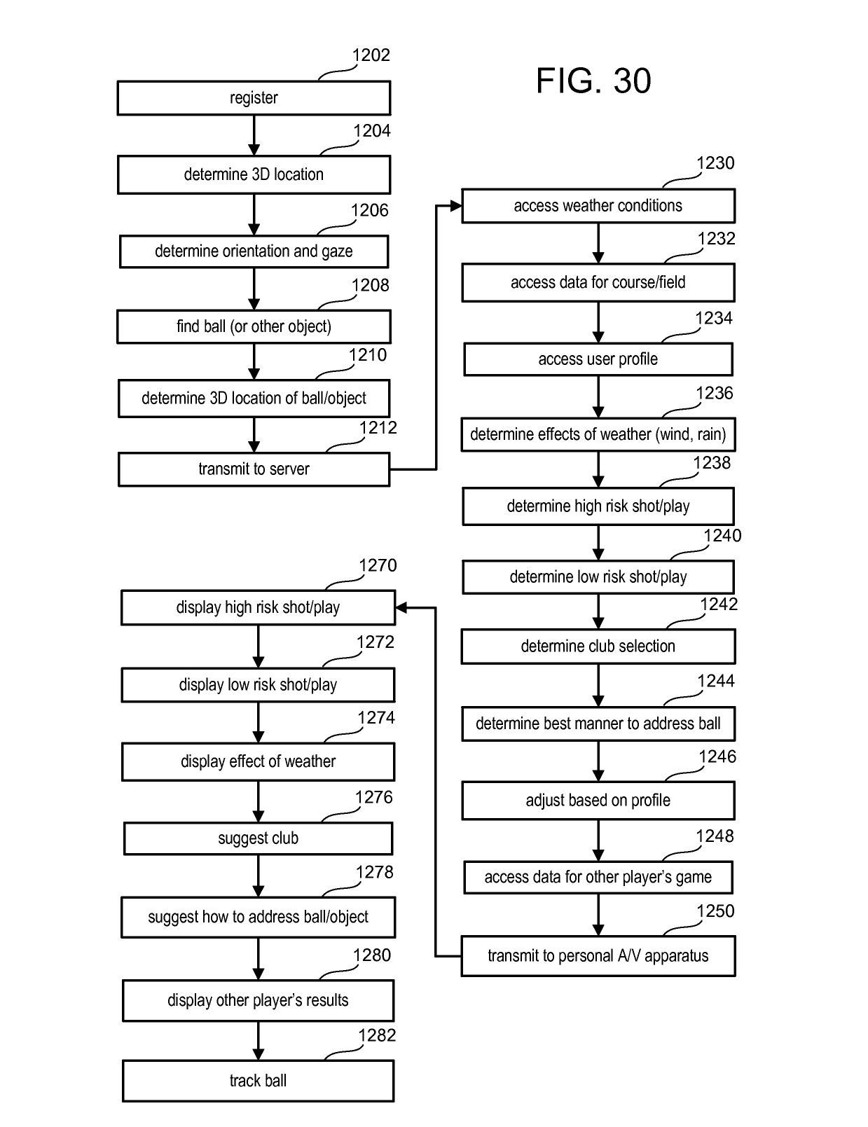

FIG. 30 is a flowchart describing one embodiment of a process for providing a personalized experience for a user while the user plays a sport. The steps on the left side of FIG. 30 are performed by a personal A/V apparatus 902 while the steps on the right side of the FIG. 30 are performed by a Central Control and Information Server 922 (and/or a Supplemental Information Provider). In step 1202, personal A/V apparatus 902 will register (e.g., including authenticate and/or authorize). In step 1204, personal A/V apparatus 902 will determine its three dimensional location in real world space. In step 1206, personal A/V apparatus 902 will determine its orientation and the gaze of the user (as described above). In step 1208, personal A/V apparatus 902 will find the ball. In one example, the system is used at a golf course and a front facing video camera (and/or depth camera) can be used to find a golf ball on the course. The video camera and depth camera can also be used to help aid in finding the location of the personal A/V apparatus 902. In step 1210, personal A/V apparatus 902 will determine the three dimensional location of the ball. Note that this system can be used with games other than golf therefore other objects can also be located. In step 1212, the information determined in steps 1204-1210 is transmitted to the Central Control and Information Server 922 via Supplemental Information Provider 904. In one embodiment a GPS receiver would be in the ball.

In step 1230, Central Control and Information Server 922 will access weather conditions, including wind speed, wind direction and precipitation information. In step 1232, data is accessed for the golf course (or other type of field). This data will include the map of the field, contours, indications of traps, etc. In step 1234, Central Control and Information Servers 922 will access a profile for the user who registered at step 1202 (the information about the identity of the user was provided in step 1212). In step 1236, Central Control and Information Servers 922 will determine the effects of weather (e.g. wind, rain). In step 1238, Central Control and Information Servers 922 will determine a high risk shot (or other type of play for other sports) based on the location of the personal A/V apparatus 902, the location of the ball, weather conditions and the course information accessed in 1232. Using the same data, the system will determine a low risk shot/play in step 1240. Central control and information servers 922 will determine the appropriate clubs to use for each shot in step 1242. The manner for best addressing the ball is determined in step 1244, including where to stand and what orientation to put your body.

In step 1246, the information determined above in steps 1236-1244 can be adjusted based on the accessed user profile. For example, if the user is a particularly unskilled player or a novice, the system will choose a recommendation that is easier to accomplish.

In step 1248, data for another player's game will also be accessed. For example, the user may want to play against a friend who previously played the same course. Alternatively, the use may want to play against a famous player (such as a professional player) who played the same course. Information for the other player for the same hole (or same shot or same play) will be accessed in step 1248. In step 1250, all the information determined in steps 1236-1248 is sent back to personal A/V apparatus 902.

In step 1270, the high risk shot/play is reported to the user by displaying the information in the personal A/V apparatus 902. In step 1272, personal A/V apparatus 902 will display the low risk shot/play. In step 1274, effect of weather will be displayed. In step 1276, suggestion of which club to use will be displayed to the user. In step 1278, a suggestion of how to address the ball will be displayed in the persona; A/V apparatus. For example, a diagram of where to stand and how to hit the ball can be displayed in the see-through optical system of the personal A/V apparatus in manner such that the user can still see the actual ball unoccluded by any virtual or video images. In step 1280, personal A/V apparatus 902 will display the other player's results. For example, the system can display a video of the other player can be shown, an animation of what happened when the other player played the same course, or text identifying the results for the other player. Note that the information displayed in steps 1270-1280 will be displayed by the optical system within the personal A/V apparatus (as discussed above). In one embodiment, the system can ghost the user with the user's last time played there.

After step 1280, it is assumed that the player will hit the ball. In step 1282, the personal A/V apparatus 902 will automatically track the ball so that when the balls lands the personal A/V apparatus can render and arrow (or other shape) in the user's field of view in the personal A/V apparatus to show the user where the ball is. Additionally, the user's profile can be updated based on performance of the shot.

### D. Exercising Applications for Personal A/V Apparatus

An augmented reality system can provide a personalized experience for the user while the user is exercising. In one embodiment, the personal A/V apparatus, in conjunction with a server, can display virtual images of other people (e.g., friends, famous people or the same person during a prior workout) performing the same work out so that the user can compare their performance or use the other person's performance as motivation. For example, while the user is running, the personal A/V apparatus can show a ghost of another runner who is running the same course. The personal A/V apparatus can also track a person's progress during a workout, provides tips/paths for proceeding, store the data for future comparisons, compare the data to past work outs, and share with friends (e.g., through social networking applications).

One embodiment includes a method for presenting a customized experience to a user of a personal A/V apparatus, comprising: determining a three dimensional position of the personal A/V apparatus; determining a course of action based on the determined three dimensional position; identifying data for another user performing the same course of action; determining an orientation of the personal A/V apparatus; determining a gaze of the user; and rendering an image representing the another user indicating the another user's performance at the same time and three dimensional location, the rendering being performed on a see-through display so that the user can see the image inserted as a virtual image into the real scene.

Some embodiments of a system for presenting a customized experience to a user of a personal A/V apparatus implement the structures of FIG. 22 or 24 (using the structure of FIG. 23). The personal A/V apparatus will be worn or possessed by the user performing the exercise. A Supplemental Information Provider 904 can be at the site of the exercise (at a gym, near a jogging course, near a bicycle riding course, etc.) or at a central location accessible via a cellular network or other communication means. In the embodiment of FIG. 24, there can be a Supplemental Information Provider 904 local to the exercise and a Central Control and Information Server remote from the exercise.

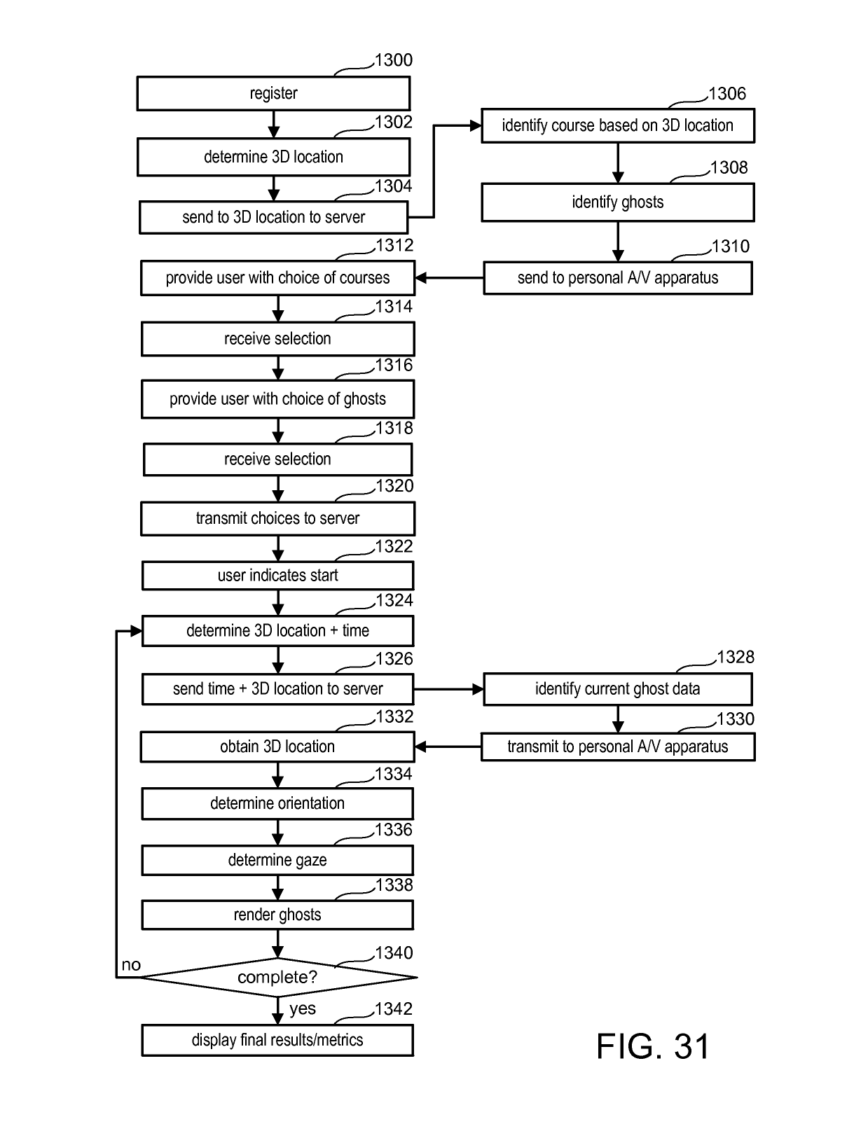

FIG. 31 is a flow chart describing one embodiment of a process for providing a customized experience to a user for personal A/V apparatus while exercising. In step 1300, the user will register with the service. In one example, the user may need to authenticate and/or authorize. In step 1302, the personal A/V apparatus will determine its three-dimensional location using the sensors, as described above. The determined three-dimensional location is transmitted to the server in step 1304. Note in the flow chart of FIG. 31, the left side of the flow chart is performed by personal A/V apparatus 902 and the right side of the flow chart is performed by Supplemental Information Provider 904 and/or Central Control and Information Servers 922.

In step 1306, the servers (Supplemental Information Provider 904 an/or Central Control and Information Servers 922) will identify the course of action being performed by the user based on the transmitted three-dimensional location. For example, if the user is riding a bicycle on a race course, the system will determine which course the user is riding on. If the user is performing a workout at a gym, the system will determine which gym the user is at, based on the three-dimensional location. In some embodiments, based on the three-dimensional location the user is currently at, there can be multiple courses.

In step 1308, the system will identify ghosts. That is, the user can compare the user's performance to other people including a friend of the user, a famous person (e.g., professional athlete), or the user's own performance from a prior iteration. The system will store data describing the performance of the other person. Based on the course of action the user is performing (identified in step 1306), the system will identify all the data for other users for that particular course. Eventually, the system will show an image with the other user performing the course of action, where the image will be rendered as a ghost (transparent) so that the user can still see the course but will see the other user performing the course. In step 1310, the servers will send the information about the course and all of the identified ghosts available to the personal A/V device.

In step 1312, the personal A/V apparatus will provide a user with a choice of all the courses available for that current location. In step 1314, the personal A/V apparatus will receive a selection from the user of the course the user wishes to proceed with. In step 1316, the personal A/V apparatus will provide the user with a choice of all the ghosts for the particular course chosen by the user. In step 1318, the user will select one of the ghosts. The choices of course and ghosts are transmitted to the server in step 1320 based on the selection received in step 1318.

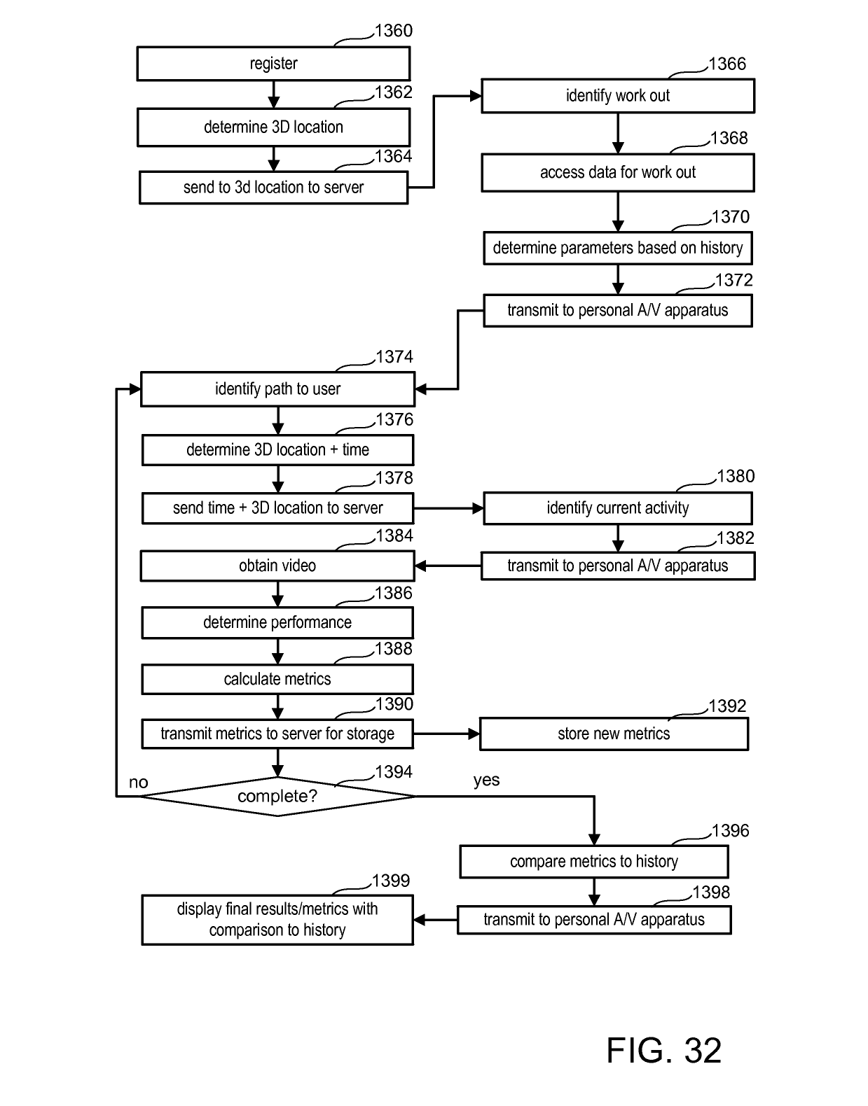

In step 1322, the user will indicate that the user is starting the course of action. For example, the user can say the word start or other keyword, push a virtual button, push a button on the personal A/V apparatus, etc. In step 1324, the personal A/V apparatus will determine its three-dimensional location and the current time. In step 1326, the three-dimensional location and the current time are sent to the server. In step 1328, the server will identify the ghost data for the current time lapse from the beginning of the course. That ghost data (location and/or orientation) will be transmitted to the personal A/V apparatus in step 1330. In step 1332, the personal A/V apparatus will determine its three-dimensional location as an update to its position. In step 1334, the personal A/V apparatus will determine its current orientation. In step 1336, the personal A/V apparatus will determine the gaze of the user. In step 1338, the personal A/V apparatus will render an image of the ghost within the personal A/V apparatus such that the user can see through the personal A/V apparatus and see an image of the ghost projected onto the real world scene. The rendering of the ghost in step 1338 is based on the three-dimensional location of the ghost received in step 1330, the three-dimensional location of the personal A/V apparatus, the orientation of the personal A/V apparatus, and the gaze of the user. If the exercising is not complete, then the process loops back to step 1324. If the user has completed the exercise course, then the final results and/or any metrics calculated (see FIG. 32) can be displayed.

FIG. 32 is a flow chart describing one embodiment of a process for using the personal A/V apparatus to provide a customized experience by monitoring and assisting while the user is exercising. The process of FIG. 32 can be performed in conjunction with or separately from the process of FIG. 31. The process described in FIG. 32 helps to provide route management and metrics for the user during a course of exercise. The system might also remind the user, for instance, of what weights to use and settings for machines, etc. in a work out; report calories burned last time on treadmill; or other information.

In step 1360 of FIG. 32, the user will register with the service (which can include authentication and/or authorization). In step 1362, the personal A/V apparatus will determine its three-dimensional location. In step 1364, the determined three-dimensional location is transmitted to the server. Based on the transmitted three-dimensional location, the server will determine the workout being performed in step 1366. For example, the server will determine the gym that the user is at, the running course the user is on, etc. In step 1368, the server will access data for the workout the user is about to do. In many cases, the user has already worked out at this particular gym or run this particular course, and the server will have data from past workouts.

The server can also access data for other users in step 1368, including data from friends, professionals, or other people the user does not know. In step 1370, the server will determine any parameters based on past history. For example, the server may determine how fast the user should run, how many reps the user should do, etc., based on the user's past history of workouts. In step 1372, the data for the parameters determined in step 1370 are transmitted to the personal A/V apparatus. One of the parameters identified in step 1370 is the path the user should take. This may include a path for running, a path for bicycling, or machines to use at a gym. The path is identified to the user by the personal A/V apparatus in step 1374. The personal A/V apparatus will determine its three-dimensional location and its current time in step 1376. In step 1378, the time and location are transmitted to the server.

In step 1380, the server will use the transmitted three-dimensional location and time to identify the current activity being performed. For example, the server can determine which exercise the user is performing at the gym or which portion of the race course the user is on. In step 1382, the identified information from step 1380 is transmitted to the personal A/V apparatus. In step 1384, the personal A/V apparatus will obtain video of what the user is doing. Based on the video, the personal A/V apparatus will determine the performance of the user in step 1386. For example, if the user is working on an exercise machine, the video will be used to determine how many repetitions the user performed. In step 1388, the personal A/V apparatus will calculate metrics such as number of repetitions to be performed, calories burned, time elapsed, distance traveled, etc. Those metrics are transmitted to the server in step 1390. The server will store the metrics in step 1392. If the exercise routine is not complete (step 1394), then the process will loop back to step 1374.

If the exercise course is complete (step 1394), the server will compare metrics for the current exercising to prior history for the user (step 1396). The results of that comparison are transmitted to the personal A/V apparatus in step 1398 and displayed to the user in step 1399. Thus, the user will be provided with a display of final results and metrics for the current exercise routine in comparison to prior history.

### E. Sharing Games Using Personal A/V Apparatus

The personal A/V system can be used to help users create and organize new games. For example, the personal A/V system can help distribute rules and indications of boundaries, record game state, and push out new rules. This push would be to other users also wearing the system. Or if one user had a system and you were on a instrumented court you might be able to use a depth sensor or other sensors so that not everyone would need a HMD.

One embodiment includes a method for presenting a game, comprising: creating rules for a game; identifying boundaries for the game; identifying players for the game; transmitting the rules and boundaries to the players; playing the game; monitoring the boundaries using multiple personal see through A/V devices that each include multiple sensors; and managing/saving game state.

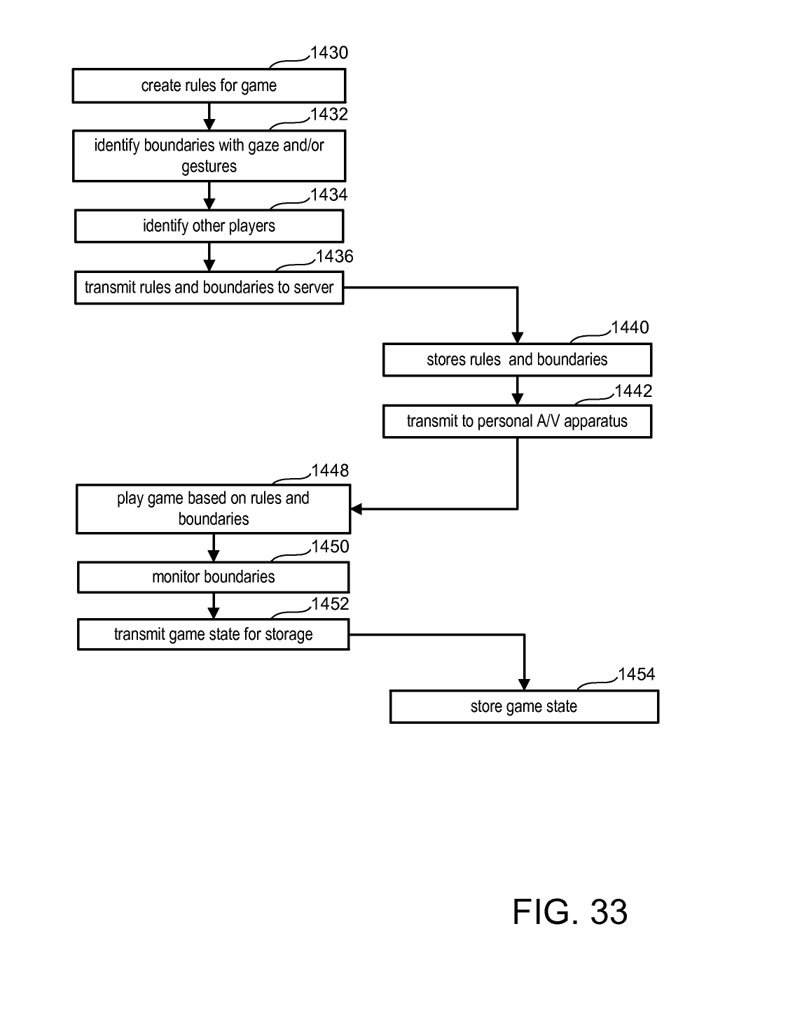

FIG. 33 is a flowchart describing one embodiment of a process for presenting a game using one or more personal A/V devices. The process of FIG. 33 can be performed by using any of the embodiments of FIGS. 22-24. Note that in the flowchart of FIG. 33, the steps on the left side of the flowchart are performed by a personal A/V apparatus 902 and the steps on the right side of the flowchart performed by Supplemental Information Provider 904 and/or Central Control and Information Server 922.

In step 1430, one or more persons will create rules for the game using their personal A/V apparatus. The user can type rules using a keyboard or virtual keyboard, say the rules which will be recorded in an audio file, say the rules which are then converted to text for a text file or use other input apparatus to create a set of rules for a game. In step 1432, the user will indicate boundaries for the game. The boundaries can be identified by monitoring the user's gaze or the user using gestures. By monitoring the gaze, the user can look at a location which is the end point or boundary and say “boundary.” In step 1434, the user can identify other players by saying their names, typing their names, or otherwise selecting the names from a list of friends/family, acquaintances, etc. The rules and boundaries identified above are transmitted to a server in step 1436.

Step 1436 includes a personal A/V apparatus 902 transmitting the rules and boundaries to a Supplemental Information Provider 904 (which then may relay the information to Central Control and Information Server 922). In step 1440, the server will store the rules and boundaries. In step 1442, the rules and boundaries are transmitted to the personal A/V apparatuses for those other players identified in step 1434. In step 1448, after receiving their rules and boundaries, the various players can (optionally) play the game based on the rules and boundaries transmitted to them.

While playing the game, each player's personal A/V apparatus 902 will monitor the player's three dimensional location and the boundaries. If the player comes close to a boundary, the personal A/V apparatus will automatically highlight the boundary by changing its color, pointing to it with an arrow (or other shape), drawing a red line next to it, etc. If the user crosses over the boundary, the personal A/V apparatus 902 will identify the infraction to the player and transmit that infraction to the server (Supplemental Information Provider 904 and/or Central Control and Information Server 922). In step 1452, each personal A/V apparatus 902 will transmit game state for storage to the Supplemental Information Provider 904. In one embodiment, step 1452 is performed continuously or periodically. The game information is stored in step 1454 by the Supplemental Information Provider 904 and/or Central Control and Information Server 922 for future access.

In some embodiment, holographic objects can be specified for use in the game. For example, if there's a virtual jousting game, virtual shields and lances would be required, in addition to the lines designating the area where a player should run.

### F. Virtual Spectator System

An augmented reality system can provide a personalized experience for the user in relation to a sporting event being viewed remote from the event. Consider the situation where a user's sports team has an away game. That is, the game is being played at the other team's stadium. Instead of watching the game on television, the team's home stadium will be open for people to enter with their personal A/V apparatus. People in the home stadium will see the game being played remotely through their personal A/V apparatus, projected on to the field as one or more virtual images. In addition, the user of the personal A/V apparatus will hear the crowd noise and announcer from the game being played remotely. This will provide a more exciting experience, as compared to watching at home on television.

One embodiment includes a method for presenting a customized experience to a user of a personal A/V apparatus, comprising: capturing a video at an away stadium; sensing data at the away stadium; determining three dimensional location of objects at the away stadium using the sensed data; recording crowd noise at the away stadium; recording announcers at the away stadium; transmitting the video, audio and data from the away stadium to multiple personal A/V apparatuses at a home stadium which is remote from the away stadium; determining the three dimensional location of a personal A/V apparatus at the home stadium; determining the orientation of the personal A/V apparatus; determining the gaze of the user operating the personal A/V apparatus; displaying video or animation on the field of the game at the away stadium (as per the user choice between video and animation) through the personal A/V apparatus; accessing a user profile; adding virtual graphic enhancements to the video animation based on the user profile; determining gaze; determine orientation; determine three dimensional location of the personal A/V apparatus; adding virtual advertisements based on the determined three dimensional location of the personal A/V apparatus, orientation of the personal A/V apparatus and determine gaze; playing the crowd noise to the through the personal A/V apparatus; and playing the announcer audio from the away stadium through the personal A/V apparatus.

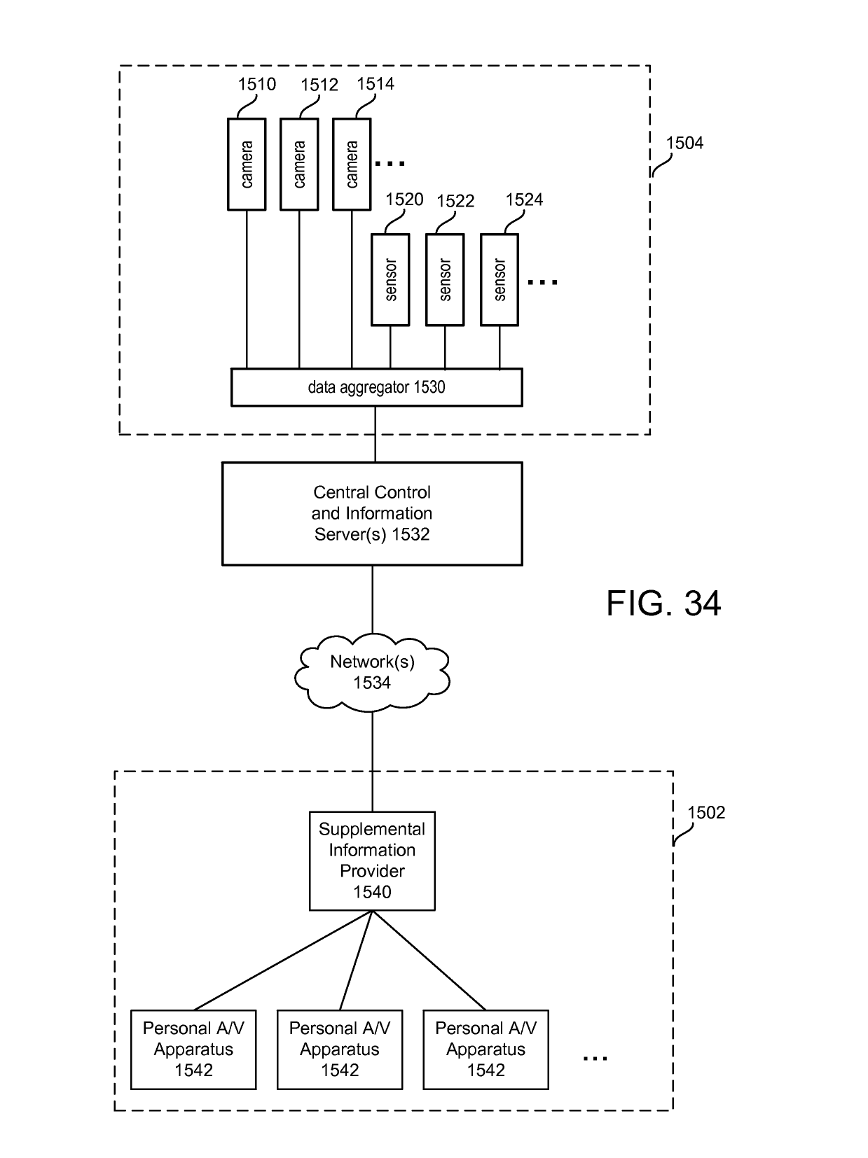

FIG. 34 is a block diagram depicting an example of one embodiment of a system for providing a personalized experience for the user watching a sporting event at the home stadium while the sporting event is being played at the away stadium. FIG. 34 shows equipment at the home stadium 1502 and equipment at the away stadium 1504. At the away stadium 1504 are a set of cameras 1510, 1512, 1514, . . . and a set of sensors 1520, 1522, 1524, . . . . In one embodiment there are multiple cameras to capture video from multiple perspectives of the game. There are multiple sensors for sensing the pan, tilt, zoom, and focal length of the cameras, as well as the location and orientation of the players and objects being used during the game. All this data and video is sent to data aggregator 1530 (one or more servers) which aggregates the data and sends it to Central Control and Information Server 1532. The data is then sent to a Supplemental Information Provider 1540 via one or more networks 1534. In one embodiment, Supplemental Information Provider 1540 is located at the home stadium 1502 and will then wirelessly transmit the data to a set of personal A/V apparatuses 1542 at the event. In one embodiment, there can be thousands of people at the home stadium 1502 using their own personal A/V apparatus 1542, each of which is in communication with Supplemental Information Provider 1540.

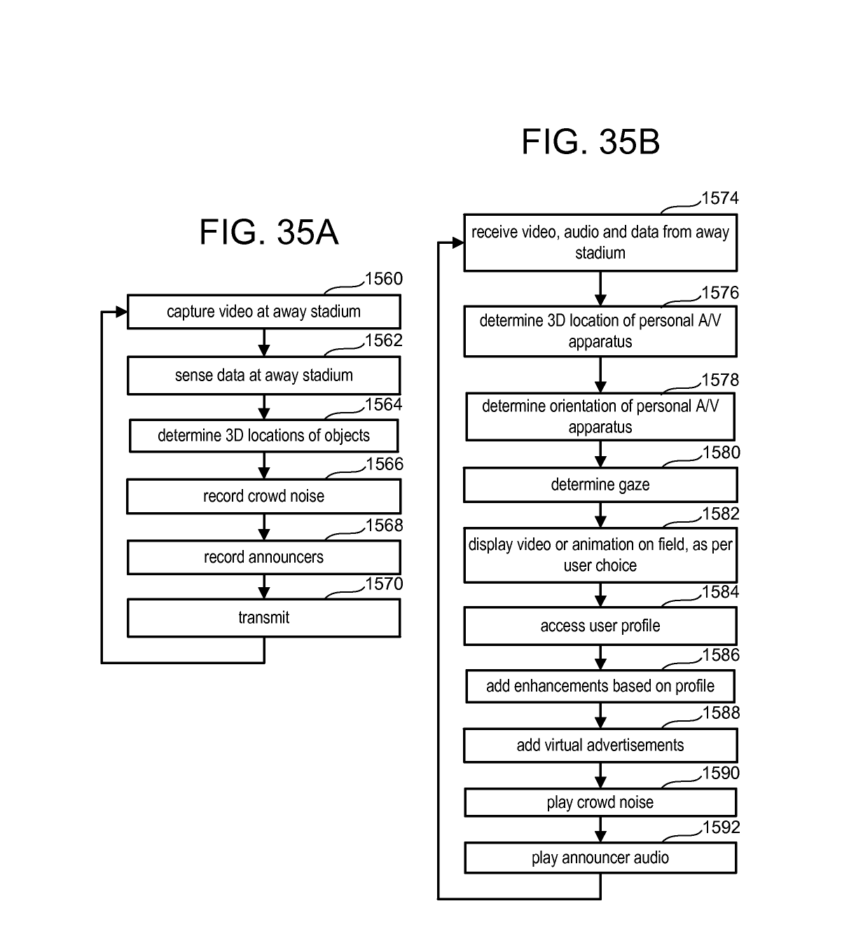

FIG. 35A is a flowchart describing one embodiment of the processes performed by the equipment at away stadium 1504, while the game is being played at away stadium 1504. In step 1560, video is captured at the away stadium. For example, video can be captured at multiple cameras to provide multiple perspectives of the game. In step 1562, data is sensed at the away stadium using the various sensors described above (1520, 1522, 1524, . . . ). In step 1564, data aggregator 1530 will determine the location of one or more moving objects for which the sensors obtained data in step 1562. Example of the sensors include inclinometers, gyros, GPS sensors, radar, IR sensors, etc. In step 1566, crowd noise at the away stadium is recorded. In step 1568, announcers at the away stadium are recorded. In step 1570, the information captured and/or recorded in steps 1560-1568 is transmitted to the various personal A/V apparatuses at the stadium 1502.

FIG. 35B is a flowchart describing the process performed by the various personal A/V apparatus 1542 at the stadium 1502. In step 1574, the personal A/V apparatus 1542 will receive the video, audio, and data from the away stadium. In step 1576, the personal A/V apparatus will determine the three dimensional location of the personal A/V apparatus. In step 1578, the orientation of the personal A/V apparatus is determined. In step 1580, the gaze of the user is determined. In step 1582, actual video or animation of the game at that away stadium is displayed by projecting it onto the field when the user looks through the personal A/V apparatus.

The user can choose to display actual video or animation. An animation can be created by using the data from the sensors that track the movement of the players, objects, balls, etc. and create the animation to show what's happening. A person looking at the field at the home stadium without a personal A/V apparatus will not see anything but an empty field. A person looking through the A/V apparatus will see the field and the video or animation projected onto the field.

In step 1584, the personal A/V apparatus will access the user profile for the particular user. In step 1586, enhancements will be added to the video or animation based on the user profile. For example, various players can be highlighted and/or various portions of the field can be highlighted based on what the user profile indicates the user is interested in. For example, a user's favorite player will be highlighted with a cloud in front of or behind the player. In a football game, the first down line can be graphically depicted. Other enhancements can also be used. The enhancements based on the user profile provides a customized experience for the user. In step 1588, virtual advertisements can be added by superimposing an image of an advertisement on the field or other portion of the stadium. Note that the video displayed in 1582, the enhancements displayed in 1586, and the virtual advertisements displayed in step 1588 are added to the user's field of view based on the three dimensional location of the personal A/V apparatus, the orientation of the personal A/V apparatus and the gaze of the user, as detected and determined above. In step 1590, crowd noise is played to the user. In step 1592, the announcer from the away stadium is played to the user. Note that the processes of FIGS. 35A and 35B are repeated throughout the game. In some embodiments, a person watching a game could hear their different announcer for their team on their headset.

### G. Personal A/V Apparatus For Customizing Purchasing Experience

An augmented reality system can provide a personalized experience for the user while the user is shopping. For example, when the user attempts to buy clothes, the user can use the personal A/V apparatus to see an image of the clothes fitted on the user. If the user is purchasing furniture, the user can be provided with an image of the furniture in the user's home. If the user is purchasing a home, the user can see their furniture in the house they are attempting to buy or lease. In one embodiment, the user and the user's possessions are scanned and represented in a database. When the user shops and identifies an item of interest, images of the item and the user's possessions can be combined to create a personalized experience for the user so that the user can see how the item potentially being purchased is relevant to the user.

One embodiment includes a method for presenting a customized experience to a user of a personal A/V apparatus, comprising: scanning the user and the user's possessions (including home and other possessions) and storing objects in the user profile indicating information about what is scanned; recording purchases of the user and storing information about the purchases as objects in the user profile; connecting a personal A/V apparatus to a local Supplemental Information Provider when a user enters a sales location, selecting an item at the sales location; forwarding the selected item from the personal A/V apparatus to the Supplemental Information Provider; looking up the item in a database to determine relevant objects; identify objects in the user profile that are relevant to a selected item; determining orientation of the personal A/V apparatus; determining gaze of the user; building a graphic combining the select item and the identified objects; and rendering the graphic in the personal A/V apparatus in perspective based on orientation and gaze.

In one embodiment, the shopping experience described herein can be performed using the system of FIG. 24. In addition, hub computing device 12 with capture devices 20A and 20B can also be used, in communication with personal A/V apparatus 902 and Supplemental Information Provider 904, to provide some of the scanning described below. The personal A/V apparatus 902 shown in FIG. 24 is mobile and can be used almost anywhere. Supplemental Information Provider 904 will be situated at a sales location. For purposes of this document, a sales location is the place where an item of interest to be purchased, rented or otherwise acquired is currently located. A sales location could be a store, a showroom, a house that is for sale, a used car lot, etc. Central Control and Information Server 922 can be located in any data center connected to the Internet or other network.

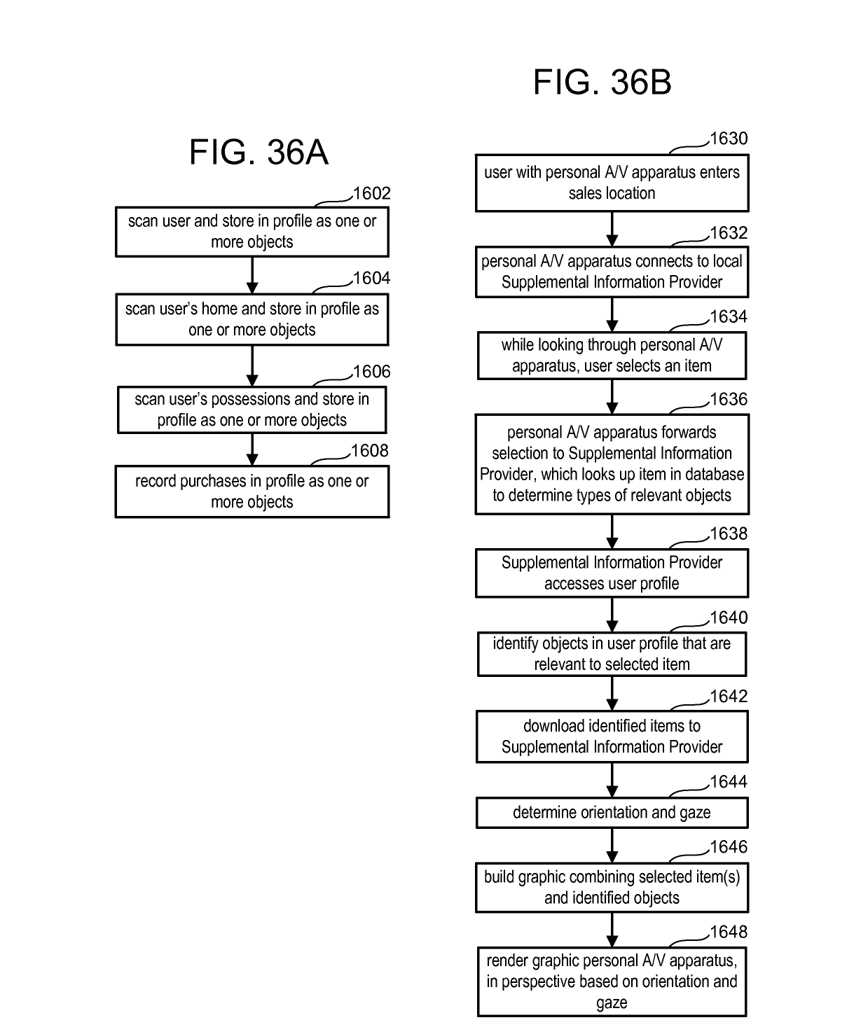

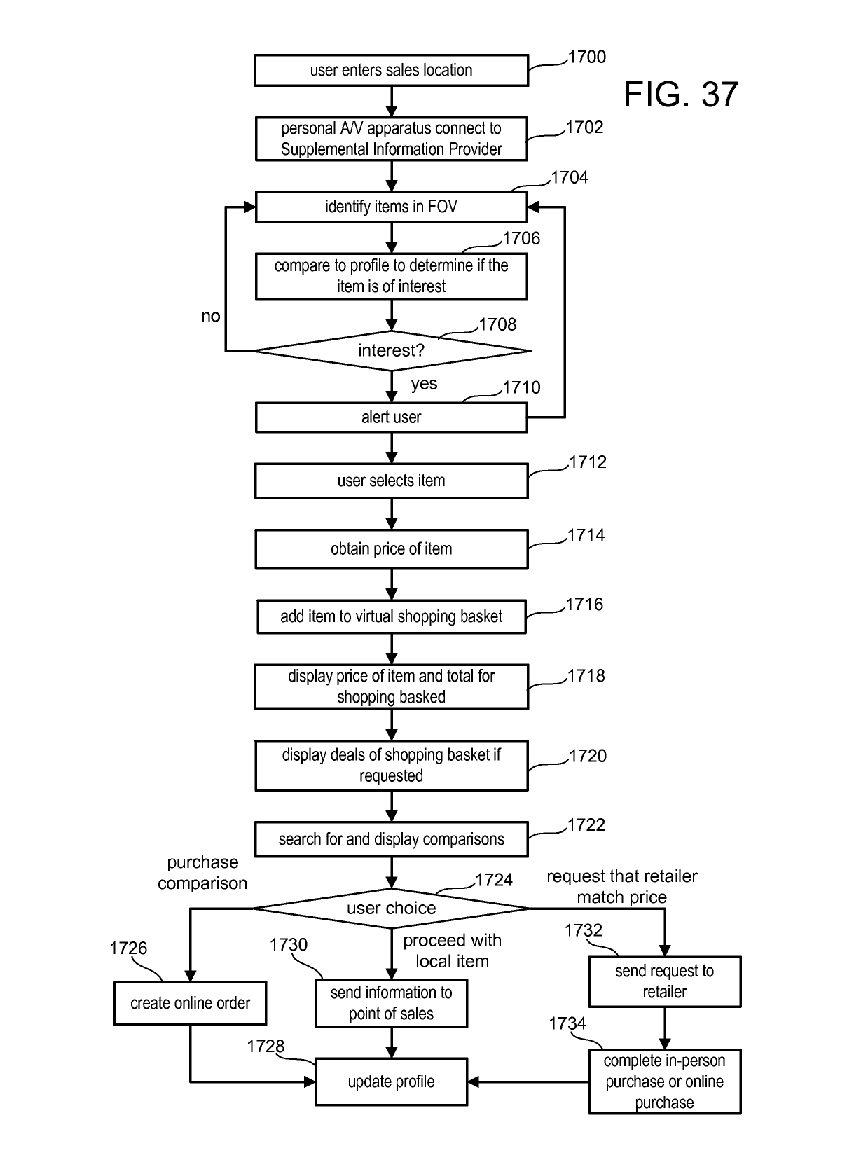

FIGS. 36A and 36B are flowcharts describing one set of processes for providing a customized shopping experience using a personal A/V apparatus. The process of FIG. 36A is used to set up the system so that the personalized shopping experience can be provided when a user enters a sales location. In step 1602 of FIG. 36A, the user will be scanned. Example of scanning a user can include taking still pictures, video images and/or depth images (as described above). The system can also access profile for that user with users previous scan and details. These images can be used to create information about the user's physical appearance. In other embodiments, the user can manually enter in various measurements. The information for the user is stored in the user's profile as one or more objects. In step 1604, the user's home is scanned using still images, video images, depth images. Information about the user's home is stored in the user's profile as one or more objects. In step 1606, the user's possessions are scanned using still images, video images and/or depth images. The information scanned is stored in the user's profile as one or more objects. In step 1608, any purchase the user makes will result in the information about the purchased item being stored in the user's profile as one or more objects. In one embodiment it is not necessary to scan additional purchases because the information about the purchased item will already be in a database of a manufacturer or a retailer, can be loaded from the database into the user's profile. In one embodiment, the user profile is stored by Central Control and Information Server 922 or other servers.

FIG. 36B describes one embodiment of a process for providing the customized shopping experience. In step 1630, a user with a personal A/V apparatus enters a sales location. In step 1632, the personal A/V apparatus connects to a local Supplemental Information Provider. In step 1634, the user will select an item at the sales location while looking through the personal A/V apparatus. In one embodiment, the user can select the item by saying the name of the item, pointing to the item, touching the item, using a gesture, etc. Other means for selecting an item can also be used. Remember that the personal A/V apparatus has a set of microphones, video cameras and depth cameras to sense what the user is selecting.

In step 1636, the personal A/V apparatus will forward the selection to the local Supplemental Information Provider, which is at the sales location. The Supplemental Information Provider will look up the selected item in a database to determine the types of objects that are relevant to that item. In one embodiment, the database is local to the Supplemental Information Provider. In another embodiment, the Supplemental Information Provider will access that database through the Internet or other network (e.g. from Central Control and Information Server 922 or other servers). Each store might have a server or a mall might have a global one

In step 1638, the Supplemental Information Provider will access the user profile. In one embodiment, the user profile is stored at the Central Control and Information Server 922. In step 1640, either Supplemental Information Provider 904 or Central Control and Information Server 922 will identify those objects in the user profile that are relevant to the item based on the information obtained in step 1636. The objects in the user profile that are relevant to the selected item are downloaded in step 1642.

In step 1644, the A/V apparatus will determine its orientation using the sensors described above. The A/V apparatus will also determine the gaze of the user, as described above. In step 1646, the personal A/V apparatus, or the Supplemental Information Provider 904, will build a graphic that combines images of the selected item and the identified objects from the user profile. In one embodiment, only one item is selected. In other embodiments, multiple items can be selected and the graphic could include the multiple items as well as the multiple identified objects. In step 1648, the graphic that combines the images of the selected items and the identified objects is rendered in the personal A/V apparatus, in perspective based on the determined orientation and gaze. In some embodiments, the graphic will only include the objects. Rather, the user will see through the personal A/V apparatus to view the selected item and the objects will be added to the field of view of the user. In another embodiment, the user can view the objects directly and the personal A/V apparatus will build and render a graphic of the select item and place that in perspective within the user's field of view in relation to the viewed objects that are directly viewed through the personal A/V apparatus.

One example implementation of the process of FIG. 36B includes a user viewing a home for sale. The selected item may be one of the rooms in the home or maybe the home itself. The objects from the user's profile will be the user's furniture. When the user walks through the home (which presumably is empty), the user's furniture (the user's objects in the user profile) will be projected in the personal A/V apparatus so that the user will see the user's furniture in the home.

Another example implementation of FIG. 36B includes the user visiting a furniture store. The selected items can be one or more pieces of furniture. The objects obtained from the user's profile will be the rooms in the user's house and furniture in the user's house. For example, if the user is shopping for a couch, the selected item may be one or more couches. The personal A/V apparatus will depict an image of the user's living room with the selected couch projected in that living so the user can see what the couch would look like.

Another embodiment, the system can be used to enhance shopping for clothing. When a user sees an item of clothing the user is interested in, the personal A/V system can project an image of the user wearing that item. Alternatively, the user can look in a mirror to see the himself/herself. In that case, the personal A/V system will project an image of the article of clothing on the user in the reflection of the mirror. These examples show how a user can look through a see-through personal A/V apparatus, and images can be projected in the user's field of view such that these projected images combined with the real world viewed through the personal A/V apparatus create a personalized experience for the user.

In another embodiment, the system is used to customize in-store displays based on what a user is interested in. For example, the window models all switch out to be wearing the items that a user interested in. Consider the example where a user is shopping for a black dress so every store she walks by has all black desses painted virtually onto the mannequins in their front displays or on their storefront dedicated to a head mounted display presentation.

### H. Personal A/V Apparatus With Holographic File Format

Many of the embodiments described herein include storing data about a user, objects and places. This data is then used to augment reality when looking through a personal A/V apparatus. To allow for the efficient storage of such data and exchange of such data, it is contemplated to have a predetermined standard format for storing that data. This format is referred to as the Holographic File Format. Use of the Holographic File Format will allow for portability of data between platforms, compressing the data, use of smart objects, and facilitating virtual representation of real world objects.

One embodiment includes the method for presenting a customized experience to a user of a personal A/V apparatus, comprising: scanning a plurality of items to create a plurality of objects in a Holographic File Format with one object created for each item, the Holographic File Format having a predetermined structure; storing the objects in the Holographic File Format for an identity; connecting a personal A/V apparatus to a local server using a wireless connection; providing the identity from the personal A/V apparatus to the local server; using the identity to access and download at least a subset of the objects to the local server; accessing data in the objects based on the predetermined structure of the Holographic File Format; and using the data to add a virtual graphic to a see-through display of the personal A/V apparatus.

One example implementation of the Holographic File Format can be used with respect to the processes of FIGS. 36A and 36B. In the method of FIG. 36A, the user, the user's home and the user's possessions are scanned and information from the scanning is stored in the user's profile as one or more objects. In one implementation, the information is stored in the profile in the Holographic File Format as one or more objects. This way, when the user enters a sales location and the associated Supplemental Information Provider local at the sales location accesses objects in the database, those objects will be accessed in the Holographic File Format. In this way, the Supplemental Information Provider will have prior knowledge of the format of the objects so that the objects can be efficiently used. The use of this Holographic File Format will allow developers to more easily create systems and platforms that can make use of these data so that more experiences can be customized using the personal A/V apparatus.

### I. Personal A/V Apparatus For Customizing Fulfillment

An augmented reality system can provide a customized shopping experience for a user of a personal A/V apparatus. For example, as a user is shopping, the personal A/V apparatus can be used to maintain a virtual shopping basket of all the items the user is interested in. This virtual shopping basket can indicate the total cost of all items, price of an individual item and/or details about any of the items in the shopping basket. Additionally, as the user is shopping, the personal A/V apparatus can highlight items that user is looking at that meet certain criteria such as being on sale, the correct size of the user or user's family/friends, fulfills a user-identified need, etc. Additionally, the personal A/V device can be used to do price comparison with other stores, provide a means for the user to request that a retailer offer a better price or match another store, or provide a means for purchasing the item in a cheaper manner.

One embodiment includes a method for presenting a customized experience to a user of a personal A/V apparatus, comprising: connecting a personal A/V apparatus to a server at a local sales location upon entering the sales location; identifying items in the field of view of the user using the personal A/V apparatus; comparing the items identified to a profile to determine if any of the items are of interest to the user; highlighting any of the items that are of interest to the user; obtaining a price of an item that the user has selected; adding a selected item to a virtual shopping basket; maintaining a total price for all items in the virtual shopping basket; displaying the total price for the shopping basket and details of the shopping basket if requested by the user; searching and displaying comparisons to the user; allowing the user to purchase online one of the items displayed as a comparison; requesting that the retailer match the price of a comparison; and sending information to a point of sales at the local sales location to facilitate purchase of the item for the user.

FIG. 37 is a flowchart describing one embodiment of a process for presenting customized shopping experience to a user of a personal A/V apparatus. In step 1700, the user will enter the sales location. In one embodiment, the user is wearing the personal A/V apparatus or otherwise in possession of the personal A/V apparatus. In step 1702, the personal A/V apparatus will connect to the Supplemental Information Provider upon the user entering the sales location. In one embodiment, Supplemental Information Provider includes one or more servers located at the sales location. The remainder of the steps of FIG. 37 are performed by a combination of personal A/V apparatus 902, Supplemental Information Provider 904 and/or Central Control and Information Server 922 of FIG. 24. In other embodiments, the structure of FIG. 22 can be used to implement the process of FIG. 37.

In step 1704, the system will identify items in the field of view of the user. As explained above, the personal A/V apparatus is a see-through display. Therefore, the user will see through the personal A/V apparatus and see a number of items at the sales location. The personal A/V apparatus includes one or more cameras (video cameras, still cameras, depth cameras, etc.) that will obtain images or information about what the user is looking at. In one embodiment, the system will also determine the gaze of the user to identify what the user is looking at. The personal A/V apparatus can use that information to determine and identify all the items in the field of view of the user. In other embodiments, the data from the personal A/V apparatus will be provided to the Supplemental Information Provider or Central Control and Information Server to determine all the items in the field of view of the user.

In step 1706, each of the items in the field of view of the user are compared to the user's profile. In one embodiment, the user will have a profile that indicates what items may be of interest. The user may indicate that anything on sale is of interest. Alternatively, the user may provide specific criteria about types of items of interest such as sizes for clothing or items that provide certain functions that are needed by the user (e.g. winter coat, bathing suit for upcoming vacation, etc.). If any of the items match the criteria in the user's profile (step 1708), then the user is alerted in step 1710. One example of step 1710 include displaying a pop up bubble, balloon, or other shape that points to or otherwise highlights the item and indicates why it of interest (e.g. on sale, fits you, for your upcoming vacation, etc.). After alerting the user, the process will return to step 1704. If there were no items in the field of view that are of interest to the user, the process (after step 1708) will continue with step 1704. That is, steps 1704-1710 will continually be performed as the user walks through a sales location.

If, at any time while the user is at the sales location, the user selects an item, step 1712 will be performed. The user can select an item by saying name of the item (captured by the microphone in the personal A/V apparatus), pointing to an item, using a gesture at an item, touching an item, or using another indication to select an item. No particular type of selection mechanism is required. In step 1714, the system will obtain a price for that item. In one embodiment, personal A/V apparatus 902 will indicate to Supplemental Information Provider 904 the item selected. Supplemental Information Provider 904 may include all the prices for all the items in the sales location. Alternatively, Supplemental Information Provider 904 can access a central database at Central Control and Information Server 922 for the price. After paying the price, the system will add the item to a virtual shopping basket in step 1716. In one embodiment, the virtual shopping basket is a list of items that have been selected, the price for each item, a description of each item, and a total for all items in the basket. In step 1718, the price of the newly selected item will be displayed to the user within the see-through display of personal A/V apparatus. Additionally, the total for all items in the basket will be updated and displayed. If requested, the personal A/V apparatus can also display all the details (quantity, description, price) of all the items in the shopping basket in step 1720.

In step 1722, the system will search for and display comparison prices. For example, Supplemental Information Provider 904 can access various databases online (e.g. via the Internet or private databases) for other entities that are selling the same product at different prices. The various comparison prices will be displayed in step 1722. At that point the user has a choice. One option is the user can purchase the comparison product using the personal A/V at one of the comparison prices. That is user can choose the lower price product depicted in step 1722. In that case, an online order will be created by the personal A/V apparatus in step 1726 and the user purchase will then be performed online. After creating the online order, the user's profile will be updated in step 1728 to indicate the purchase. For example, if the profile shows a need for an item, that need can now be fulfilled. Alternatively, the system may keep a running history of all purchases, as described above. Another alternative is for user to proceed purchasing the item at the sales location that the user is currently at. In one embodiment, the system will send information for the items (one or more items of the shopping basket) to a point of sales location in step 1730. For example, the cash register for checking out can be populated with all the information for the sale. Alternatively, the user's credit card can be provided and the sale can be commenced electronically.

After completing the local sale, the user's profile is updated in step 1728. In another embodiment, if one of the comparison prices displayed in step 1722 is lower than the price at the current sales location, the system can send a request to the retailer associated with the current sales location to match the price online in step 1732. If the price is matched or beaten, the user may complete the purchase through the retailer by doing an in-person purchase at the sales location or performing the purchase online. In either case, the user's profile will be updated in step 1728 after completing the purchase.

### J. Personal A/V Apparatus For Smart Resource Use

A system with a personal A/V apparatus can provide a personalized experience when maintaining and using food inventories. For example, the personal A/V apparatus, and the system supporting the personal A/V apparatus, can be used to automatically generate and maintain shopping lists, automatically identify recipes that can be implemented using ingredients on hand and automatically develop menus for upcoming occasions (including managing the ingredients for those menus). The lists andrecipes can be automatically shared with friends, relatives and/or employees of the user.

One embodiment includes setting up a food profile with identification of items to be maintained on hand, quantities required and locations of storage. As the user of a personal A/V apparatus moves throughout the user's house (or other location) the personal A/V apparatus will be used to capture video (or still images or depth images) of what the user is seeing, determine the location of the user (in the personal A/V apparatus), determine the orientation of the personal A/V apparatus and determine the gaze of the user. Based on that information (or a subset of that information), the personal A/V apparatus will access food profile for the user. In one embodiment, the system will only access the food profile for the location that the user is currently in. Based on detecting what food items are in stock in the user's home and what food items are required by the food profile, missing items will automatically be added to a shopping list. The user will be provided the opportunity to place an order online for those missing items. In conjunction with the food profile, the system will maintain a food inventory which indicates which food items are on premises. The food inventory can be updated when the user orders or purchases items. Additionally, when the user views various storage locations the personal A/V apparatus can detect what food items are in stock. Based on the information in the food inventory, the personal A/V apparatus, and its accompanying support service, it can be used to automatically determine what recipes can be fulfilled using items on hand.

In one embodiment, the system for providing automated shopping lists, automated recipes and automatic menus will make use of the system of FIG. 22. In other embodiments, the system of FIG. 24 can also be used.

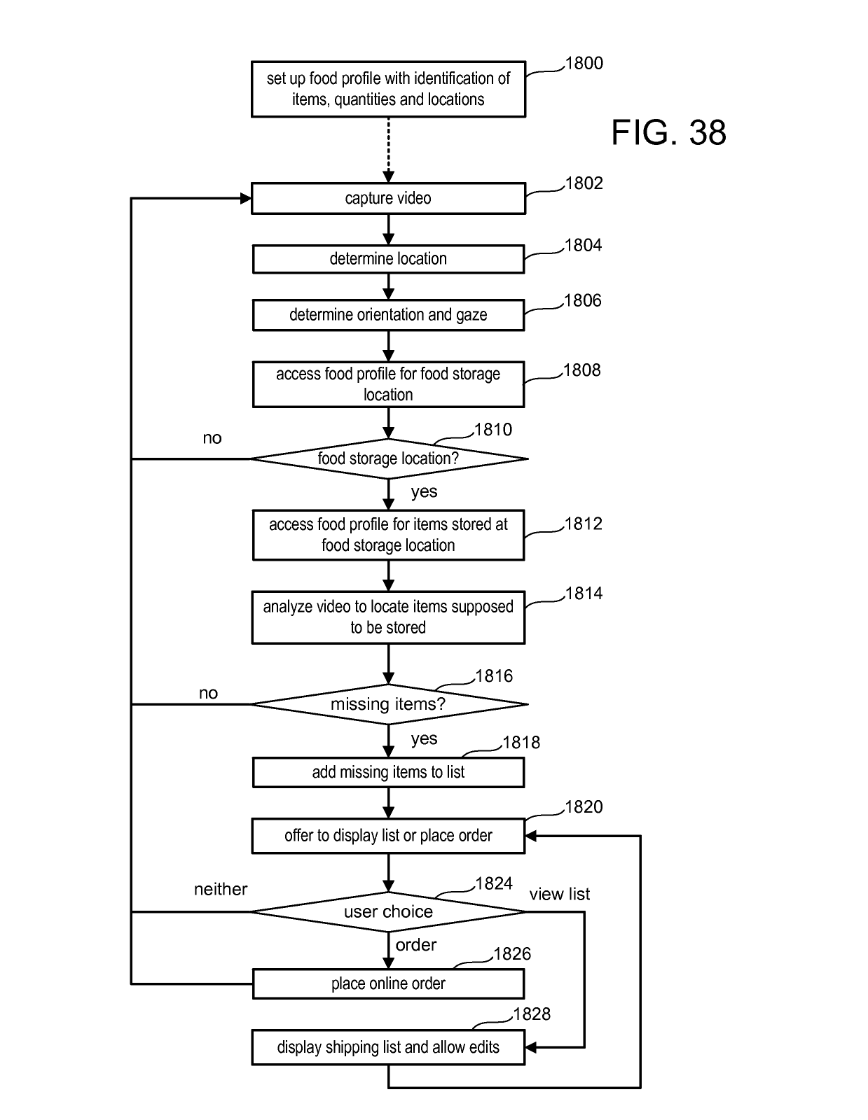

FIG. 38 is a flowchart describing one embodiment of a process for automatically generating shopping lists. In step 1800, a user will set up a food profile. In one embodiment, the profile indicates an identification of all items a user wishes to maintain on premises. For each of those items listed in the food profile, there will be an indication of a quantity of each item required and the location for storing the item. For example, the food profile may indicate that two quarts of milk should be stored in the refrigerator and three loaves of bread should be stored in the pantry. In one example implementation, the food profile is created manually using a keyboard and mouse. In another embodiment, the food profile can be performed using the personal A/V apparatus described above by talking and using speech to text, by using hand gestures, by choosing items in a menu, etc. FIG. 38 shows a dotted line between steps 1800 and 1802 to indicate that an unpredictable may exist between these two steps.

As the user moves around, while wearing or otherwise possessing the personal A/V apparatus, the personal A/V apparatus will capture video (and/or still images and/or depth images) of the user's surroundings. In one embodiment, the video captured is a video of the field of view of the user. In step 1804, the personal A/V apparatus will determine the location of the personal A/V apparatus, as discussed above. In step 1806, the personal A/V apparatus will determine its orientation. In addition, the personal A/V apparatus will determine the gaze of the user, as described above. In step 1808, the personal A/V apparatus will access the food profile of the current food storage location.

In step 1804, the system determines the location of the user. If that location is one or more of the food storage locations mentioned in the user's food profile, then the system will identify all the ingredients in the food profile that should be stored at the food storage location that the user is currently in. If the user is not in a food storage location (step 1810) then the process moves back to step 1802. If the user is in a storage location (step 1810), then the system will access the food profile to access all items that are supposed to be stored at the current food storage location that the user is in (step 1812). The personal A/V system (in conjunction with Supplemental Information Provider or Central Control and Information Server) will analyze the video captured in step 1802 to determine whether all the items that are supposed to be at the current location are actually stored at the current location. If there are no missing items (step 1816), then the process moves back to step 1802. If there are items missing from the current storage location, that are in the food profile, then the missing items can be added to a shopping list in step 1818.

In one embodiment, a shopping list is stored on the personal A/V apparatus. In other embodiments, the shopping list can be stored at the Supplemental Information Provider. The shopping list can indicate an identification of the item, a description of the item, quantity to purchase. In step 1820, the personal A/V apparatus can offer to display the list or place an order for the items on the list. In step 1824, the personal A/V apparatus will receive a choice from the user, using any of the means described above. If the user chooses to order the items on the list, then the system will place an online order for the missing food items from step 1826, and the process will continue at step 1802. If the user requested to view the shopping list, then in step 1828, the personal A/V apparatus will display the shopping list through the display of the personal A/V apparatus. The personal A/V apparatus will also allow the user to edit the list. After step 1828, the process loops back to step 1820. If the user chose not to view the list or not to order the items, then the process (at step 1824) will loop back to step 1802.

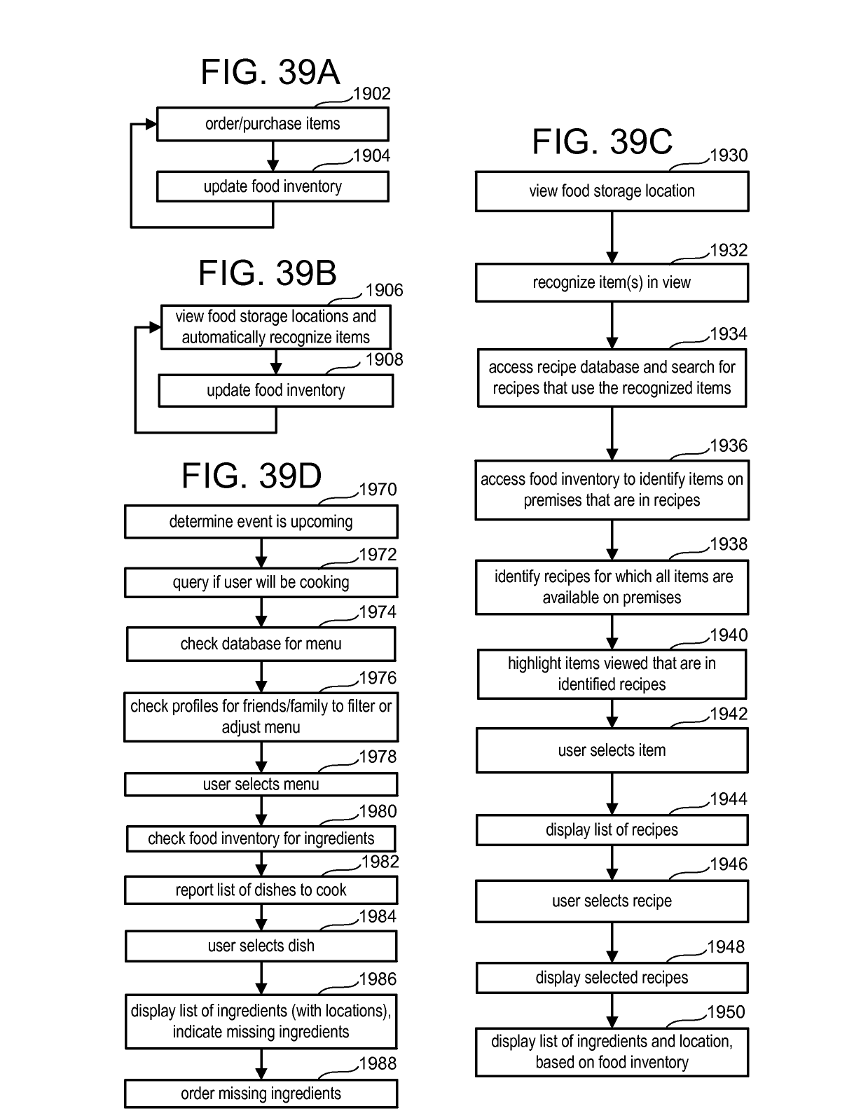

FIG. 38 made use of a food profile for the user. In one embodiment, the system will also include a food inventory. The food inventory will list all the items in the food profile and indicate how many of each item is currently in stock at the user's food storage locations. FIGS. 39A and 39B are flowcharts describing a process for maintaining the food inventory. In step 1902 of FIG. 39A, as the user orders or otherwise purchases food items, the food inventory will be updated to indicate the new quantity of the food item in step 1904.

As the user moves around the user's various food storage locations, the personal A/V apparatus will view these food storage locations (in step 1906 of FIG. 39B) and capture still, video and/or depth images of the food storage locations. As the personal A/V apparatus views images of food storage locations, it will automatically recognize items on the food inventory using one or more image recognition processes in conjunction with knowing its three dimensional location and orientation. In step 1908, the food inventory will be updated based on recognizing any items to be in stock in the user's food storage location. The food inventory can be stored at or by the personal A/V apparatus and/or the Supplemental Information Provider.

FIG. 39C is a flowchart describing one embodiment for automatically determining recipes that can be implemented using food items on hand. The process of FIG. 39C relies on the food inventory discussed above. In step 1930 of FIG. 39C, the user will move around the user's various food storage locations and the personal A/V apparatus will view the locations within the field of view of the user. The personal A/V apparatus can capture one or more still, video and/or depth images. In step 1932, the personal A/V apparatus will recognize one or more items in view using any of various image recognition techniques known in the art. The personal A/V apparatus can also make use of knowing its three dimensional location and orientation.

In step 1934, the personal A/V apparatus will access a recipe database stored on Supplemental Information Provider or Central Control and Information Servers. Upon accessing the database of recipes, the system will search for all recipes that use the items recognized in step 1932. In step 1936, the system will access the food inventory for the user to identify all items that are on premises for that user and that are in recipes identified in step 1934. In step 1938, the system will identify those recipes for which all items needed by the recipe are available on premises and at least one item was recognized in step 1932.

In step 1940, those items in the field of view of the user (determined based on the determining the user's gaze) that are required by the recipes identified in step 1938 will be highlighted in the user's field of view. One example of highlighting can be to draw an arrow (or other shape) pointing to the item, changing the color of the item, putting a graphic behind the item or putting a graphic in front of the item. The graphic added to the user's field of view will be added to the display of the personal A/V system, as described above. In step 1942, the user will select one of the items that are highlighted. In step 1944, a list of recipes will be displayed to the user in the personal A/V apparatus. Each of the recipes on the list are those recipes identified in step 1938 that use the selected item. In step 1946, the user will select one of the recipes listed from step 1944. In step 1948, the selected recipe is displayed to the user within the personal A/V apparatus. In step 1950, the list of ingredients for the displayed recipe will all be displayed within the personal AV apparatus. In one embodiment, the personal A/V apparatus will also indicate the location of each ingredient. The listing of the ingredients and location can be based on information in the food inventory.

FIG. 39 is a flowchart describing one embodiment of a process for automatically creating a menu for an upcoming event using a personal A/V apparatus. In step 1930, the system will determine whether an event is coming up. For example, Supplemental Information Provider 904, personal A/V apparatus 902 or any of the users' computing devices can be monitoring one or more calendars to determine that a holiday is approaching, a birthday is approaching or the special family event marked on the calendar is approaching. In step 1972, the user will be provided with a query asking if the user will be cooking for this holiday or special event. For example, the question can be presented using text in the display for the personal A/V apparatus or an audio question can be posed to the user. If the user is not cooking, the rest of the process of FIG. 39D will not be performed.

If the user is cooking, then in step 1974, the system will check a database of menus. This database will have a set of menus and a set of indicators which show which holidays or special occasions each menu is for. Step 1974 will include identifying a subset of the menus in the database that are appropriate for the upcoming holiday or special event. In step 1976, the system will check profiles for family and friends to determine if there is any indication in any of the profiles for meals or dishes that these people like or dislike. The menus determined in 1974 will be filtered to remove meals or dishes that are disliked by the user, the user's friends and/or the user's family. In one embodiment the filtering is only done for those friends and family who will be attending the event, as indicated by the calendar entry in the user's calendar. In step 1978, the resulting set of menus are displayed and the user will select one of the menus.

In step 1980, the system will check the food inventory for all the ingredients in the selected menu. In step 1982, the system will report a list of all the dishes that need to be cooked. These listed dishes will be displayed in the personal A/V apparatus. In step 1984, the user will select one of the dishes using any of the selection means described above. In step 1986, all of the ingredients of the selected dish will be displayed. Next to each ingredient will be an indication of the location that the ingredient is stored in. The location is obtained from the food inventory discussed above. Additionally, for each of the ingredients listed that the user is not in possession of, there will be an indication that this ingredient is missing. For example, an asterisk can be next to the ingredient or the word “NEEDED” can be displayed next to the ingredient. Other symbols can also be used. In step 1988, the system order the missing ingredients from an online service or local store that delivers. The ordering of the missing ingredients can be performed automatically or manually (in response to a user affirmation) from an online seller.

### K. Personal A/V System Providing Allergy Awareness

The personal A/V apparatus can also be used to provide the user with awareness of food restrictions (e.g., food allergies, diets, etc.). For example, when looking at a food item that the user (or family/friend) is allergic to, the personal A/V apparatus can warn the user of the allergy or prevent the user from seeing the item so that the user does not purchase or eat it. When choosing menus or dishes, the personal A/V device can also make sure that the user is only offered food items that map into the user's dietary requirements.

One embodiment includes a customized method for determining and reacting to allergies and dietary restrictions, comprising: recognizing one or more items in view of a personal A/V apparatus; checking a food profile to see if there is a food restriction associated with the items in view; if there are no other restrictions, allowing access to the item; if there are restrictions, skipping the item from being used in a current activity (such as being viewed, used in a recipe, eaten, etc.).

In one embodiment, the user's food profile (discussed above) will include information about food restrictions for the user, user's family and/or user's friends. Food restrictions could include foods that user is allergic to. Food restrictions can also include foods that the user doesn't want to eat because the user is on a diet. Other reasons can be used to make a food restricted. User should be able to swap on and off this warning.

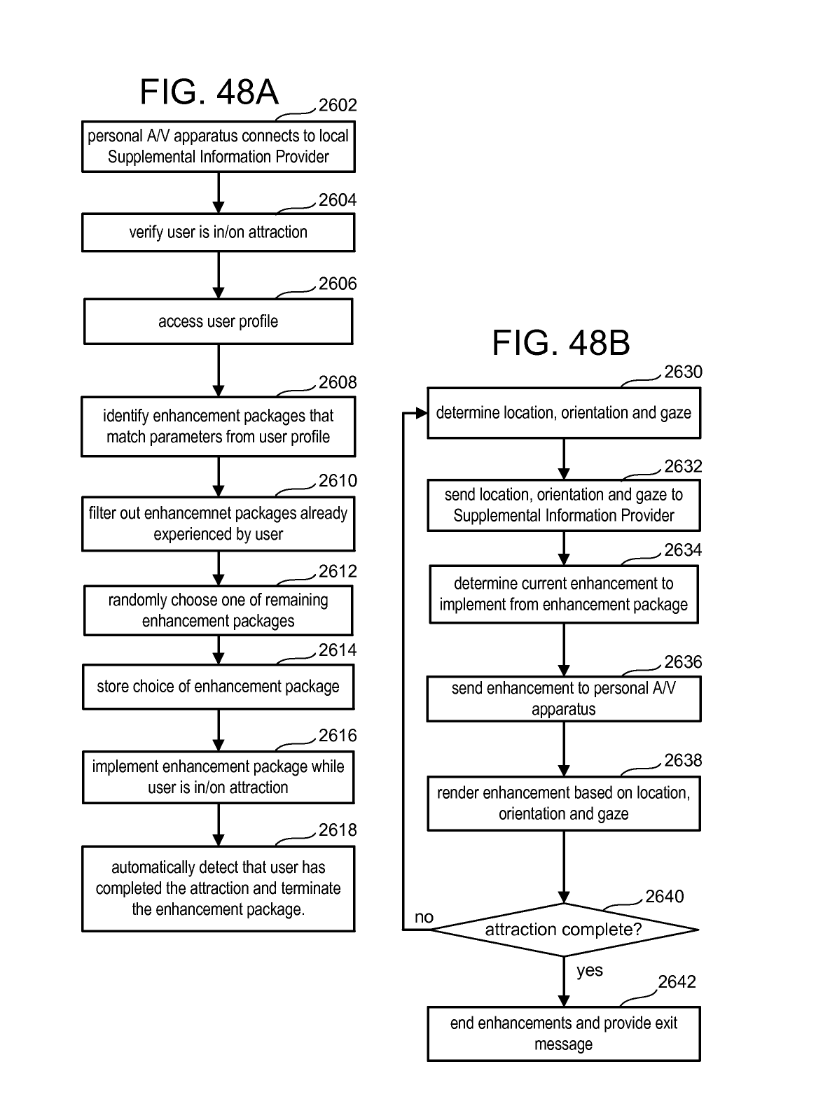

FIG. 48 is a flowchart describing one embodiment of a method for keeping a food profile updated with respect to food restrictions. In step 2002, the food profile is manually updated to indicate food restrictions for the user, the user's family and/or friends. In one example implementation, the user will use a keyboard of a computer, laptop, PDA, etc. to manually enter in data (allergies, diets, etc.) into the user's food profile. In other embodiments, the user can talk into a microphone for a personal A/V apparatus or other computing device. In other embodiments, the user can use other input devices to enter information. In step 2004, the food profile is automatically updated to indicate food restrictions for the user, family and/or friends based on doctor reports. For example, if a doctor determines that a user is allergic to a particular food item, that information can be automatically added to the user's food profile. In one example implementation, doctor reports can be provided to the system (Supplemental Information Provider and/or Central Control and Information Server) that keeps track of user profiles.

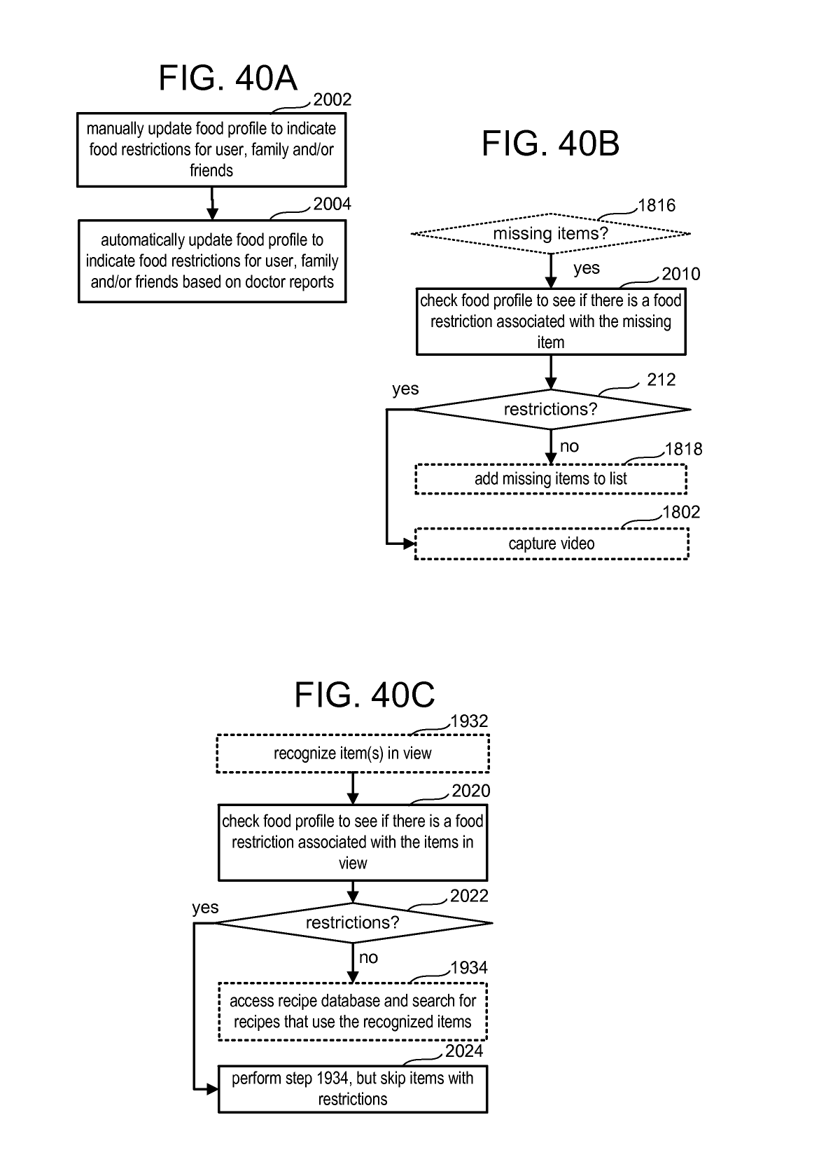

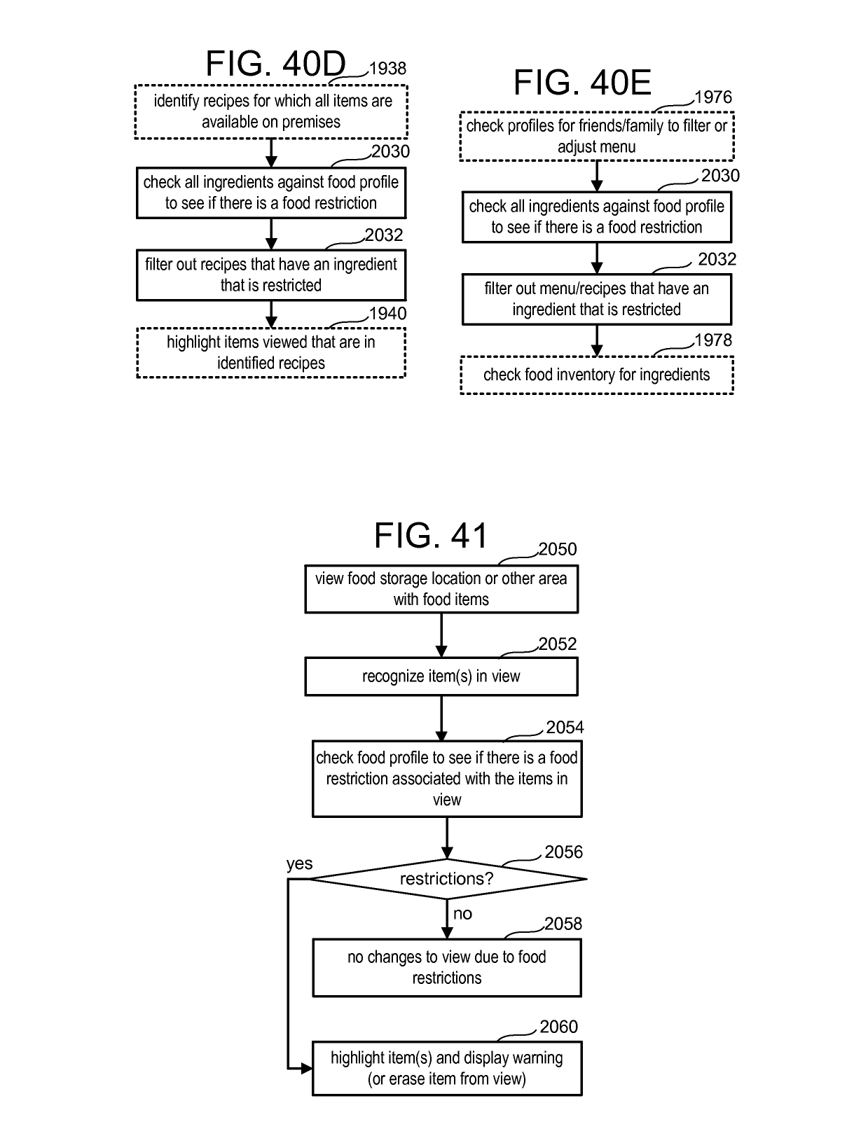

FIG. 38, as discussed above, provides a method for automatically creating shopping lists. FIG. 40B shows a modification to the method of FIG. 38 to include accounting for food restrictions. Note that the steps of FIG. 38 are shown in FIG. 40B with dotted lines. The new steps are shown with solid lines. After step 1816 of FIG. 38, the system can perform step 2010, which includes checking the food profile in the user profile to see if there is a food restriction associated with the item that is missing. For example, looking back at FIG. 38, the system is adding missing items to a shopping list. FIG. 40B adds in new step 2010 that (before adding the item to the list) determines if there is a food restriction. If there is no restriction (step 212), then the missing item is added to the list in step 1818 of FIG. 38. If there is a food restriction found (step 212), then the missing item is not added to the shopping list instead, the process of FIG. 38 will loop back to step 1802 without performing step 1818.

FIG. 39C, described above, depicts a process for automatically discovering recipes that can be made with food items on hand. FIG. 40C shows a modification to the process of FIG. 39C, which accounts for food restrictions. Step 1932 of FIG. 39C includes recognizing an item. The process of FIG. 39C will then use that item recognized to identify recipes. Before identifying the recipes, the process (enhancement) of FIG. 40C will check the food profile to see if there is a food restriction associated with the items that were recognized in step 1932. If there were no food restrictions found, then the process will continue with step 1934, as described with respect to FIG. 39C. However, if step 2020 found a food restriction (step 2022), then step 1934 will skip the item that has a food restriction. That is, step 1934 will be performed; however, any food item that has a restriction will not be used to access recipes. The process will then continue (after performing step 1934) with step 1936.

FIG. 40D describes another change to the process of FIG. 39C to account for food restrictions. Step 1938 of FIG. 39C includes identifying all recipes for which all items are available on premises. After step 1938, step 2030 of FIG. 40D will include checking all ingredients of all the recipes identified at step 1938 against the food profile to see if any of the ingredients in any of the recipes has a food restriction. In step 2032, the recipes will be filtered such that any recipe having an ingredient that has a food restriction will be removed from the list of recipes. The process will then continue with step 1940.

FIG. 39D (described above) illustrates a process for identifying appropriate menus. In step 1976 of FIG. 39D, the system will check profiles of family and friends to filter out or adjust the menus previous identified. After filtering based on the likes of family and friends, step 2030 of FIG. 40E will include checking all the ingredients in all the menus that survived the previous filtering to determine whether any of the ingredients have a food restriction. In step 2032, any menu or recipe that has a food item with a food restriction will be filtered out of the list. The process will then continue with step 1978, as discussed above.

FIG. 41 is a flowchart describing one embodiment of a process that includes accounting for food restrictions when the user is looking at food items through the personal A/V apparatus. In step 2050, the user will view a food storage location or other area that has food items in it. For example, the user could be looking at food in a supermarket or other type of store. In step 2052, the personal A/V apparatus (in conjunction with one or more other servers) will recognize the items in the field of view of the user, as described above. In step 2054, the system will check each of the items recognized against the food profile to see if any of the food items are associated with a food restriction. For example, personal A/V apparatus 902 of FIG. 24 can access Central Control and Information Server 922 to determine whether the user profile indicates that any of the items recognized have a food allergy or dietary restriction associated with them. If none of the food items have a food restriction associated with them (step 2056), then no changes are made to the view due to food restrictions (step 2058). If any of the food items recognized are associated with a food restriction, then the system can do one of two things in step 2060. In one alternative, the system could highlight the items that have a food restriction and graphically indicate what the restriction is. For example, a pointer can point to a food item and say that the user has an allergy or that that particular food item is not part of the user's diet. Alternatively, the item for which there is a food restriction can be erased from the view. There are many methods for erasing images from a view. In one embodiment, an image can be erased by placing another graphic image in front of it. The graphic placed in front could include an image of another item or an approximation of the view behind the item.

### L. Group Souring Using Personal A/V System

The personal A/V apparatus can also be used to perform crowd sourcing in order to obtain group discounts on purchasing items. For example, a user of a personal A/V apparatus who sees an item for sale, can obtain information through the personal A/V apparatus, can obtain confirmation from other people who want to buy the same device, and use the power of the group purchase in order to get a reduced price.

One embodiment includes a method for using a personal A/V apparatus to aggregate purchasing, comprising viewing an item through a personal A/V apparatus; automatically recognizing the item using the personal A/V apparatus; automatically obtaining pricing information; automatically aggregating demand from other users of personal A/V devices through communication through personal A/V devices; and providing an offer to purchase an item at a reduced price based on the sale of multiple items to the group.

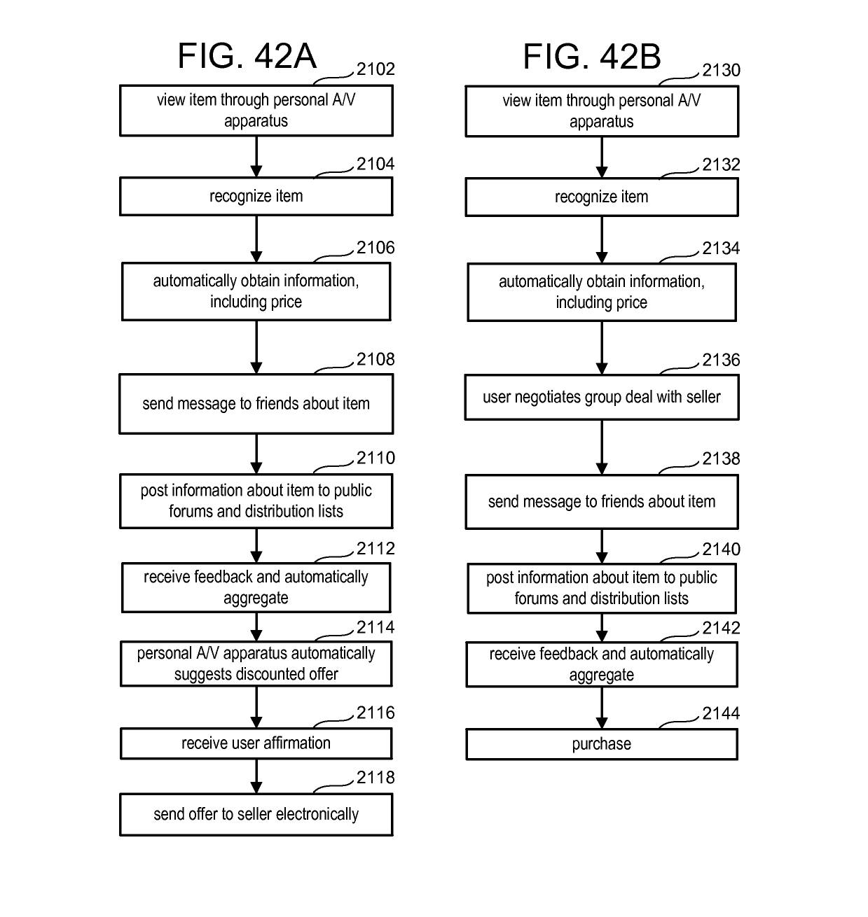

FIG. 42A is a flowchart describing one embodiment of a method for using personal A/V devices to organize group purchasing. In step 2102, a user is viewing an item for sale through the personal A/V apparatus. In step 2104, the personal A/V apparatus will recognize the item using one or more image recognition techniques known in the art. In one embodiment, personal A/V apparatus will communicate with another server to perform the recognition. For example, the structure of FIG. 22 or 24 can be implemented. In such an embodiment, personal A/V apparatus 902 will communicate with Supplemental Information Provider 904 and/or Central Control and Information Server 922 in order to recognize the item. For example, an image can be transmitted from personal A/V apparatus 902 to Supplemental Information Provider 904 in order for the item to be recognized by Supplemental Information Provider 904 using image recognition software. In step 2106, the system will obtain pricing information automatically. For example, once the item is recognized, a database can be accessed on Central Control and Information Server 922 to obtain a description and price.

In step 2108, a message will be sent to the user's friends (including family) inquiring whether any of the people receiving the message are interested in the item. For example, personal A/V apparatus 902 can access the user profile and send a message to everyone who is considered a friend in the user profile. Alternatively, the system can access an address book in the user's personal information management system. In one example implementation, the message can be sent via e-mail, text message, etc. In another embodiment, messages can be sent to the personal A/V apparatus for each of the user's friends listed in the user profile. Each of the receiving personal A/V apparatuses will pop up a message with the item, a description of the item and a price. The user of the remote personal A/V devices (the friends of the user from step 2102) will be asked whether they are interested in buying the item and it will be explained that the user is intending to get a group discount. Each of those users will have an option to say yes or no and the results will be sent back to the original user. Additionally, information can be posted to one or more public forums and/or distribution lists. For example, users can sign up for public forums or distribution lists if they are interested in purchasing a particular good. In one example, a user may be interested in purchasing a high definition television set. That user can register at a forum or distribution list for people looking to buy high definition television sets. Step 2110 will including posting information sales forums or to the distribution list (which sends out e-mail, text messages or messages to the respective personal A/V apparatuses) about the purchase opportunity. Each of those people will be given the opportunity to indicate whether they are interested or not.

All the results from 2108 and 2110 will be sent back to the original user who will view the feedback in step 2112. That user's personal A/V apparatus will receive the results and automatically aggregate them. For example, the user's personal A/V apparatus will indicate that they contacted 2,000 people and 50 want to buy the same television. In response to the aggregate information, the personal A/V apparatus will automatically suggest a discounted offer. For example the personal A/V apparatus may pop up a dialogue box recommending to the user that since 50 people want to purchase the TV and the TV normally costs 1,000 U.S. dollars, it is recommended to offer the retailer $800.00 to purchase 50 televisions for the 50 users. The user has the option to affirm (step 2116) or decline the suggested discount offer by the A/V apparatus. If the user declines, the user can then manually make the user's own offer to the seller. If the user accepts the suggested one, the personal A/V apparatus will automatically send that offer to the seller electronically. Alternatively, if the user declines the suggestion by the personal A/V apparatus, the user can edit the suggested offer and that suggested offer as edited will be sent electronically to the seller. In response to the seller accepting the offer, the sale can be consummated automatically on line, or in person in a manual fashion.

FIG. 42B is a flowchart describing another embodiment for aggregating group demand using personal A/V devices. Steps 2130, 2132 and 2134 are the same as steps 2102, 2104 and 2106 of FIG. 42A. In step 2136, the user will manually negotiate a group deal with the seller. For example the user may approach a seller and say that if I can get 50 friends to buy the same television will you give us a 20% discount. This negotiation can be done in person or via electronic communicatio means (e.g. e-mail, text messages, personal A/V apparatuses, etc.). After negotiating a group discount, the user will then send a message to all the friends in the user's profile indicating the group deal and asking if the friends want to participate. In step 2140, the personal A/V apparatus will automatically post information about the item and the group deal to public forums and distribution lists (similar in manner to step 2110 of FIG. 42A). In step 2142, the personal A/V apparatus will receive all the feedback from steps 2138 and 2140. This feedback will be automatically aggregated and presented to the user. For example, the user will be presented with statistics that say that of the 2,000 people queried, 60 said yes they would like to participate in the deal. In step 2144 the purchase can be made automatically or manually, in person or online

### M. Service Provision Using Personal A/V System

A system using one or more personal A/V apparatuses can also be used to provide services to users from remote service providers. Through the use of personal A/V apparatus, a user can easily obtain a short period of service from an expert, allow an expert to see what the user sees, allow the user to see what the expert sees and/or allow the expert to guide the user. Because the services are provided through the personal A/V apparatus, it is possible that the person can be receiving the services while no one else around the person knows. For example, the person will see images from the service provider through the private optical system of the personal A/V apparatus and receive audio through an earphone of the personal A/V apparatus.

One embodiment includes a method for providing services using a personal A/V apparatus, comprising: authenticating a user and a service provider; connecting a personal A/V apparatus for the user to a central server; connecting personal A/V apparatus of a service provider to a central server; transmitting sensor data from the user's personal A/V apparatus to the service provider's personal A/V apparatus via the central server and the two connections; allowing a service provider to view through the service provider's personal A/V apparatus as if the service provider was looking through the user's personal A/V apparatus; and providing the service provider with the ability to send images to be viewed by the user through the user's personal A/V apparatus and audio to be listened to by the user through the user's personal A/V apparatus.

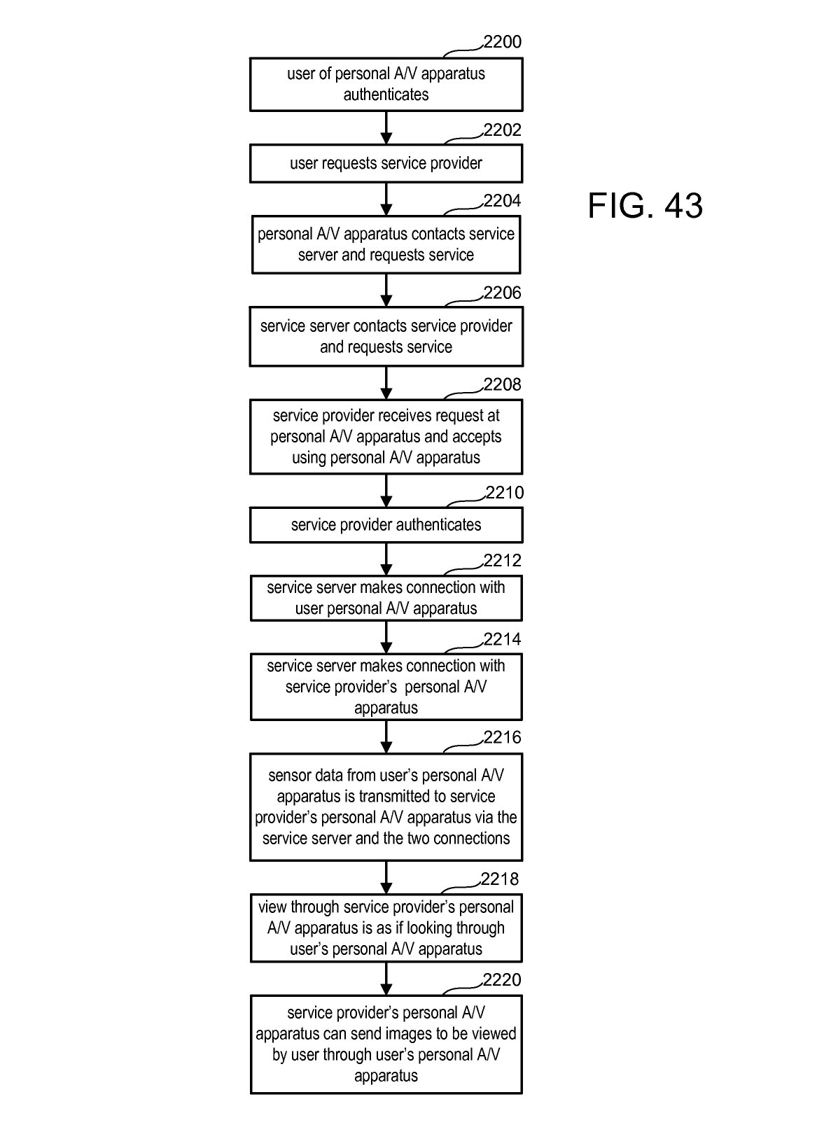

FIG. 43 is a flowchart describing one embodiment of a process for using one or more A/V apparatuses to provide a service to a user. In one embodiment, the system will implement the system of FIG. 24 with the user operating personal A/V apparatus 902 and the service provider operating personal A/V apparatus 902A or 902B. In this embodiment, either the Supplemental Information Provider 904 or Central Control Information Servee 922 can act as a central server (referred to in this example as the service server).

In step 2200 of FIG. 43, the user of the personal A/V apparatus will authenticate. In one embodiment, authentication is limited to the personal A/V apparatus 902. In another embodiment, authentication will be performed in conjunction with Supplemental Information Provider 904 and/or Central Control and Information Servers 922. In step 2202, the user will request a service provider to provide a service. In one embodiment, the user will have an identity of the service provider and request that particular identity to the personal A/V apparatus 902. In another embodiment, the user will know that the user wants the service but will not know an identity of a particular provider. Therefore, the user will request a service, the system will provide the user with a list of services, the user will choose a service from the list, the system will provide the user with a list of service providers for the chosen service, and the user will choose one of the service providers. This process of choosing can be performed with a set of menus or other selection means.

In step 2204 of FIG. 43, the user's personal A/V apparatus 902 will contact the service server (in this case either Supplemental Information Provider 904 or Central Control and Information Servers 922). Personal A/V apparatus 902 will request the service from the service server. In step 2206, the service server will contact the specific service provider by sending a request to the service provider's personal A/V apparatus. In step 2208, the service provider will receive the request at the service provider's personal A/V apparatus and accept or reject the request for the service. This example assumes the service provider accepts the request for service using the service provider's personal A/V apparatus. In step 2210, the service provider will authenticate. In one embodiment, the authentication is performed with personal A/V apparatus for the service provider. In some embodiments, the authentication will all be formed in conjunction with Supplemental Information Provider and/or Central Control and Information Servers.

After the service provider accepts the request for the service and authenticates, the system is ready to facilitate the service. In one example implementation, the service is provided such that it is personal to the user and others around the user will not be able to perceive the service, and the service provider will be able to step into the shoes of the user through the personal A/V apparatus.

In step 2212, the service server will make a connection with the personal A/V apparatus. The connection is persistent for the duration of the service and can be performed using various networking protocols known in the art. In step 2214, the service server will make a connection with the service provider's personal A/V apparatus. At this point, the service provider's personal A/V apparatus is now in communication with the user's personal A/V apparatus via a service server and the two persistent connections. In step 2216, sensor data from the user's personal A/V apparatus is transmitted to the service provider's personal A/V apparatus via the service server and the two persistent connections. In this manner, the service provider's personal A/V apparatus will project a video for the service provider to see through the personal A/V apparatus of the service provider. The video will show the scene/environment in front of the user by taking the output of the cameras (still, video and/or depth) from the user's A/V apparatus. Additionally, any graphics being superimposed in the see-through display of the user's A/V apparatus will also be provided to the service provider's A/V apparatus, therefore, the service provider is effectively looking through the service provider's personal A/V apparatus as seeing what the user sees through the user's personal A/V apparatus. As the user talks, the service provider can hear when the user says and sees what the user sees. In this manner, the service provider can help the user perform a task, answer questions, fix things, etc. Using the gaze detection described above, the service will also be able to tell where the person is looking (e.g., eye tracking). For the car mechanic service, for example, this would give the expert the info to say “no, you're looking at the wrong thing.” In step 2200, the service provider's personal A/V apparatus can send images to be viewed by the user through the user's personal A/V apparatus. Similarly, the service provider's personal A/V apparatus can send audio to be listened to by the user through the user's personal A/V apparatus.

N. Personal A/V System with Navigation

A system utilizing a personal A/V apparatus can provide navigation and information in a place of interest. Examples of locations of places of interest include amusement parks (includes theme parks), museums, festivals, parks, carnivals, temporarily set-up locations (like haunted houses at Halloween), etc. The system can be used to provide navigation/directions to various portions of the place of interest, show areas that are less crowded than other areas, show opportunities for performances, etc.

One embodiment includes a method for managing information for a place of interest, comprising: continuously sensing real time data about the place of interest in regard to traffic at one or more subsections of the place of interest; connecting a mobile wireless personal A/V apparatus to the nearest local server of plurality of local servers in communication with one or more central servers; and using the personal A/V apparatus, via the connected local server, to obtain a navigation service from the one or more central servers based on the sensed real time data.

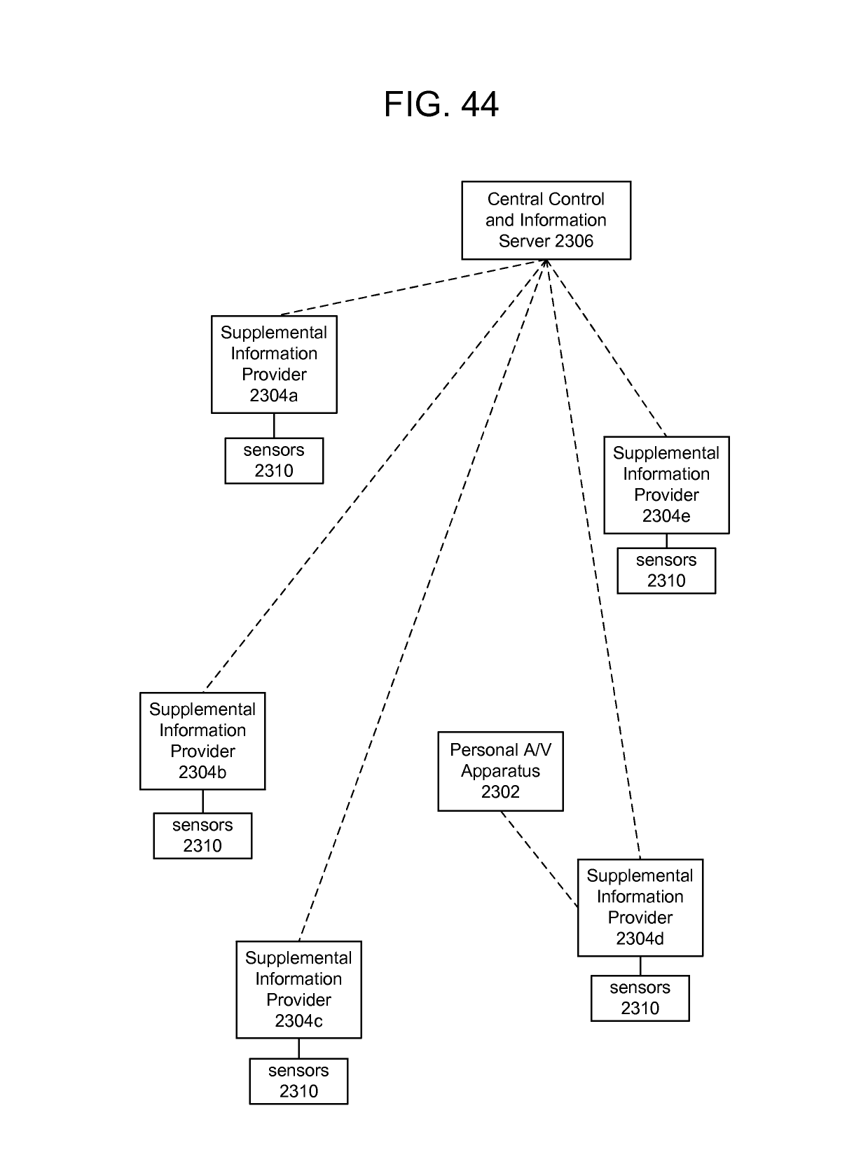

FIG. 44 is a block diagram depicting one example of a system that can be implemented at a place of interest. FIG. 44 shows a Central Control and Information Server 2306 (which can be one or more computing devices) in communication with a plurality of Supplemental Information Providers 2304A, 2304B, 2304C, 2304D and 2304E. Each Supplemental Information Provider 2304 is co-located with and connected to a set of one or more sensors 2310. The sensors can include video sensors, depth image sensors, heat sensors, IR sensors, weight sensors, motion sensors, etc. Each of the Supplemental Information Providers are placed at various locations throughout the place of interest. The sensors are used to gather traffic information about different subsections of the place of interest. For example, in the case of an amusement park, a Supplemental Information Provider 2304 and an accompanying set of one or more sensors 2310 can be placed at each ride or attraction. The sensors can be used to determine the amount of people waiting on line or how crowded the ride is. In some embodiments, there will be some Supplemental Information Providers 2304 which do not have co-located sensors. In other embodiments, sensors can be implemented without a co-located Supplemental Information Provider, where the sensors can communicate directly to Central Control and Information Server 2306. The Supplemental Information Providers will communicate with the Central Control and Information Server 2306 via one ro more wired networks, wireless communications or any other communication means. In an example of a museum, the Supplemental Information Providers (with co-located sensors) can be located in each section/room of the museum, or each major exhibit.

The system of FIG. 44 can be used to provide a user of a personal A/V apparatus 2302 with directions how to navigate through the place of interest. Additionally, Central Control and Information Server 2306, based on the information from the sensors 2310 can indicate which areas of the place of interest are less crowded. In the case of an amusement park, the system can tell the user of personal A/V apparatus 2302 which ride has the shortest line. In the case of a ski mountain, the system can provide the user of personal A/V apparatus 2302 with indication of which lift line is the shortest or which trail is less crowded. The personal A/V apparatus 2302 will be mobile and move around the place of interest with the user, connecting to the closest Supplemental Information Provider 2304 at any given time. In one embodiment, an overall command system could instead not send everyone the same data of shortest line as that line may then be flooded. Instread, people could be given one of the x number of suggestions either randomly, based of previous interest, or profile data (don't send me to a scarry ride when I′m with my 2 year old).

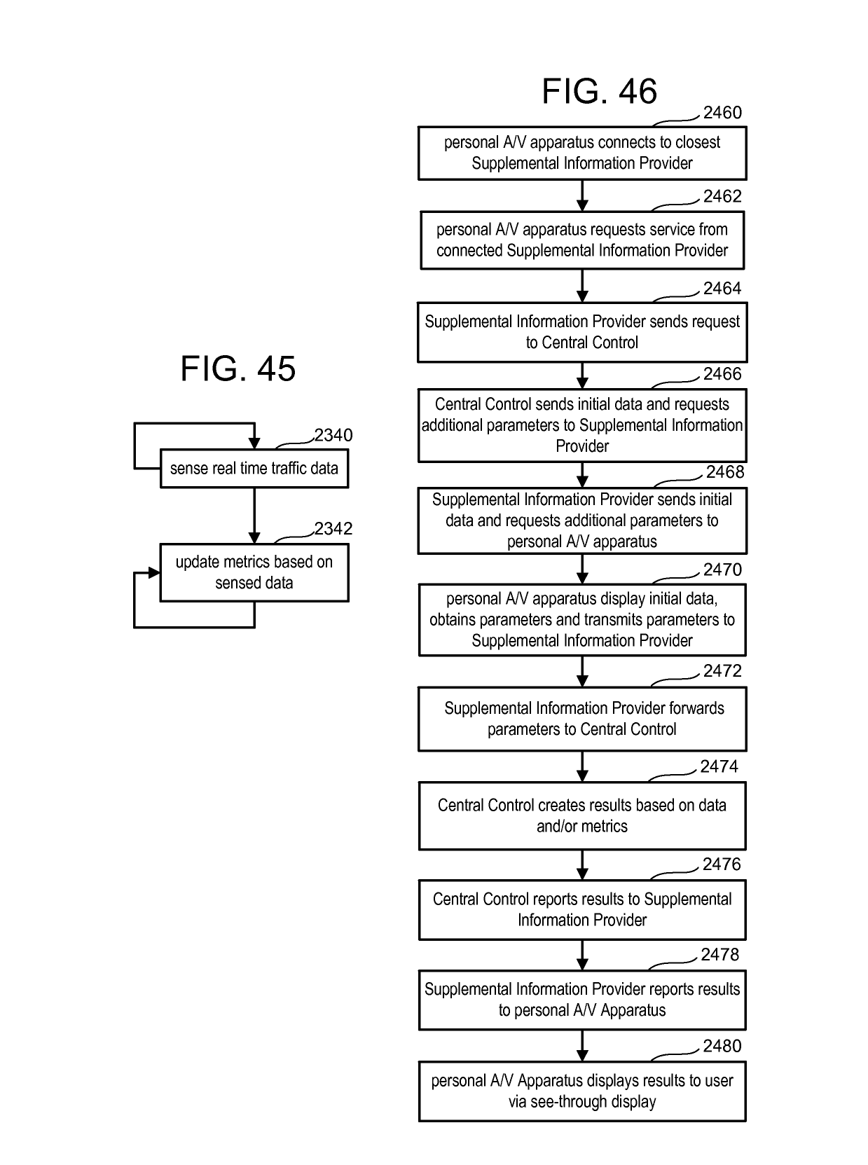

FIG. 45 is a flowchart describing the process performed with sensors 2310. In step 2340, sensors 2310 are constantly sensing data and reporting that data to the local Supplemental Information Provider 2304, which provides that information to sensor control and information server 2306. The data will be stored at Central Control and Information Server 2306. In step 2342, Central Control and Information Server 2306 will update metrics it is storing based on the new data. For example, the wait for a ski lift line or wait at a ride will be calculated. Steps 2340 and 2342 are continuously repeated.

FIG. 46 is a flowchart describing one embodiment for the operation of the system depicted in FIG. 44. In step 2460, the personal A/V apparatus will connect to the closest Supplemental Information Provider. The connection is likely to be over Wi-Fi but can be over Bluetooth or other wireless communication means. In step 2462, the personal A/V apparatus will request a service from the connected Supplemental Information Provider. For example, the personal A/V apparatus (at the control of the user) will request directions to an attraction at the location, or request an indication of what ride/exhibit/line is the least crowded. In step 2464, the Supplemental Information Provider will send that request to the Central Control and Information Server.

In step 2466 the Central Control and Information Server will obtain initial data for the request and send that initial data back to the Supplemental Information Provider, along with a request for additional parameters. For example, if the user is requesting directions to a theme park, the central control may request such parameters as the desired destination. The initial data may be a map. In step 2468, the Supplemental Information Provider will send the initial data and request for parameters to the personal A/V apparatus so that that information can be provided to the user looking through the see through display of the personal A/V apparatus. In step 2470, the personal A/V apparatus will display the initial data, obtain the parameters from the user and then transmit these parameters back to the Supplemental Information Provider. For example, the display of the personal A/V apparatus may request the user to indicate at a destination. Another example, the personal A/V apparatus may provide a menu of options to the user such as find a ride at the amusement park that has the shortest line, or choose a category of rides from which to find which one has the shortest line.

In step 2472, the Supplemental Information Provider will forward the parameters back to Central Control and Information Servers. In step 2474, the Central Control and Information Servers will create the results of the user request based on data stored at the Central Control and Information Servers and the metrics stored by Central Control and Information Servers (which is based on the sensor data). In step 2476, the Central Control and Information Servers will report the results to the Supplemental Information Provider. In step 2478, the Supplemental Information Provider will report the results back to the personal A/V apparatus. In step 2480, the personal A/V apparatus will display the results to the user via the see-through display.

In one embodiment of step 2480, the presentation of results can be interactive in that the user can ask questions about the results and the questions will be reported back to the Central Control and Information Server. Central Control and Information Server will respond to the questions via text, images, video, audio and/or graphics provided back to the user through the personal A/V apparatus.

### O. Personal A/V System With Context Relevant Information

A system utilizing a personal A/V apparatus can be used to occupy a user while the user is waiting. For example, if the user is at a amusement park, many of the attractions will have long lines. While the user is waiting in line, the personal A/V apparatus can be used to provide the user with the opportunity to play games, review relevant information, or otherwise be entertained. In one embodiment, the content provided to the user while waiting in line is in context to the attraction the user is waiting for. In addition to amusement parks, the system can be used while waiting in other situations such as at stores, banks, tourist attractions, etc. In each case, while the user is waiting for something, the user can be provided with context sensitive information.

One embodiment includes a method for providing context sensitive information while the user is waiting, comprising connecting a personal A/V apparatus to a local server; verifying that the connection persists for a predefined amount of time; providing content that is context sensitive to the location the user is waiting in; and automatically detecting that the user is at the front of a line and concluding the presentation and response thereto.

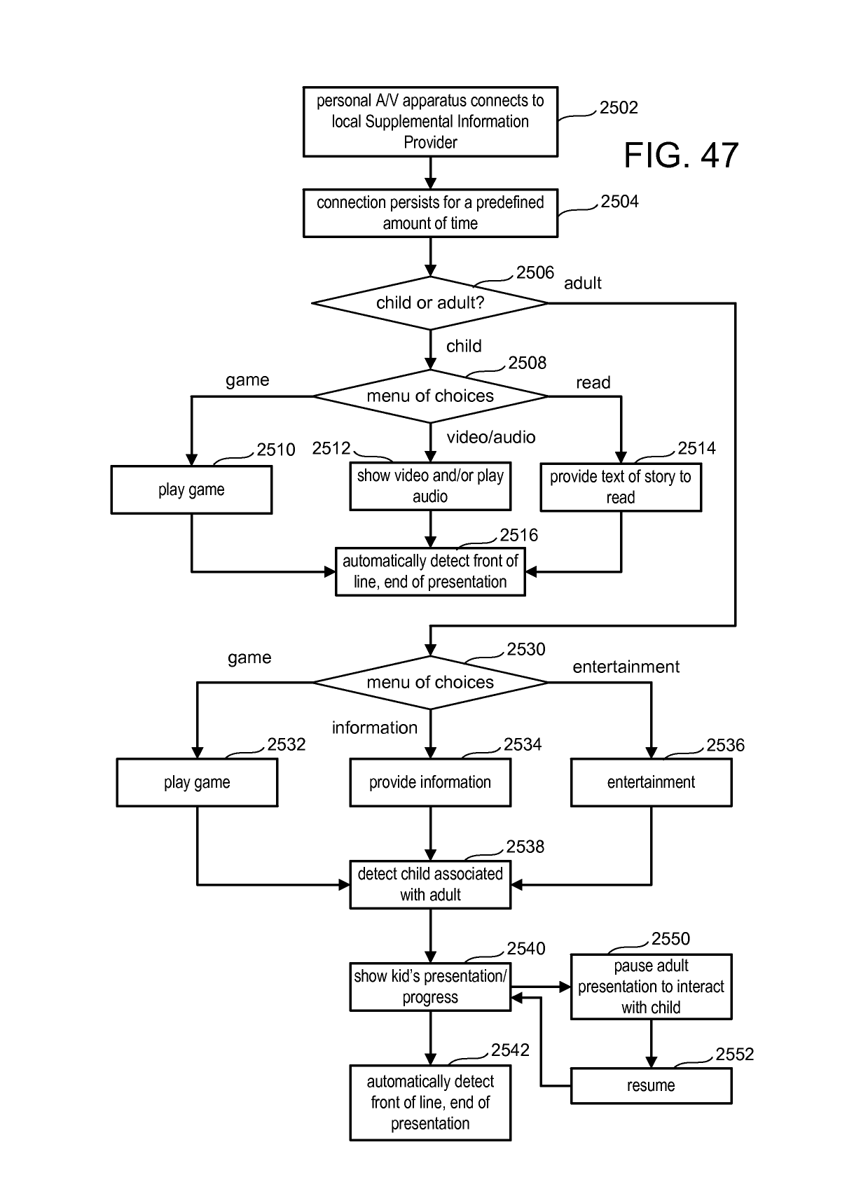

FIG. 47 is a flowchart describing one embodiment of method for providing the context sensitive information to a user while that user is waiting. The process of FIG. 47 can be implemented using the system of FIG. 44. For example, the various Supplemental Information Providers 2304 can be situated at different attractions in an amusement park, different areas of a museum, different areas of an airport, etc. In step 2502, the personal A/V apparatus connects to the local Supplemental Information Provider. In one embodiment, the personal A/V apparatus will connect to the closest local Supplemental Information Provider. For example, if the user is at a amusement park, each attraction may have its own Supplemental Information Provider and the user's personal A/V apparatus will automatically connect to the Supplemental Information Provider for the current attraction that the user is waiting in line for. In step 2504, Supplemental Information Provider will verify that the connection between the personal A/V apparatus and the Supplemental Information Provider persists for a predefined amount of time. This is to verify that the user is in fact waiting in line rather than just walking by the Supplemental Information Provider.

In step 2506, the system will determine whether the user of the personal A/V apparatus is a child or an adult. In one embodiment, the personal A/V apparatus will indicate to a Supplemental Information Provider whether the user is a child or adult. In other embodiments, the Supplemental Information Provider will access the user profile for the user to determine whether the user is a child or an adult.

If the user is a child (step 2506), then the child is provided with a menu of choices in step 2508. In response to the menu of the choices, the child will choose one of the choices. In one embodiment, the choices include playing a game, watching a video (or listening to audio) or reading a story. If the child chooses to play a game, the child will be able to play a game at step 2510. If the child chooses to watch a video or listen to a story, the child would be provided with the presentation in step 2512. If the child chooses to read, then the text will be provided of a story so the child can read the story in step 2514.

In step 2516, the Supplemental Information Provider automatically detects that the user is at the front of the line and, in response thereto, ends the presentation (game, video, story, etc.). In one embodiment, the system can use a Bluetooth connection to identify that the personal A/V apparatus is at the front of the line. In another embodiment, the Supplemental Information Provider will use the attached sensors 2310 to detect (using video, depth images, still images, RFID tags, Bluetooth, etc.) that the user is at the front of the line. In another embodiment, the personal A/V apparatus can detect that it is at the front of the line based on its GPS sensor, video camera, depth camera, RFID tag, or other sensor.

If, in step 2506, it was determined that the user is an adult, then in step 2530 the user will be provided with a menu of choices (such as play a game, access information about the attraction the user is waiting for, of be presented with entertainment). In one embodiment, the game, information and entertainment are all context sensitive, in that they pertain to the attraction the user is waiting for. This is similar to the child's choices where the game, video and/or story are all context sensitive to the attraction the user is waiting for. For example, if the user is waiting to enter a haunted house, the game, video, story, information, or other entertainment can be about haunted houses in general or this specific haunted house. If the user chooses (in step 2530) to play a game, then the user would be provider with the opportunity to play a game in step 2532. If the user chooses to access more information, then the user will be provided with more information in step 2534. In one embodiment, step 2534 allows the user to access various pages of information about the attraction and/or provides a connection to the Internet or other network. If the user chooses to be entertained, in step 2536, the user will receive entertainment (e.g. video, audio).

After the content starts (step 2532, 2534, or 2536) the system can automatically detect that the adult is associated with a child. In one embodiment, this can be determined using the profiles for the users of the A/V apparatus. In another embodiment, the personal A/V apparatus with the child and adult can be pre-configured to broadcast that they are associated. Once detecting that the adult is associated with a child who is also receiving content (see steps 2510, 2512 and 2514), the child's presentation and/or progress through the presentation can be depicted within the display of the adult's A/V apparatus. That is, the adult looking through the see through display of the personal A/V apparatus will see a projection of what the child is seeing. If the child is playing a game, a corner of the adult's display will show the game being played. If the child is watching a video, a corner of the adult's display will show the video being presented. If the child is reading a story, the text of the story will scroll through a corner of the adult's display. This way the adult can monitor what the child is doing in step 2540. At any point, the adult believes that the child needs the adult's attention due to the content being displayed or other reason, the adult can pause their presentation to interact with the child in step 2550. When the adult is done interacting with the child, the adult's presentation can resume in step 2552 (and the process will loop back to step 2540). In step 2542, either the personal A/V apparatus or the Supplemental Information Provider, as described above, will automatically detect that the user is at the front of the line. In response to detecting that the user is at the front of the line, the system will end the presentation.

### P. Changing Experience Using Personal A/V System

A system with a personal A/V apparatus can be used to vary the experience of a ride at a theme park, exhibit at a museum, tourist attraction or other attraction. They system can be used to make sure the ride/exhibit is different for everyone or different for each trip the user makes on the same ride or exhibit. Additionally, the differences in experiences can be based on the seasons and/or demographics (age, gender, likes/dislikes, etc.).

One embodiment includes a method for providing a personalized experience, comprising connecting a personal A/V apparatus to a local server; verifying that the user of the personal A/V apparatus is in or on an attraction; accessing user profile for the user of the personal A/V apparatus; identifying an enhancement package that matches parameters from a user profile and has not already been experienced; implementing the enhancement package while the user is in/on the attraction; and automatically detecting that the user has completed the attraction and ending the enhancement package in response thereto.

FIG. 48A is a flowchart describing one embodiment or a process for providing a personalized experience to a user at an attraction (ride in an amusement park, tourist attraction, museum, etc.). The process of FIG. 48A can be implemented using the system of FIG. 44, where each of the Supplemental Information Providers are located at different rides, exhibits, attractions, etc. In step 2602, the personal A/V apparatus will connect to the local Supplemental Information Provider using WiFi, Bluetooth or other wireless technologies. In step 2604, the system will verify that the user is on or in the attraction. For example, sensors on the personal A/V apparatus (GPS sensors, video cameras, depth cameras, Bluetooth communication links, IR sensors, etc.) can determine if the user is on the ride. Additionally, sensors 2310 connected to a Supplemental Information Provider can detect that the user is on the ride using video cameras, depth cameras, RFID tags, Bluetooth, WiFi, etc. In step 2606, the Supplemental Information Provider 2304 will access the user profile for the user of the personal A/V apparatus as connected to the Supplemental Information Provider.

In one embodiment for each attraction (each ride in an amusement part), the system will have a set of enhancement packages. Each enhancement package in the set of multiple enhancement packages will have different sets of virtual graphics and sounds to be presented to the user via the personal A/V apparatus. The enhancement packages can be set up so that they are designed for different types of people. For example some enhancement packages can be designed for children, some designed for middle aged people, and some designed for older people. Some enhancement packages can be designed for males while other enhancement packages are designed for females, some enhancement packages can be designed for people who live in one country and other enhancement packages can be designed for people who live in a different country. Enhancement packages can also be designed based on language, education, interest or theme, time of year, holiday, etc.

In step 2608 of FIG. 48A, the system will determine the subset of enhancement packages that meet the demographic parameters in the user's profile. For example, if the user is a 32 year old female from California with a college degree, the system will determine the appropriate set of enhancement packages for those parameters. In step 2610, the system will filter out any of the enhancement packages identified in step 2608 that the user has already experienced. In the manner, the user will get a different experience each time the user goes on the ride, visits the exhibit, etc. With the remaining enhancement packages after the filtering of step 2610, the system will randomly choose one of the remaining packages in step 2612. In this way, two people entering the same ride may get different experiences. In one embodiment, the system can choose one of the remaining enhancement packages by a means other than choosing randomly.

In step 2614, an indication of the chosen enhancement package is stored in the user's profile so that next the user visits this ride, exhibit or other attraction, the user will not be provided with the same enhancement package. In step 2616, the enhancement package is implemented while the user is in or on the attraction. In step 2618, the system will automatically detect that the attraction has completed and the enhancement package will be terminated. In one embodiment, sensors 2310 can determine that the attraction is completed. For example, the sensors can determine that the roller coaster ride is over.

FIG. 48B is a flowchart describing one embodiment of a process for implementing the package while the user is in or on the attraction (one example implementation of step 2616). In step 2630, the personal A/V apparatus will determine its location and orientation. Additionally, the personal A/V apparatus will determine the gaze of the user, as explained above. In step 2632, the location, orientation and gaze are sent to the Supplemental Information Provider. In step 2634, the Supplemental Information Provider will determine the current enhancement to implement from the enhancement package chosen in step 2612 of FIG. 48A. For example, as the user is on a ride, different sounds can be provided to the user's personal A/V apparatus and/or different virtual graphics can be projected in the see-through display of the personal A/V apparatus. In one example, a user is on a haunted house ride. In different rooms of the haunted house, different images of ghosts and scary images will be provided to the user. Enhancements are sent to the personal A/V apparatus in step 2636 from the Supplemental Information Provider. In step 2638, the personal A/V apparatus will render the enhancement based on the personal A/V apparatus' location and orientation, as well as the gaze of the user. If the attraction is complete (see step 2618), then the enhancements will be terminated and an exit message will be provided to the user in step 2642. If the attraction is not complete, then the process will loop back to step 2630 and provide another set of one or more enhancements.

### Q. Adding Content to Scene Using Personal A/V System

A system with a personal A/V apparatus can be used to graphically show the history of a certain location. For example, a castle or heritage site can be made to come alive. A user can see what the heritage site looked like at any point in time throughout history. A scene from history can also be played out. For example, the user can see a castle and watch daily life around the castle or watch a battle being forged. Historical reenactments can be made at the modern day locations of the site of the original event. In one example, a user can be at a non-famous location and have the personal A/V apparatus show the user all the events that happened at that location at certain points in history. Another example could be a user walking through a city while the personal A/V apparatus shows the user where various movies were made, by pointing out the location and/or displaying the scene from the movie. In each of these embodiments, one or more virtual graphics are added to the see-though display of the personal A/V system to show the historical scene superimposed on top of the current location's image in the see-through display described above.

One embodiment includes a method for providing a personalized experience to user of a personal A/V system, comprising: determining the location and orientation of the personal A/V apparatus; determining the gaze of the user operating the personal A/V apparatus; receiving a request for historical scene; accessing data for the scene; determining current enhancement to implement based on location, orientation and gaze; sending the enhancements to the personal A/V apparatus; rendering virtual graphics in the see through display of the personal A/V apparatus based on location, orientation and gaze; changing a perspective of the personal A/V apparatus; and rendering new graphics in the see-through display of the personal A/V apparatus based on the change in perspective, where the rendered graphics depict a scene at the location of the personal A/V apparatus at a time in the past.

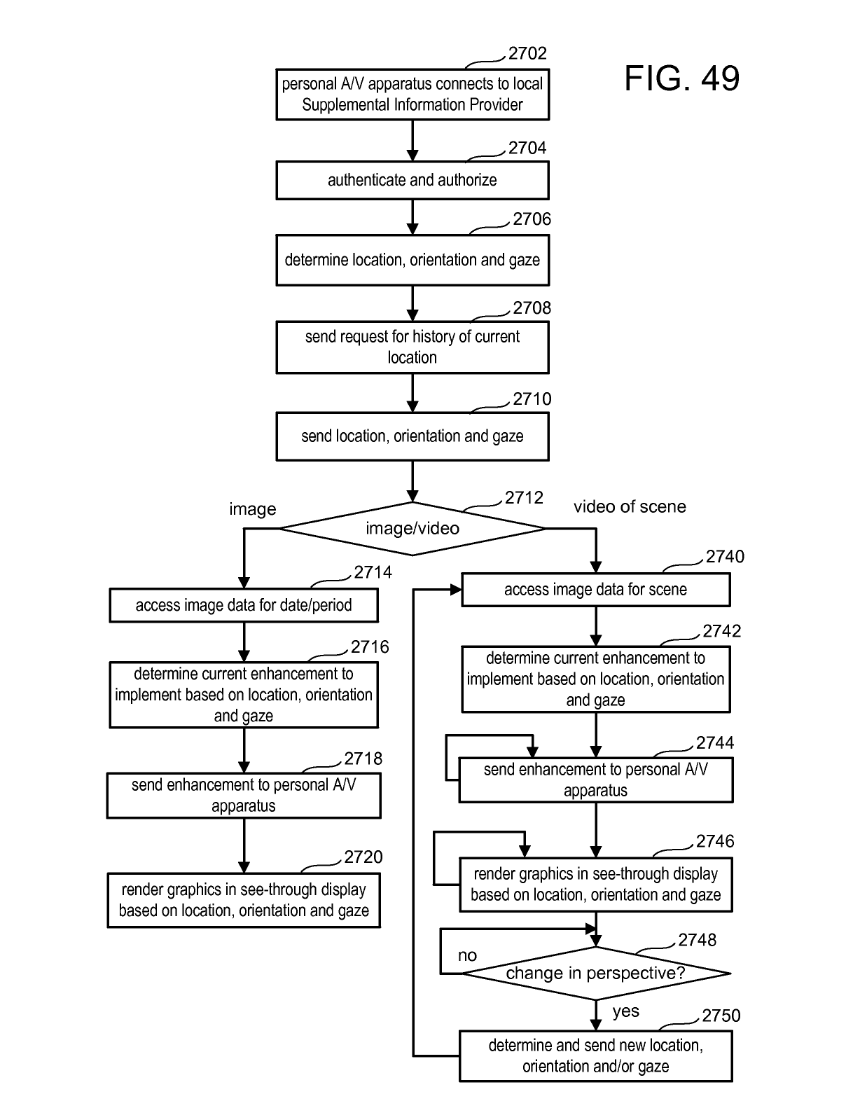

FIG. 49 is a flowchart describing one embodiment of a process for providing a personalized experience to a user of a personal A/V apparatus such that the user looking at a modern scene can see historical images and/or reenactments of scenes through the personal A/V apparatus. In one embodiment, the system of FIG. 44 can be used to implement the process of FIG. 49. It is contemplated that Central Control and Information Server 2306 will include a database that describes images and scenes for various locations of interest. These images and scenes can be indexed based on location and date.

In step 2702 of FIG. 49, the personal A/V apparatus will connect to a local Supplemental Information Provider. It is contemplated that there will be a Supplemental Information Provider at each of the locations for which historical scenes and images can be inserted in the personal A/V apparatus. In step 2704, the personal A/V apparatus will authenticate and authorize. In one embodiment, a user will only be able to access the service described herein if the user has been authorized to use the service (e.g. paid a subscription fee or otherwise received permission). In step 2706, the personal A/V apparatus will determine its location and orientation. Additionally, the gaze of the user will be determined, as described above. In step 2708, a request for history will be sent from the personal A/V apparatus to the Supplemental Information Provider. In step 2710, the personal A/V apparatus will send its location, orientation and gaze to the Supplemental Information Provider. If the user requested an image of the location at a certain point in history (step 2712), then steps 2714-2712 will be performed. If the user requested a video of a scene that took place in history (step 2712), then steps 2740-2750 will be performed.

In step 2714, the system will access image data for the date/period requested. For example, Supplemental Information Provider 2304 will request that image data from Central Control and Information Server. In step 2716, the system will determine the current enhancement to implement based on the location, orientation and gaze of the user. For example, the image data for the date/period will include information about images of a larger area. However, the user will only see a small subset of the area. The subset will be determined based on the location, orientation and gaze information provided in step 2708. That enhancement is sent to the personal A/V apparatus in step 2718. One or more graphics are rendered and projected in the see-through display of the personal A/V apparatus based on the location, orientation and gaze information described above (or newly sensed information). Therefore, one or more images are placed into the current scene, in perspective. For example, a tourist at a castle may wish to see what the castle looked like in 1250 AD. Therefore, step 2720 will include adding graphics to the walls of the castle and the grounds of the castle to make the castle look like it did in 1250 AD. In one embodiment, steps 2716-2720 can be repeated to show stop motion of the castle aging over time.

In step 2740, the system will access image data for a scene. For example, Supplemental Information Provider will access the image data from Central Control and Information Server. In step 2742, the system will determine the current enhancement to implement based on location, orientation and gaze information provided in step 2708. In step 2744, the system will send enhancements to the personal A/V apparatus. Because the system will be showing a scene (which is a video), step 2744 will be repeated once for each frame. Therefore, step 2744 can be repeated 24 times a second or at a different frame rate. Step 2746 includes rendering graphics based on the enhancement information received at the personal A/V apparatus. The graphics are rendered in the see-through display based on the location, orientation and gaze information (previously sent or current sent). Each time enhancement information is received, the new graphics can be rendered, thereby, rendering a video. In one embodiment, graphics are rendered 24 times a second or a different frame rate.

In one example, a user could be looking at the castle described above and ask to see what daily life looked like. Steps 2744 and 2746 will be continuously performed to show peasants, knights and royalty walking about the castle. If the user changes perspective (in step 2748) by changing the gaze or orientation, then new location, orientation and/or gaze information will be determined in step 2750 and sent to Supplemental Information Provider. The process will then loop back to step 2740 to access new image data (if necessary) and then proceed with determining current enhancements and providing new enhancements/graphics.

### R. Enriched Experience Using Personal A/V System

A personal A/V apparatus can also be used as a personal tour guide for tourists, or a docent for museum goers. For example, a system can determine the level of prior exposure to an attraction via the user's profile and then provide commentary, facts and suggestions to the user in regard to what the user is currently looking at. A user can set up an itinerary or task list of things the user wants to accomplish in a particular day and use the personal A/V apparatus to track whether the user had seen everything they intend to see. In a teaching situation, a teacher can bring the teacher's class to a museum or other attraction, and send a task list to each of the students. Each student will then have their own personal A/V apparatus to provide them with a list of tasks, commentary on each of the items they see and the ability to automatically track whether the student performs each task. For example, a task can be to view a particular exhibit in a museum, see a particular painting, etc. At the end of the day (or other time period) the teacher can be provided with a report indicating which students performed which tasks. Tasks can be acknowledged by RFID proximity, sensors, etc.

One embodiment includes a method for using a personal A/V apparatus as a personal tour guide, comprising: determining location and orientation of the personal A/V apparatus; determining the gaze of the user; accessing a user profile and obtaining a task list; sending a request for information about something being viewed; determining what is being viewed; accessing user profile to determine past experience with what is being viewed; accessing the user profile to access a task list; automatically determining whether the user is performing a task on the task list and, if so, updating the task list; filtering location data based on user's past experience and preparing additional information to be displayed to the user based on the filtered location data; displaying the information prepared for the user in the see-through display of the personal A/V apparatus and displaying the updated task list; and reporting the update of the task list to an authorized reviewer.

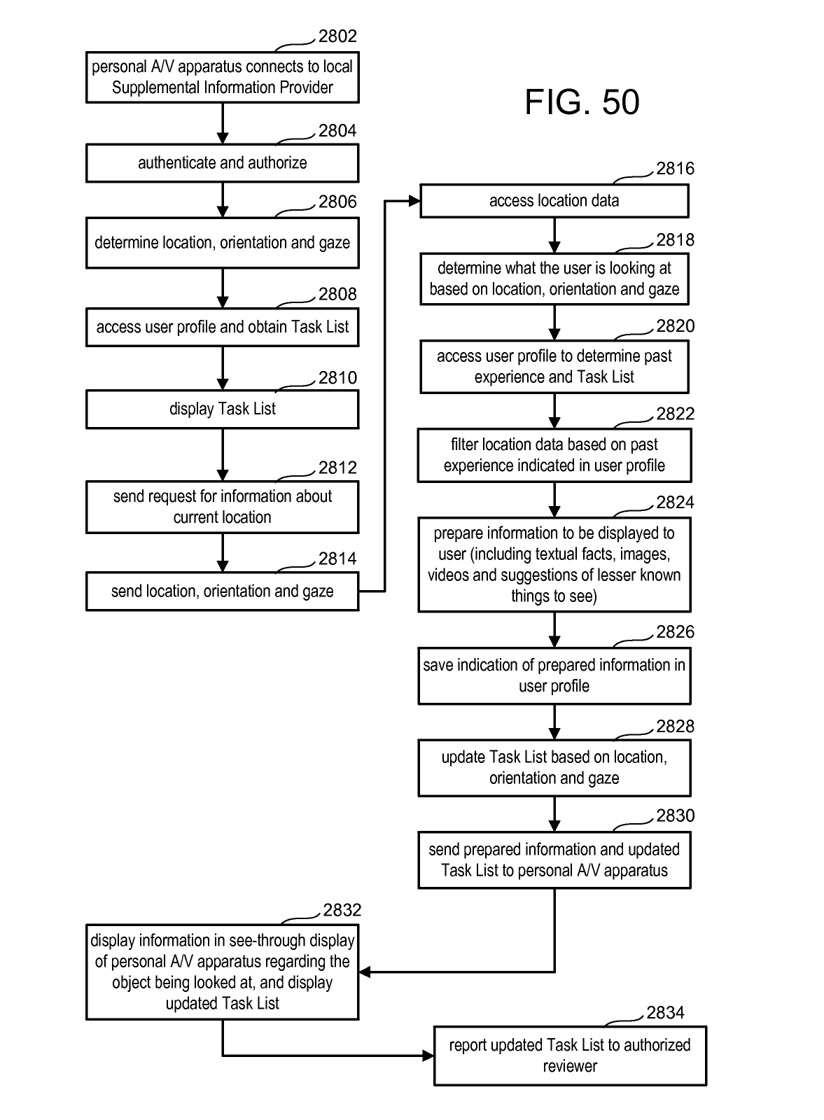

FIG. 50 is a flowchart describing one embodiment of a process for using an A/R apparatus as a personal tour guide or docent. The system of FIG. 44 can be used to implement the process of FIG. 50, with each of the Supplemental Information Providers being arranged at different exhibits, attractions, etc. in a particular location. Note that the steps of FIG. 50 on the left hand column are performed at the personal A/V apparatus, and the steps on the right hand column of FIG. 50 are performed at the central computer and information server (or a combination of the central computer and information server in combination with Supplemental Information Provider).

In step 2802 of FIG. 50, a personal A/V apparatus will connect to the local Supplemental Information Provider. As the user moves throughout a location, the personal A/V apparatus may reconnect to different Supplemental Information Providers, all which are in communication with Central Control and Information Server. In step 2804, the user will authenticate and the system will make sure the user is authorized to access the service.

In step 2806, the personal A/V apparatus will determine its location and orientation. Additionally, the personal A/V apparatus will determine the gaze of the user, as described above. In step 2808, the personal A/V apparatus will access the user profile and obtain a task list. This can include contacting Central Control and Information Server and obtaining a copy of the task list from the user's profile. In step 2810, the task list is displayed to the user via the see-through display of the personal A/V apparatus. In step 2812, the personal A/V apparatus will send a request to the Central Control and Information Server for information about what the user is looking at. In step 2814, the personal A/V apparatus will send the location, orientation and gaze to the Central Control and Information Server.

In step 2816, the system will access location data for the location that user is currently at (based on the location sent in step 2814). The location data will include facts, suggestions, images, videos of the location. Step 2818 includes determining what the user is looking at based on the location, orientation and gaze. For example, step 2818 may determine that the user is looking at a particular painting. In step 2820, the system will access the user profile to determine past experiences at the current location. The system will also access the task list which may be part of the user profile or separate from the user profile (but linked to the user profile). In step 2822, the system will filter all the location data accessed in step 2816, based on the past experiences of the user in this location as indicated by the user profile accessed in step 2820. In step 2824, information will be prepared for the user to be displayed in the personal A/V apparatus. The information being prepared will include textual facts, images, videos and suggestions of lesser known things to see in the area. This information will not include duplicate information already provided to the user or that the user already knows.

In step 2826, the system will save an indication of what information was prepared and sent to the user. This information will be stored in the user profile so the next time the user is at this location, new information can be provided. In step 2828, the task list can be updated based on the current location, orientation and gaze. For example, if one of the tasks was to view a painting and it is determined that the user is viewing that painting, then that task is marked as being accomplished. In another example, if the task is to view an exhibit in a particular room, and the user is in that room, that task is marked as being accomplished. Some embodiments will not include a task list.

In step 2830, the prepared information (see step 2824) and the update task lists are sent to the personal A/V apparatus. In step 2832, the personal A/V apparatus will display the information sent (and prepared in step 2824) in the see-through display of the personal A/V apparatus. That information will provide background about whatever object the user is looking at. Additionally, the personal A/V apparatus will display the updated task list.

In some embodiments, the task list is created by the user for the user's own benefit. In other embodiments, another party can create the task list. For example, a teacher may create a task list for a class of students on a field trip. In such an embodiment, the updates to the task list will be reported to an authorized reviewer (e.g. the teacher) in step 2834. In this manner, the teacher (or other authorized reviewer) can monitor whether the students are performing all the tasks they are supposed to be performing. In this manner, a teacher can bring a class to a museum or other place of interest, provide an itinerary of things to see and do, and monitor that each of the students do what they are supposed to be doing. The use of a task list could also be for a self-study program.

### S. Virtual Theme Park

A system using one or more personal A/V apparatuses can use augmented reality to simulate a theme park, museum or other attraction. For example, an amusement park operator can operate an augmented reality room in an empty warehouse in a downtown of a city in a way to promote the amusement park. Similarly, the augmented reality system can be used to allow a person to visit a city without actually being in that city. The augmented reality experience can vary by season, include seated rides which provide motion and tactile sensations, and include advertisements for counterpart movies, toys and apparel.

One embodiment includes a method for performing an augmented reality experience, comprising: performing simulation of a destination location, including multiple events occurring serially and concurrently; a user with a personal A/V apparatus entering a simulation staging area during the simulation; determining the location and orientation of the user's A/V apparatus; determining the gaze of the user through the personal A/V apparatus; determining where the user is within the destination location based on the determined location of the user's personal A/V apparatus; determining the user's field of view in the destination location based on the determined location, orientation, gaze and current state of the simulation; filtering the user's field of view based on the user's profile (to make it age appropriate); rendering and displaying the user's field of view through the see-through display (including everything except other people and/or the user); and updating the display of the user's field of view as the user moves and/or the simulation continues.

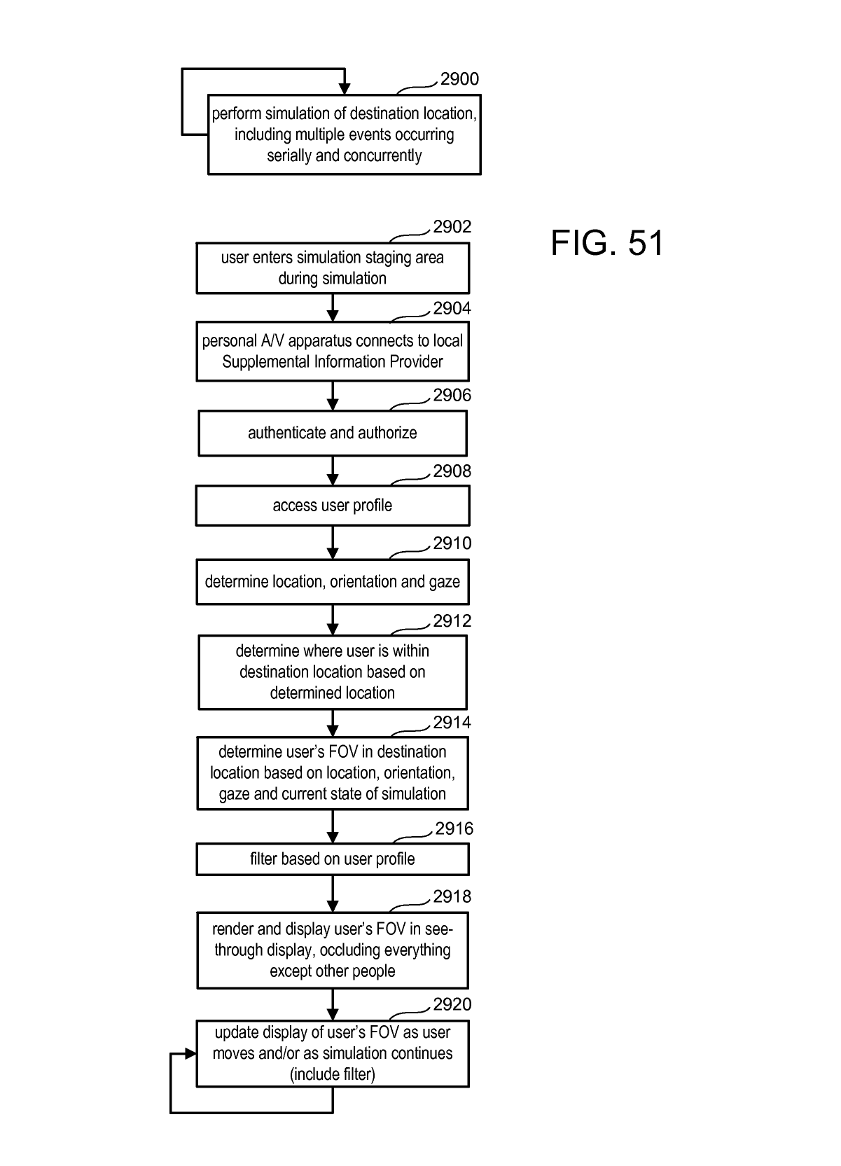

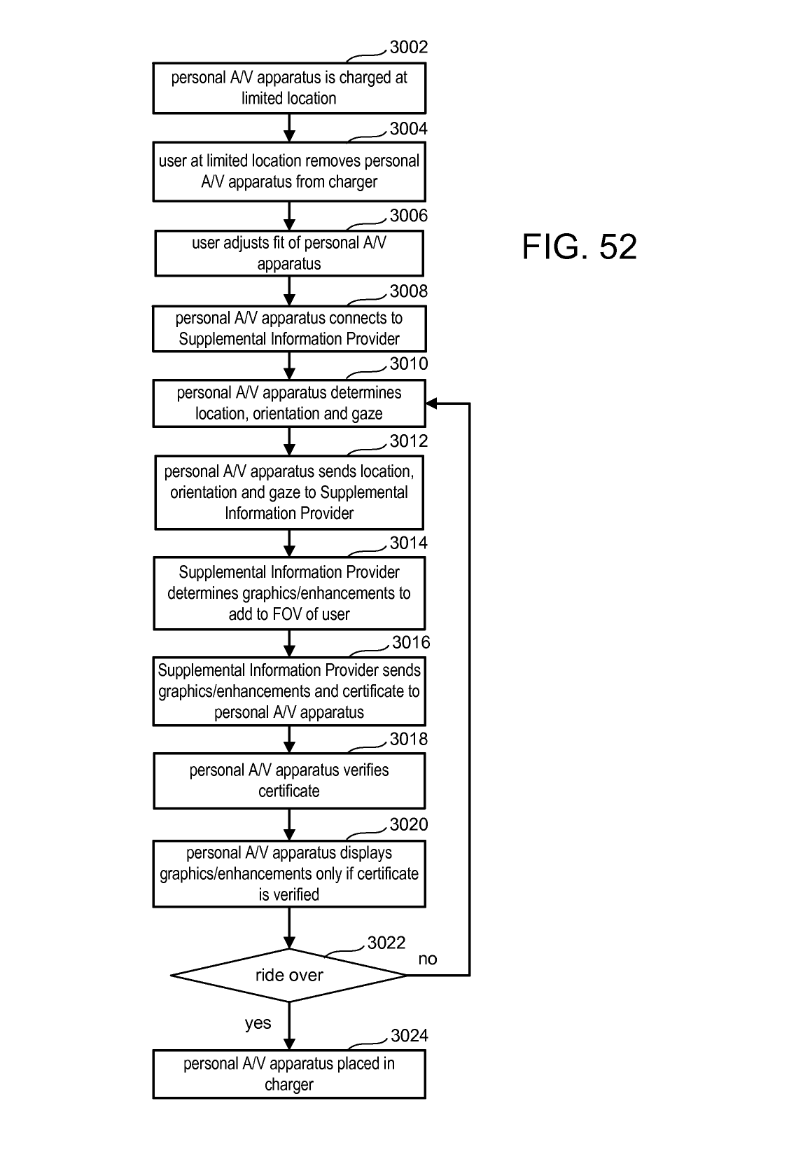

FIG. 51 is a flowchart describing one embodiment of a process for using augmented reality to provide a personal experience to the user. The process of FIG. 51 can be implemented by the system of FIG. 44. In some embodiments, all the components of FIG. 44 will be in a single room such as a giant warehouse. In other embodiments, the components can be in different rooms but physically close to each other.

In step 2900 of FIG. 51, the system will perform a simulation of a destination location. For example, the system will simulate a portion or the entire amusement park. Alternatively, a portion of a remote city, museum or other attraction can be simulated. The simulation includes performing multiple events occurring serially and concurrently. In the example of a simulated amusement park, multiple rides can be operating concurrently, and each ride will operate repeatedly (serially). For example, the roller coaster will take two minutes to go around the track. After two minutes, people can get off, more people can get on, and the roller coaster ride will be repeated. The simulation process is performed continuously.

While the simulation of step 2900 is being performed, a user will enter the simulation staging area. In one embodiment, the components of FIG. 44 will be operating in a warehouse. In this embodiment, the warehouse serves as a simulation staging area. Upon entering the simulation staging area, the user's personal A/V apparatus will connect to the local or (closest) Supplemental Information Provider in step 2904. The user will authenticate in step 2906. In addition, the system will make sure the user is authorized to participate in the simulation. In step 2908, the user's profile will be accessed. In one embodiment, the profile is stored on the user's personal A/V apparatus. In another embodiment, the profile is stored in the Central Control and Information Server 2306. In the process of FIG. 51, all the components are local so that the processing speed will be increased. Additionally, the processing is distributed between the personal A/V apparatus, Supplemental Information Provider and Central Control and Information Server to provide the fastest response times. In one embodiment, as much of the processing as can be done is performed on the personal A/V apparatus.

In step 2910, the personal A/V apparatus will determine its location and orientation. Additionally, the gaze of the user will be determined, as discussed above. In step 2912, the system will determine where the user is within the destination location based on the determined location of the personal A/V apparatus in the simulation staging area. In one embodiment, the personal A/V apparatus will transmit its location to the Central Control and Information Server, which will then determine where the user is within the destination location. In other embodiments, the personal A/V apparatus or the Supplemental Information Provider can determine the user's location in the destination location. For example, step 2912 could include determining where the user is within the amusement park. In step 2914, the user's field of view in the destination location (e.g. the amusement park) is determined based on the determined location of the personal A/V apparatus, the determined orientation of the personal A/V apparatus, the determined gaze of the user and the current state of the simulation. For example, if the user is determined to be standing next to a roller coaster, the state of the simulation (e.g. where the roller coaster is on the track) will affect the user's field of view.

In some embodiments, the user can be provided with advertisements. For example, virtual billboards can exist in the destination location. These billboards can display static images or videos. For example, an amusement park may have a virtual billboard with a video showing a preview for a movie associated with the theme park. In step 2916, a filter can be used for the user's field of view based on the user's profile. For example, an age filter can be used so that kids will not see adult content. For example some advertisements for movies may not be suitable for children. In addition, there could be other content at the destination location that may not be appropriate for children. In another embodiment, the user's profile can indicate the languages spoken by the user and the filtering in step 2916 can be used to translate advertisements and other textual references within the destination location so that they appear in the user's language.

In step 2918, the personal A/V apparatus will render and display the images in the user's field of view in the see-through display of the personal A/V apparatus. In one embodiment, the system will include images for everything in front of the user except other people. This way, the user will not see the empty warehouse. Instead, the user will only see the amusement park and the people around him or her walking through the amusement park. In step 2920, the display of the user's field of view will be updated as the user moves and/or as the simulation continues. Note that step 2920 will also implement the filter of step 2916. In one embodiment, step 2920 is repeated continuously based on the frame rate of the personal A/V apparatus and/or the refresh rate of the simulation being performed. In one embodiment, the simulation of step 2900 is being performed by Central Control and Information Server 2306. In other embodiments, an additional simulation server can perform the simulation.

### T. Short Term Virtual Experience Specific to Situation

An augmented reality system can be implemented such that a set of one or more personal A/V apparatuses can only be used with the local system and will be unusable when not near the local system. This can be useful in a theme park, a museum or other attraction. For example, a set of personal A/V apparatuses can only be useful for particular ride in an amusement park. Because the apparatus is only available to be used for one ride, it will be owned and maintained by the amusement park owner at the particular ride. Since multiple people will then use it, the personal A/V apparatus should adjustable to fit multiple people. Additionally, since it will only be used at the one ride, the personal A/V apparatus can have a smaller battery and would not need long range wireless communication. For example, the personal A/V apparatus would have no cellular communication system. In one embodiment, the personal A/V apparatus would only communicate by WiFi. In another embodiment, the personal A/V apparatus would not have WiFi and would only use Bluetooth or other short range wireless technology. An RFID tag can be used on the personal A/V apparatus to make sure that it is not removed from the premises of the ride. Additionally the system could use security so that the personal A/V apparatus is not used when away from the ride.

One embodiment includes a method for using a personal A/V apparatus with a local system only, comprising: connecting the personal A/V apparatus to a local server; determining location, orientation and gaze; using the location, orientation and gaze to determine and render virtual graphics; sending the virtual graphics with a certificate to the personal A/V apparatus; receiving the graphics and certificate at the personal A/V apparatus; and only displaying graphics received on the personal A/V apparatus if an accompanying valid certificate is received with the graphics (or information indicating the graphics).

FIG. 52 is a flowchart describing one embodiment of a process for using a personal A/V apparatus in a limited location. For purposes of this document, the limited location is an area within a bigger setting for which the area has defined boundaries and a defined function. One example of a limited location is a ride in an amusement park. Another example of a limited location is a room in a museum. The process of FIG. 52 can be implemented by the system of FIG. 22, where a personal A/V apparatus 902 will communicate directly with a Supplemental Information Provider 904. Multiple personal A/V apparatuses can communicate with the same Supplemental Information Provider 904, with the Supplemental Information Provider 904 being in the limited location. The network 906 of FIG. 22 can be any short range wireless communication technology.

In step 3002, a personal A/V apparatus is charged at the limited location. In one embodiment, the ride at the amusement park will have a charging station and will have multiple personal A/V apparatuses connected to a charging station. When a person goes to experience the ride, the person will access one of the personal A/V apparatuses by removing it from the charging station (step 3004). Because one A/V apparatus will be used by multiple users (at different times), the personal A/V apparatus will be adjustable. Therefore, in step 3006, the user will adjust the fit of the personal A/V apparatus.

In step 3008, the personal A/V apparatus will connect to the Supplemental Information Provider for the particular limited location. In step 3010, the personal A/V apparatus will determine its location and orientation within the limited location. In one embodiment, the software for operating the location sensor will only be able to determine location within the limited location. If the A/V apparatus is located outside the limited location, the software will not be able to resolve the location. Step 3010 also includes determining the gaze of the user, as described above. In step 3012, the personal A/V apparatus will send the location, orientation and gaze to the Supplemental Information Provider.

In step 3014, the supplement information provider will determine graphics/enhancements to add to the field of view of the user. These graphics/enhancements will be displayed by the personal A/V apparatus. In one embodiment, the graphics/enhancements are determined based on the location, orientation and gaze provided by the personal A/V apparatus. The graphics/enhancements can be virtual images which add to the ride or other attraction associated with the limited location. For example, if the limited location is a haunted house in an amusement park, the graphics/enhancements can be images of ghosts or other scary things. In step 3016, the Supplemental Information Provider sends the graphics/enhancements and a certificate to the personal A/V apparatus. The certificate is a security certificate in any suitable form known in the art.

In step 3018, the personal A/V apparatus will verify the certificate to make sure that it is authentic. In step 3020, the personal A/V apparatus will display the graphics/enhancements sent from the Supplemental Information Provider only if the certificate was verified as being authentic. If the certificate was not verified as being authentic, the personal A/V apparatus will ignore (and/or discard) the graphics/enhancements sent to it from the Supplemental Information Provider (or any other entity). In step 3022, it is determined whether the ride (or other attraction) is over. If the ride is not over, the process loops back to step 3010. If the ride is over, then the personal A/V apparatus is placed back in the charger (step 3024). In one embodiment, the ride can be detected as being over automatically by the computing device controlling the ride, by the location of the personal A/V apparatus, or by a timing mechanism. In other embodiments, determining if the ride is over can be done manually.

In some embodiments, enhancements displayed to a user during a ride (or other attraction) is themed to that ride (or other attraction).

The system describe above for providing enhancements during a ride (or other attraction) can be used in combination with the process for providing content while waiting in line.

The above discussion describes many different ideas. Each of these ideas can be combined with the other above-described ideas such that a personal A/V apparatus and accompanying system can be designed to implement all of the ideas discussed above, or any subset of the ideas.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for presenting a personalized experience using a personal A/V apparatus, comprising:
automatically determining a three dimensional location of the personal A/V apparatus, the personal A/V apparatus includes one or more sensors and a see-through display;
automatically determining an orientation of the personal A/V apparatus;
automatically determining a gaze of a user looking through the see-through display of the personal A/V apparatus;
automatically determining a three dimensional location of a movable object in the field of view of the user through the see-through display, the determining of the three dimensional location of the movable object is performed using the one or more sensors;
transmitting the three dimensional location of the personal A/V apparatus, the orientation, the gaze and the three dimensional location of the movable object to a server system;
accessing weather data at the server system and automatically determining the effects of weather on the movement of the movable object;
accessing course data at the server system;
accessing the user's profile at the server system, the user's profile including information about the user's skill and past performance;
automatically determining a recommend action on the movable object base on the three dimensional location of the movable object, the weather data and the course data;
automatically adjusting the recommendation based on the user's skill and past performance;
transmitting the adjusted recommendation to the personal A/V apparatus; and
displaying the adjusted recommendation in the see-through display of the personal A/V apparatus.

2. The method of claim 1, further comprising:
automatically tracking the movable object after the user performs the adjusted recommendation.

3. The method of claim 2, further comprising:
automatically updating the user's profile to include data based on the tracking of the movable object.

4. The method of claim 1, wherein:
the displaying the adjusted recommendation in the see-through display of the personal A/V apparatus includes graphically showing in the see-through display how to address the movable object.

5. The method of claim 4, wherein:
the graphically showing in the see-through display how to address the movable object includes rendering a virtual graphic in the see-through display in relation to the position of the movable object in the see-through display, the user is able to view the real world movable object through the see-through display.

6. The method of claim 1, further comprising:
accessing data of another player playing the same course as the user; and
graphically depicting in the see-through display the another player playing the same course synchronized with the user.

7. The method of claim 1, wherein:
the movable object is a golf ball; and
the adjusted recommendation includes an indication of a club.

8. The method of claim 1, further comprising:
receiving a request for help;
automatically determining the current situation with respect to the user, the course and the movable object;
displaying rules about the current situation in the see-through display; and
displaying an explanation about the current situation in the see-through display.

9. An apparatus for presenting a personalized experience, comprising:
a personal A/V apparatus that includes a see-through, near-eye, augmented reality display that is worn by a user; and
one or more servers in wireless communication with the personal A/V apparatus, the one or more servers automatically determine that the user is within an attraction, the one or more servers access a user profile for the user and identify one or more enhancement packages for the attraction that match parameters of the user profile, the one or more servers filter out enhancement packages that have already been experienced by the user and choose one of the remaining enhancement packages;
the chosen enhancement package is implemented by the personal A/V apparatus sensing data about its location and orientation, the personal A/V apparatus sensing data about gaze of the user, the one or more servers determining a graphic to add to the see-through, near-eye, augmented reality display, and the personal A/V apparatus rendering the determined graphic in the see-through, near-eye, augmented reality display, the one or more servers automatically determine that the user has completed the attraction and terminate the chosen enhancement package in response to determining that the user has completed the attraction.

10. The apparatus of claim 9, wherein:
the one or more servers includes a local Supplemental Information Provider data processing system and a central server that is remote from and in communication with the Supplemental Information Provider; and
the personal A/V apparatus automatically connects to the Supplemental Information Provider when in proximity to the attraction.

11. The apparatus of claim 10, wherein:
the attraction is a ride at an amusement park;
the local Supplemental Information Provider data processing system and the central server are positioned at the amusement park; and
the graphic is themed to the ride.

12. The apparatus of claim 9, further comprising:
one or more sensors positioned in proximity to the one or more servers, the one or more sensors automatically determine that the user is within the attraction.

13. The apparatus of claim 9, wherein:
the one or more servers automatically determine that the personal A/V apparatus is waiting at the attraction and provide content to the user via the personal A/V apparatus while the A/V apparatus is waiting at the attraction, the one or more servers determine that the personal A/V apparatus is no longer waiting at the attraction and then stop providing the content to the user via the personal A/V apparatus, the personal A/V apparatus will pause the content in response to a companion personal A/V apparatus.

14. A method for presenting a personalized experience using a personal A/V apparatus, comprising:
accessing a data structure indicating storage locations and items to be stored at each of the locations;
automatically determining a current location of a personal A/V apparatus;
automatically determining that the current location is a storage location based on the data structure;
identifying items to be stored at the current location based on the data structure;
automatically sensing presence of a plurality of items;
automatically identifying items from the data structure that are missing from the current location based on the automatically sensing presence of the plurality of items and the data structure;
creating a list, adding the items that are missing from the current location to a list, and storing the list;
displaying the list in the personal A/V apparatus; and
ordering the items that are missing from the current location.

15. The method of claim 14, wherein:
the ordering the items that are missing includes the personal A/V apparatus automatically and electronically ordering the items that are missing from one or more online sellers.

16. The method of claim 14, wherein:
automatically sensing presence of the plurality of items includes automatically recognizing one or more items from an image.

17. The method of claim 16, further comprising:
determining the orientation of the personal A/V apparatus; and
determining the gaze of a user of the personal A/V apparatus, the determining that the current location is a storage location includes using the gaze and orientation to determine that the area being viewed by the user is the storage location.

18. The method of claim 14, wherein:
the storage location is a food storage location and the plurality of items are food items; and
the method further comprises automatically identifying that the user has a food allergy to one of the plurality of food items and graphically identifying in a see-through optical system of the personal A/V apparatus the one of the plurality of food items and that the user has a food allergy to the one of the plurality of food items.

19. The method of claim 14 wherein:
the storage location is a food storage location and the plurality of items are food items; and
the method further comprises automatically identifying a recipe for which all of the ingredients are in possession of a user of the personal A/V, graphically identifying a food item in a field of view of the user looking through a see-through optical system of the personal A/V apparatus that is in the recipe and graphically reporting the recipe in the see-through optical system of the personal A/V apparatus.

20. The method of claim 19, further comprising:
automatically identifying that the user has a food allergy to one of the plurality of food items; and
graphically identifying in a see-through optical system of the personal A/V apparatus the one of the plurality of food items and that the user has a food allergy to the one of the plurality of food items, the automatically sensing presence of the plurality of items includes automatically recognizing one or more items from an image.
